(19) United States
(12) Patent Application Publication
(10) Pub. No.: US 2022/0347027 A1
(43) Pub. Date: Nov. 3, 2022

(54) Devices and Methods to Help Prevent Decubitus Ulcers

(71) Applicant: Sleepme Inc., Mooresville, NC (US)

(72) Inventor: Robert A. Connor, Burnsville, MN (US)

(73) Assignee: Sleepme Inc., Mooresville, NC (US)

(21) Appl. No.: 17/866,082

(22) Filed: Jul. 15, 2022

Related U.S. Application Data
(63) Continuation of application No. 16/826,197, filed on Mar. 21, 2020, now Pat. No. 11,389,352.
(60) Provisional application No. 62/830,497, filed on Apr. 7, 2019.

(51) Int. Cl. A61G 7/00; A61G 7/10; A61G 7/057

(52) U.S. Cl. CPC A61G 7/001; A61G 7/1055; A61G 7/057

(57) ABSTRACT

This invention helps a person in bed to avoid decubitus ulcers. This device has a flexible body support structure (such as a sheet or blanket) which is automatically moved from a first configuration, which is flat, to a second configuration, which enfolds and/or wraps around a person's body. The device turns a person from lying on their first side to lying on their opposite side by: enfolding the person in the support structure; rotating or pivoting the support structure; and then releasing the person by unfolding the support structure.

### CROSS-REFERENCE TO RELATED APPLICATIONS

This application is related to and claims priority from the following US patents and patent applications: this application is a continuation of U.S. patent application Ser. No. 16/826,197, filed Mar. 21, 2020, which claims priority from U.S. Provisional Patent Application No. 62/830,497, filed on Apr. 7, 2019. Each of the above applications is incorporated herein by reference in its entirety.

### BACKGROUND OF THE INVENTION

### 1. Field of the Invention

The present invention relates to devices and methods adapted for reducing risk of decubitus ulcers, and more specifically to devices and methods for rotating a user to prevent pressure areas contributing to decubitus ulcers from developing.

### 2. Description of the Prior Art

Decubitus ulcers (also known as pressure ulcers or bed sores) are localized areas of tissue damage and/or necrosis which are caused by prolonged pressure on the same tissue location, sheer friction on the tissue, localized high moisture level, incontinence or high perspiration, high temperature, poor blood circulation, anemia, infection, poor nutrition, inactivity or immobility, sensory impairment, and/or advanced age. Decubitus ulcers tend to form where there is prolonged external pressure on tissue at a bony prominence such as the sacrum, coccyx, hips, heels, ankles, knees, and elbows.

Decubitus ulcers frequently result in pain and suffering, open wounds, infection and sepsis, disability, amputation, and even death. The prevalence of decubitus ulcers among people in intensive care units and nursing homes continues to be high despite ongoing efforts toward prevention, with high associated costs in terms of human suffering as well as direct healthcare costs. This issue is further pressing due to an increase in the elderly population, economic constraints on human labor to turn patients from one side to the other, and the increase in contagious diseases.

Previously proposed solutions to the issue of decubitus ulcers include mattresses with arrays of individually inflatable cells that are adjusted to reduce areas of prolonged pressure on a reclining person's body. In some of the prior art, the operation of these inflatable cells is adjusted based on data from an array of pressure sensors which is incorporated into a mattress.

Prior art patent documents include the following:

U.S. Pat. No. 4,799,276 for Body rest with means for preventing pressure sores by inventor Kadish, filed Sep. 11, 1987 and issued Jan. 24, 1989, discloses a body rest such as a bed with means incorporated for avoiding the development of pressure sores (decubitus ulcer) caused by prolonged local pressure against a patient's body. The bed comprises: a matrix of freely vertical displaceable supports, in the form of free-floating, pressurized air-supported pistons, constituting together the continuous couch surface of the bed. The pressure exerted by the patient's body sections against their respective support pistons is constantly measured. Valves are provided associated with and controlling the discharge of the air from the piston chambers under the pressure applied to each one of the respective support pistons. After a preset time and level of pressure prevailing within a given piston chamber, a fixed amount of air is discharged, thereby partly relieving the pressure and causing the downward displacement of the respective piston. At the end of the cycle, all the pistons are brought back to their initial, common high level.

U.S. Pat. No. 5,010,608 for Support system for reducing formation of decubitus ulcers by inventors Barnett et al., filed Oct. 11, 1989 and issued Apr. 30, 1991, discloses a support system that reduces the likelihood of breakdown of human skin, and hence formation of decubitus ulcers. The system comprises two sheets of flexible material bonded together to provide a plurality of separate cells that are capable of being alternately and repeatedly inflated and deflated by means of a fluid contained in the cells. The flexible material is impermeable to the fluid. The cells are of a size and shape and with an intercellular spacing such that in at least one of the width and length of the system, the distance between centers of adjacent inflated cells is less than the human two-point discrimination threshold and the support system is capable of supporting a human body with bottoming out either of or between the inflated cells. In particular embodiments, the support system is in the form of a mattress. The support system may be used with persons who are confined to bed, wheelchairs or the like for periods of time or who are otherwise fully or partially immobilized, including for therapeutic reasons.

U.S. Pat. No. 5,052,067 for Bimodal system for pressurizing a low air loss patient support by inventors Thomas et al., filed Jul. 18, 1990 and issued Oct. 1, 1991, discloses a bimodal system for pressurizing a low air loss patient support having a plurality of inflatable sacks, each sack being subdivided into at least two separate air tight chambers. The system includes a source of pressurized air such as an air blower. The system also includes at least two pressure control valves, each valve having an input communicating with the source of pressurized air. The system further includes at least one flow diverter valve having a pair of inlets and a pair of outlets. One of the pressure control valves communicates with one of the diverter valve inlets via the output of the pressure control valve. The second pressure control valve also communicates with the other of the inlets of the diverter valve via the output of the second pressure control valve. The flow diverter valve has a pair of pathways which connect between the inlets and the outlets. A rotatable switching disk supports the pathways and can be rotated to change the way that the inlets communicate with the outlets and accordingly change the way that the pressurized air travels from the source through the flow diverter valve. A plurality of diverter valves can be provided for a plurality of pressure control valves. Different air flow patterns can be selectively arranged by different configurations of the pressure control valves and the flow diverter valves.

U.S. Pat. No. 5,267,364 for Therapeutic wave mattress by inventors Volk et al., filed Aug. 11, 1992 and issued Dec. 7, 1993, discloses a therapeutic mattress for bed ridden patients comprising a plurality of inflatable tubular elements fabricated from a low air loss material which are disposed in side by side, transverse relationship to a mattress supporting surface. The air pressure within the various tubular elements is cyclically varied to produce a wave-like deformation of the patient supporting surfaces of the tubular elements which progresses longitudinally along a selected portion of the length of the mattress.

U.S. Pat. No. 5,283,735 for Feedback system for load bearing surface by inventors Gross et al., filed Dec. 4, 1992 and issued Feb. 1, 1994, discloses an electronic system for adjusting a load bearing surface such as a chair or bed to provide a desired level of comfort including an array of pressure sensors located within the load bearing surface. The pressure sensors generate data indicating the actual distribution of pressure exerted by a user on the load bearing surface. An electronic processor processes the data generated by the array of pressure sensors. The processor compares the fraction of total load exerted on each of a plurality of regions of the load bearing surface with a desired range for each region. If the fraction of total load for any region is not within the desired range, a servo-mechanism is activated to change the shape of the load bearing surface so that the fraction of total load on each region is within the desired range, so as to provide a desired level of comfort to the user.

U.S. Pat. No. 5,794,289 for Mattress for relieving pressure ulcers by inventors Wortman et al., filed Nov. 12, 1996 and issued Aug. 18, 1998, discloses a mattress wherein at least one fabric strip bridges a foam crib for an inflatable cushion to provide lateral stability thereto such as when the mattress is tilted for turning a patient over or otherwise. The fabric strip position is selected so as not to interfere with pressure relief to a portion of the patient's body where pressure ulcers frequently occur. In order to accurately and quickly monitor the tilt of a mattress, transmitting and receiving coils are provided on opposite sides of an assembly of lifting bladders for the side of the mattress being lifted, and the signal strength is measured when a signal is transmitted therebetween, and the angle of tilt is determined therefrom. In order to reduce exposure of lines leading to an inflatable mattress, a notch is provided in a crib for receiving a pump for pressurizing a cushion within the crib so that the pump is positioned to face exteriorly of the crib to allow heat dissipation. In order to extend the life of a cubed foam mattress, the mattress comprises at least two identical interchangeable cubed foam sections. In order to effectively provide pressure relief to a person lying on a mattress while preventing bottoming-out when a person sits on the mattress, the mattress is provided with an upper alternating pressure cushion and a lower cushion which allows the pressure in the upper cushion to be reduced and which is of a non-alternating pressure type. Side-by-side bladders are provided between upper and lower side-by-side cushions respectively for inclining the mattress. Hip bladders are provided to apply pressure to the hip area of a person lying on the mattress on a side opposite to the side of the mattress being inclined in order to maintain body alignment.

U.S. Pat. No. 5,815,864 for Microprocessor controller and method of initializing and controlling low air loss floatation mattress by inventor Sloop, filed Apr. 2, 1996 and issued Oct. 6, 1998, discloses an air pressurization and control system for a low air loss air floatation mattress or cushion. The control system controls air supplied to the air floatation mattress within a range of pressures and flowrates so as to inflate all of the cells of the mattress and to maintain a flow of air to all of the cells over an extended period of time while maintaining all of the cells at a desired level of inflation for the air floatation support of the patient without any of the cells exerting decubitus pressures above the maximum desired decubitus pressure and so as to prevent collapse of any of the cells. A sensor is provided for sensing the pressure of the air within the common supply. The controller includes a microprocessor for initializing the controller to a particular patient to be supported by the mattress and for the air floatation support of the patient over an extended period of time without exceeding a maximum decubitus pressure on any portion of the person's body in contact with the mattress and without permitting any of the cells to collapse. The initializing procedure comprises inflating the mattress with the person supported thereon and determining when at least one of the cells becomes fully inflated thereby determining a maximum inflation pressure not to be exceeded during the course of treatment and then deflating the mattress and determining the pressure at which at least one of the cells collapses thereby determining a lower pressure level above which pressure within the mattress is to be maintained during the course of treatment. The controller monitors the pressure of the air supplied to the common source and regulates operation of the source of pressurized air so as to be at a predetermined pressure between the minimum and the maximum pressure.

U.S. Pat. No. 5,963,997 for Low air loss patient support system providing active feedback pressure sensing and correction capabilities for use as a bed mattress and a wheelchair seating system by inventor Hagopian, filed Mar. 24, 1997 and issued Oct. 12, 1999, discloses a low air loss therapeutic air support system which simultaneously prevents the development of pressure sores and skin maceration due to the build up of heat and moisture at points of interface between the device and the patient and has an active feedback system which provides for real time adjustments to the inflation pressure of the support surface in response to an increase in the compressive pressure on a part of the support surface from shifting of the patient's position or other causes which can be used interchangeably with a sleeping surface and a wheelchair seating system.

U.S. Pat. No. 6,560,804 for System and methods for mattress control in relation to patient distance by inventors Wise et al., filed Nov. 24, 1998 and issued May 13, 2003, discloses a system and a method for detecting and monitoring the distance between a patient and a reference point on an inflatable air mattress and for controlling the air supply to that mattress in relation to such distance. The patient distance sensing system includes a rigid support frame such as a bed frame, an inflatable air mattress positioned atop the bed frame with the upper surface of the inflatable air mattress forming a patient support surface, an air supply operable to provide controlled variations in air supply, and a series of patient distance sensing devices. Such devices including a heterodyning proximation detector, a force responsive distance sensing device, and a light responsive sensing device. Each device is operable to act separately or cooperatively in maintaining a therapeutically beneficial patient support surface through variable control of the delivery of inflation pressure to the air mattress. The heterodyning proximation detector is further operable to initiate inflation by way of a through space sensing of an approaching patient. The present invention further provides a preferred method for regulating the inflation of a therapeutic air mattress through operation of the described patient distance sensing system.

U.S. Pat. No. 7,515,059 for Patient support surface with physiological sensors by inventors Price et al., filed Nov. 19, 2007 and issued Apr. 7, 2009, discloses a patient support surface comprising a cover defining an interior region, a modifiable support layer situated in the interior region and having at least one air bladder, and a sensor layer situated in the interior region and having at least one sensor configured to detect a physiological parameter of a patient atop the patient support surface.

U.S. Pat. No. 8,539,627 for Body position and pressure control apparatus by inventors Terawaki et al., filed Dec. 20, 2010 and issued Sep. 24, 2013, discloses a body position and pressure control apparatus is provided capable of highly accurately detecting body pressure distribution without causing a sense of discomfort for a sleeper, changing body positions, and distributing body pressure. The body position and pressure control apparatus has a mattress provided with a plurality of divided portions and supporting a sleeper, an elastomer sensor, and a body pressure adjuster controlling each of the divided portions based on an instruction from the elastomer sensor and thereby changing the body pressure distribution of the sleeper. The elastomer sensor has a sheet sensor main body and a calculator, the sensor main body having an elastomer sensor thin film, a plurality of electrodes, and a plurality of detectors corresponding to the divided portions provided between the electrodes.

U.S. Pat. No. 8,719,980 for Pressure-ulcer-prevention dynamic cushion by inventor Chen, filed Sep. 17, 2011 and issued May 13, 2014, discloses a multiple-phase dynamic cushion comprising a frame, at least a driving source, at least a transmission assembly, and clusters of plural strips interleaved in parallel. Taking a two-phase embodiment as an example, the two-phase strips interleave with each other, in parallel, to form the cushion's surface and alternate their tensions in turn; when one phase's strips periodically tighten to support the user's body, the other phase's strips will loosen, allowing the user's body covered by the loosened strips to take a rest, averting a pressure-ulcer risk. The driving source is energized by an altering energy, making the two strip groups alternate in loosening and tightening states periodically in turn. This invention can be converted into a portable dynamic chair when the four holes on the bottom of its four corners are inserted with legs; it can also be converted into a dynamic support for a lying human body.

U.S. Pat. No. 8,726,908 for Enhanced patient-orienting alternating pressure support apparatus by inventor Squitieri, filed Oct. 25, 2013 and issued May 20, 2014, discloses systems and apparatuses for enhanced comfort through contact pressure reduction. In particular, the systems and apparatuses disclosed herein prevent or otherwise mitigate pressure by actively orienting a patient over an anatomy-specific pressure-mitigating contact surface on which the patient rests. A pressure-mitigating contact portion of the contact surface includes a plurality of independently pressurized chambers configured in a specific geometric pattern that is designed to mitigate contact pressure between a support surface (e.g., bed or chair) and a specific anatomic region of a patient's body when the specific anatomic region of the patient's body is oriented over an epicenter of the geometric pattern. In one embodiment, the geometric pattern includes a first independently pressurized relief chamber that intersects the epicenter of the geographic pattern, and second and third independently pressurized relief chambers that collectively encompass the first independently pressurized relief chamber.

U.S. Pat. No. 8,757,165 for Patient-orienting alternating pressure support apparatus with lower extremity wedge by inventor Squitieri, filed Oct. 25, 2013 and issued Jun. 24, 2014, discloses systems and apparatuses for enhanced comfort through contact pressure reduction. In particular, the systems and apparatuses disclosed herein prevent or otherwise mitigate pressure by actively orienting a patient over an anatomy-specific pressure-mitigating contact surface on which the patient rests. A pressure-mitigating contact portion of the contact surface includes a plurality of independently pressurized chambers configured in a specific geometric pattern that is designed to mitigate contact pressure between a support surface (e.g., bed or chair) and a specific anatomic region of a patient's body when the specific anatomic region of the patient's body is oriented over an epicenter of the geometric pattern. Additionally, a plurality of elevated side support portions and a wedge interconnected on the base material are configured to actively orient the specific anatomic region of the patient's body over the epicenter of the geometric pattern.

U.S. Pat. No. 8,752,222 for Adaptable surface for use in beds and chairs to reduce occurrence of pressure ulcers by inventor Papaioannou, filed Oct. 13, 2009 and issued Jun. 17, 2014, discloses an adaptable surface system including a plurality of individually adjustable surface units and a plurality of pressure sensors. Each pressure sensor corresponds to one of the adjustable subsurface units and is positioned to measure an amount of pressure exerted upon the subsurface unit. The system also includes a controller that receives a first pressure value from a pressure sensor, compares the value to a threshold, and adjusts the height of the first subsurface unit based on the comparison. The controller also receives a second pressure value from a second pressure sensor, compares the second pressure value to the threshold, and adjusts the height of a second subsurface unit based on the comparison.

U.S. Pat. No. 8,801,635 for Adjustable pneumatic supporting surface by inventor Hovorka, filed Oct. 2, 2009 and issued Aug. 12, 2014, discloses an apparatus and method adapted for characterizing human tissue type. A plurality of inflatable bladders enable the application of kinetic energy to the human tissue. Collected data responsive to the applied kinetic energy differentiates between different tissue types and patient loading. The data can be routed via a network to a remote location.

U.S. Pat. No. 8,813,284 for Inflatable component for an alternating pressure mattress by inventors Teasdale et al., filed Feb. 16, 2006 and issued Aug. 26, 2014, discloses an inflatable component for an alternating pressure mattress. The inflatable component has at least two inflatable cells. Each cell has at least two opposite edges and at least part of one of two opposite edges is free and lies within an outer peripheral edge of the component. The inflatable component may be formed from two layers of material joined together along predetermined lines to define the cells. The inflatable component may include two or more groups of cells, each connected to a respective air inlet. The inflatable component may be comprised in a mattress.

U.S. Pat. No. 8,893,338 for Inflatable cellular mattress with alternating zones of inflated cells by inventors McCausland et al., filed Oct. 24, 2011 and issued Nov. 25, 2014, discloses a cushion or mattress comprising a base and a plurality of linearly aligned individual air cells across the base. Groups of individual air cells can be interconnected and in fluid cooperation with an inflation source, such as a pump. In one aspect of the invention, the inflation of adjacent cells is staggered, for example, in a checkerboard-like inflation pattern that helps diffuse load over a wider area.

U.S. Pat. No. 8,898,842 for Anti-decubitus ulcer mattress overlay system with selective elevation structure by inventor Dennis, filed Oct. 8, 2012 and issued Dec. 2, 2014, discloses an elevation structure system possessing anti-decubitus ulcer characteristics, and cooperating with a mattress overlay also having anti-decubitus ulcer capabilities as part of a mattress overlay system, in which multiple elongate, positionally adjustable, relatively moveable risers are configured for selective placement in conditions of transverse, subposed, under engagement with the sides of an overlay to create substantially non-inclined, elevated, depth-supplemented regions at locations along the length of the overlay. The elevation structure and overlay may each include a dynamic-response core expanse formed of an open-cell, compressible viscoelastic foam coated with elastomeric, moisture- and gas-flow-managing, differential-thickness coating structure load-transmissively bonded to the entirety of the outside of said core expanse to function as a dynamically-responsive unit therewith.

U.S. Pat. No. 9,149,401 for Support apparatus for preventing and/or inhibiting decubitus ulcers by inventors Davenport et al., filed Dec. 23, 2011 and issued Oct. 6, 2015, discloses an apparatus and method for preventing decubitus ulcerations including a frame having a pair of frame supports spaced from each other. A mattress is supported on the frame between the frame supports. A pliable support material extends between the supports. The material is adapted to support an individual thereon in a generally recumbent position. A lift mechanism is disposed on the frame and operably connected to the support material. The lift mechanism adjusts the tension of the material so that the support has a first position resting on the mattress and a second position wherein the support is raised above the mattress.

U.S. Pat. No. 9,295,600 for Person support apparatus with activity and mobility sensing by inventor Receveur, filed Apr. 10, 2012 and issued Mar. 29, 2016, discloses a person support apparatus supporting a person in a laying-down or a seated position. One or more sensors, which may be operably coupled to the person support apparatus, monitor changes in the position of a person situated on the person support apparatus. A control system receives output from the sensor or sensors over a period of time, while the person is positioned on the person support apparatus. The control system makes a determination relating to the activity and/or mobility of the person positioned on the person support apparatus. The control system may use the activity and/or mobility determination to control a feature of the person support apparatus, or for other purposes.

U.S. Pat. No. 9,504,620 for Method of controlling a pressurized mattress system for a support structure by inventors Soltani et al., filed Jul. 23, 2014 and issued Nov. 29, 2016, discloses a method for automatically varying the internal air pressure in at least one inflatable air bladder associated with at least one zone of a pressurized mattress system to achieve an optimal zone air pressure for a patient. The method includes a step of incrementally decreasing the zone air pressure of the at least one zone until more than a predetermined percentage or portion of the patient is directly supported by a substrate disposed below the at least one inflatable air bladder. The method then determines the appropriate increase in zone air pressure to achieve the optimal zone air pressure for the patient.

U.S. Pat. No. 9,711,029 for Equipment, dressing and garment wireless connectivity to a patient bed by inventors Ribble et al., filed Oct. 9, 2015 and issued Jul. 18, 2017, discloses a system comprising a patient bed having a reader to read wireless signals. In some embodiments a wound dressing has a transmitter that transmits wireless signals to the reader of the patient bed. In other embodiments, a garment has a transmitter that transmits wireless signals to the reader of the patient bed. In still further embodiments, other medical equipment has a transmitter that transmits wireless signals to the reader of the patient bed.

U.S. Pat. No. 9,724,257 for Anti-bedsore bed by inventors Chen et al., filed May 3, 2017 and issued Aug. 8, 2017, discloses an anti-bedsore bed comprising a bed unit, a first bed body, and a second bed body. The bed unit has a first mattress, and a bottom portion is coupled on a bottom surface thereof. Moreover, the bottom portion comprises six supporting units evenly arranged into three sets at positions corresponding to a user's upper, middle and lower back, and each of the supporting units has a sliding block moveably mounted on an upper surface of the bottom portion. Furthermore, each of the sliding blocks has a supporting rod, and an abutting unit is pivotally connected to an upper end of the supporting rod. The supporting rods are configured to move upwardly in a preset time interval, and the abutting units are adapted to uplift a user's body to detach from the first mattress for a designed time, thereby achieving the anti-bedsore effect.

U.S. Pat. No. 9,763,841 for Apparatus and method for automatic adjustment of a support surface with interwoven support elements by inventors Carlson et al., filed Jun. 6, 2012 and issued Sep. 19, 2017, discloses an apparatus for adjusting an active length of a plurality of interwoven support elements of a weight bearing surface to conform to contours of a user's anatomy. The weight bearing surface overlies a frame to which the plurality of interwoven support elements are connected. The apparatus includes an adjustment mechanism connected to one of the plurality of interwoven support elements, wherein the adjustment mechanism is attached or releasably attached to the frame. The adjustment mechanism allows the active length of the connected interwoven support element to change as a user bears upon the weight bearing surface, thereby conforming the weight bearing surface to the contours of a user's anatomy. In another aspect, a method for adjusting an active length of at least some of a plurality of interwoven support elements of a weight bearing surface to conform to contours of a user's anatomy is disclosed.

U.S. Pat. No. 10,039,488 for System and method to determine tissue compression by inventors Hermann et al., filed Sep. 10, 2012 and issued Aug. 7, 2018, discloses a system and method for how tissue compression can be measured continuously in a non-contact way to provide a low cost, patient/user specific measurement system. The method may be used to inform existing and future pressure relief mattress systems. The invention may also be used for any application either in conjunction with another system or on its own to measure tissue compression. In another embodiment the invention can be used for measuring any type of compression of a compressible material, for example compression of viscoelastic foam or other materials. The invention may also be used to make inferences about the changes of blood flow at site of measurement.

U.S. Pat. No. 10,045,632 for Traveling wave air mattresses and method and apparatus for generating traveling waves thereon by inventor Chapin, filed Feb. 12, 2018 and issued Aug. 14, 2018, discloses a traveling wave air mattress apparatus including an air mattress comprised of an array of laterally disposed, longitudinally spaced air bladder cells that are individually inflatable to quiescent pressure levels which provide comfortable support for a human body, and an air pressure-pulse generator controlled by a wave sequence generator for periodically introducing into sequences of the air bladder cells timed sequences of air pressure pulses which vary pressures in the cells from quiescent pressures, the air pressure variations resulting in leading and lagging soliton-like traveling waves of body support force variation which travel longitudinally over the surfaces of the pulsed air bladder cells, thus inhibiting formation of bedsores. The wave patterns may optionally simulate water waves and/or rocking motions of a boat to produce relaxing effects.

U.S. Pat. No. 10,058,189 for Active multicompartmental pressure redistribution system by inventor Petrov, filed Aug. 3, 2015 and issued Aug. 28, 2018, discloses an interconnected multicompartmental pressure redistribution system that is able to precisely identify contact pressure points and address excess pressure on the body by redistributing the pressure in real time. Sensors that are part of a matrix of fluid substance-filled interactive pixels communicate with a microcontroller that may also be in wireless communication with a smart device. The microcontroller controls the individual fluid flow regulators located between the interactive pixels. This causes specific flow regulators to open, allowing the fluid substance to flow from one interactive pixel to another, redistributing pressure, as needed.

US Patent Publication No. 2009/0194115 for Apparatus for prevention and treatment of decubitus ulcers by inventor Squitieri, filed Jan. 29, 2009 and published Aug. 6, 2009, discloses an apparatus to prevent and/or treat pressure ulceration of the skin notably in the sacral area, but also other pressure-sensitive areas of the body as well. The apparatus includes a garment configured for placement about a region of a person, the garment having at least one bladder and at least one corresponding support surface configured to be maintained in a substantially fixed relationship relative to a portion of the region of the person and configured to provide controllable support to the person in this portion of the region. The at least one bladder is controllably inflated/deflated with a fluid. The apparatus can be configured to off-load the sacrum and reposition weight distribution in the sacral area to avoid skin ischemia and skin breakdown leading to pressure sores know as decubitus ulcers.

US Patent Publication No. 2011/0263950 for Systems, devices and methods for preventing, detecting and treating pressure-induced ischemia, pressure ulcers, and other conditions by inventors Larson et al., filed Mar. 23, 2011 and published Oct. 27, 2011, discloses a system for monitoring medical conditions including pressure ulcers, pressure-induced ischemia and related medical conditions comprises at least one sensor adapted to detect one or more patient characteristic including at least position, orientation, temperature, acceleration, moisture, resistance, stress, heart rate, respiration rate, and blood oxygenation, a host for processing the data received from the sensors together with historical patient data to develop an assessment of patient condition and suggested course of treatment. In some embodiments, the system can further include a support surface having one or more sensors incorporated therein either in addition to sensors affixed to the patient or as an alternative thereof. The support surface is, in some embodiments, capable of responding to commands from the host for assisting in implementing a course of action for patient treatment. The sensor can include bi-axial or tri-axial accelerometers, as well as resistive, inductive, capacitive, magnetic and other sensing devices, depending on whether the sensor is located on the patient or the support surface, and for what purpose.

US Patent Publication No. 2013/0090571 for Methods and systems for monitoring and preventing pressure ulcers by inventors Nourani et al., filed Oct. 6, 2011 and published Apr. 11, 2013, discloses prevention and treatment of pressure ulcers and a platform for monitoring, prevention and management of pressure ulcer using a pressure mapping system that records a patient's bed posture, tracks different limbs along with associated statistical pressure image data and produces a summary report for care givers after data analysis and risk assessment. The methodology allows care givers to utilize the stress data and schedule the repositioning of the patient more effectively. The invention relates to creation and using algorithms and analytics for monitoring, prevention and management of pressure ulcers which include time-stamped whole-body pressure distribution data collection and profiling; posture classification, limb detection and tracking; quality of turn and risk assessment; turning schedule and nursing staff utilization for pressure ulcer management; and patient status reporting system customized for caregivers.

US Patent Publication No. 2013/0281804 for Methods and systems for monitoring a patient to reduce the incidence of pressure ulcers by inventors Lee et al., filed Apr. 19, 2013 and published Oct. 24, 2013, discloses systems, methods, and apparatus for preventing and treating pressure ulcers in bedfast patients. The invention includes monitoring a bedfast patient using a sensor array disposed between a patient and a support surface, the sensor array adapted to transmit signals indicative of interfacial pressure and blood oxygen saturation levels; and a processor coupled to the sensor array and adapted to receive the signals from the sensor array to determine if an undesirable condition exists. Numerous additional aspects are disclosed.

US Patent Publication No. 2015/0128354 for Methods, circuits, apparatuses and assemblies for providing a mattress or body portion support cushion with a sensor layer by inventors Greenstein et al., filed Apr. 11, 2013 and published May 14, 2015, discloses a resting body support, such as a mattress or an encasement for a resting body support, comprising a sensor layer which may incorporate a mattress adjustment system. The system may comprise at least one pressure detection mat comprising a plurality of sensors arranged in a matrix and at least one processor configured to monitor a plurality of pressure values detected by each of said sensors; and at least one active mattress comprising a plurality of cells, the cells being controlled by an inflation control unit that is connected to said processor, and operable to individually adjust the level of inflation of said plurality of cells based on said plurality of pressure values.

US Patent Publication No. 2016/0228050 for System and Method for Prevention of Pressure Ulcers by inventors Sugla et al., filed Feb. 8, 2016 and published Aug. 11, 2016, discloses a method and system for monitoring and preventing a patient from developing pressure ulcers, comprising (1) a sensing unit, which includes a pressure sensor, attachable to a body part of a patient and having a unique identifier, for detecting pressure exerted by a supporting surface and outputting pressure data indicative of pressure as a function of time; and a wireless transceiver for transmitting the pressure data and/or the unique identifier; (2) a controller unit configured for receiving the pressure data and the unique identifier, associating the unique identifier with the body part of the patient, and for transmitting the pressure data and the unique identifier; and (3) a central server device configured for (i) receiving the unique identifier and the pressure data from the controller unit; (ii) determining whether the pressure data exceeds a predetermined value associated with the body part of the patient; and (iii) transmitting to the controller unit a determination that the pressure data exceeded the predetermined value, the controller unit outputting a signal indicative of the determination.

US Patent Publication No. 2016/0317370 for Cushion with bladders running different pressurization modes inside and outside dynamically selected target bladder group by inventors Evans et al., filed Feb. 29, 2016 and published Nov. 3, 2016, discloses a responsive cushion system including a pressure adjustment system and a cushion formed by an array of bladders coupled to the pressure adjustment system. At least two of the bladders are independent from one another such that that each can be independently pressurized and depressurized by the pressure adjustment system. A processor is coupled to the pressure adjustment system and a user interface, and the processor is operable to select a target group of one or more bladders according to data received via a communication interface. The processor is further operable to control the pressure adjustment system to adjust pressurization of bladders outside the target group according to a first pressurization mode, and control the pressure adjustment system to concurrently adjust pressurization of the target group of bladders according to a second, different pressurization mode. At least one of the first and second pressurization modes dynamically changes pressure over time.

US Patent Publication No. 2016/0324707 for Multi-mode sacral unloading pressure relief in a patient support surface by inventors Lachenbruch et al., filed Apr. 26, 2016 and published Nov. 10, 2016, discloses a patient support apparatus including a mattress having an air bladder system configured to sense pressure levels along the mattress surface and perform unloading of mattress areas corresponding to specific patient body areas to relief loading to the area, and to perform unloading independently or in combination with lateral rotation. The air bladder system may include a support bladder system and a rotation bladder system.

US Patent Publication No. 2017/0056264 for Soliton Traveling Wave Air Mattresses by inventor Chapin, filed Feb. 10, 2015 and published Mar. 2, 2017, discloses a soliton air mattress including an array of air bladder cells that are individually inflatable to quiescent pressure levels which provide comfortable support for a human body, and a soliton wave generator including an air pressure-pulse generator controlled by a wave sequence generator for introducing into ordered sequences of air bladder cells a wave-like time sequence of air pressure pulses which vary quiescent pressure levels in the cells, the pressure wave resulting in a soliton traveling wave of body support force reduction which traverses surfaces of the air bladder cells, thus reducing normal forces exerted on a body and minimizing the occurrence rate of shear forces exerted on the body, thereby inhibiting formation of bedsores. The soliton wave patterns may optionally simulate water waves and/or rocking motions of a boat to produce relaxing effects.

US Patent Publication No. 2017/0128297 for Supporting surface with programmable supports and method to reduce pressure on selected areas of a body by inventors Cernasov et al., filed Nov. 7, 2016 and published May 11, 2017, discloses a system and method to reduce pressure on selected areas on a body include an array of programmable supports and at least one sensor to detect a physical property of the body. Each programmable support of the array of programmable supports includes an adjustable member and a mechanism to adjust the length of the adjustable member based on the detected physical property of the body.

US Patent Publication No. 2017/0348181 for System for Adjusting Pressure Locally on the Skin and Subcutaneous Tissue by inventors Perriard et al., filed Nov. 6, 2015 and published Dec. 7, 2017, discloses a system for adjusting pressure locally acting on the skin. Said system includes a set of adjacent modules distributed so as to form a layer. Each module includes a cushion capable of changing shape and comprising a cavity, a valve, a tank, and a pressure sensor, wherein the cavity and the tank are in communication with each other by means of the valve, and the sensor is placed so as to sense pressure directly or indirectly acting on the cushion. The system also includes a feedback loop arranged such as to increase or decrease the change in the shape of the cushion on the basis of the pressure detected by the sensor. The system according to the invention can be built into a shoe so as to re-establish normal plantar pressure under the entire sole of the foot, which is particularly desirable for athletes or for patients suffering from diabetes mellitus or leprosy. It is also possible to incorporate the system according to the invention into a (bed or wheelchair) mattress so as to prevent decubitus ulcers in patients with neurological diseases (hemiplegia, paraplegia, tetraplegia, multiple sclerosis, amyotrophic lateral sclerosis) and any other sensory and/or motor deficit diseases.

US Patent Publication No. 2018/0061044 for Method and System for Monitoring a User to Prevent Pressure Ulcers by inventors Woodbridge et al., filed Aug. 28, 2016 and published Mar. 1, 2018, discloses monitoring of users to prevent pressure ulcers using imaging technologies to detect a user's posture, track the user's poses, detect changes in a user's posture, quantify changes in a user's posture, determine pressure areas from the user's poses, and alert caregivers when a user's current positioning and/or lack of movement may result in the formation of a pressure ulcer. The invention relates to the use of devices that can form images in low to high lighting conditions for monitoring a user to prevent pressure ulcers. These devices include, but are not limited to, thermographic cameras (also known as infrared cameras and thermal imaging camera), image intensifiers (also known as image intensifier tubes), and active illumination. The invention relates to both the hardware used to monitor users to prevent pressure ulcers as well as the algorithms and analytics used to detect a user's posture, detect changes to a user's posture, quantify changes in a user's posture, track the user's poses, determine pressure areas from the poses, as well as detect conditions that may lead to a pressure ulcer. The invention can be used in a variety of environments including, but not limited to, a hospital setting, home setting, and public settings (such as an airplane).

US Patent Publication No. 2018/0280219 for Air mattress turning device by inventors Garrett et al., filed Nov. 27, 2015 and published Oct. 4, 2018, discloses an apparatus for rotating a bed-ridden person in order to prevent pressure sores, or bed sores, comprising a first set of bladders and a second set of bladders, and at least one fluid pump, which may be an air pump, in fluid communication with the bladders through a system of fluid valves. Inflating first set of bladders will cause a patient to be rotated onto their right side; likewise, inflating the second set of bladders will cause a patient to be rotated onto their left side. A patient may therefore be rotated from left side to right side in order to prevent pressure, or bed, sores from occurring. The invention may be programmed to rotate persons automatically on any predetermined timing, and in any sequence, desired, or by manual command. The invention also comprises a pump and valve assembly for low pressure applications.

US Patent Publication No. 2018/0310719 for Adaptable Mattress by inventor Wiggermann, filed May 25, 2017 and published Nov. 1, 2018, discloses a mattress including a first, phase changeable component and a thermal management system adapted to control the temperature of the phase changeable component in order to change the firmness of the mattress. Some embodiments of the mattress include an optional single phase component. The firmness is made spatially and/or temporally uniform or nonuniform, and can be controlled based on one or more sensed parameters.

US Patent Publication No. 2018/0311095 for Pressure redistribution system and methods of using same by inventors Bednarz et al., filed Apr. 29, 2017 and published Nov. 1, 2018, discloses a pressure redistribution system, including: a chair having a frame; a back cushion inflation system operatively connected to an upper portion of the frame, wherein the back cushion inflation system includes a back cushion and a plurality of back cushion air bladders located within an opening in the back cushion; a pump system operatively connected to the back cushion inflation system for inflating and deflating the back cushion air bladders; a seat cushion sensor system operatively attached to the wheelchair frame and the pump system, wherein the seat cushion sensor system includes a seat cushion and a plurality of seat cushion air bladders located within an opening in the seat cushion and a plurality of load sensors located adjacent to the plurality of seat cushion air bladders and wherein the pump system is able to inflate and deflate the plurality of seat cushion air bladders; a light display operatively connected to the back cushion inflation system, wherein the light display provides a visual indication as to a pressure being experienced by each of the plurality of load sensors; and a microcontroller located adjacent to the pump system, the seat cushion sensor system and the light display to assist in a determination of the pressure being experienced by each of the plurality of load sensors and to assist in providing the visual indication as to a pressure being experienced by each of the plurality of load sensors.

US Patent Publication No. 2018/0369040 for System and method for treating and preventing pressure sores in bedridden patients by inventor Sheth, filed Jun. 30, 2017 and published Dec. 27, 2018, discloses a system such as a hospital bed provides capability to monitor and alleviate the pressure points and provides oxygen and water jets to prevent and treat bed sores in bed-ridden patients. An array of balloons touching each other form a mattress of unstitched but contiguous balloons like in a conventional mattress with stitched puffs. Individual pressure sensors placed within each balloon measure and monitor pressure. Furthermore, horizontal rods which lay between the balloons perform oxygenation and provide water massage to the back of the patient body from the interstitial spaces within the unstitched mattress of contiguous balloons. The rods are elevated to raise the patient above the mattress to relieve overall pressure and enable cleaning and wipe down of the back of the patient body. The rods can elevate the entire patient body or its torso alone or the lower extremities alone to clean as desired.

US Patent Publication No. 2019/0021918 for Non-invasive pressure-mitigation apparatuses for improving blood flow and associated systems and methods by inventor Squitieri, filed Sep. 26, 2018 and published Jan. 24, 2019, discloses apparatuses and systems for mitigating contact pressures applied to a human body by the surface of an object, such as a chair, bed, or table. A pressure-mitigation apparatus can include a series of chambers whose pressure can be individually varied. When placed between a patient and a contact surface, the pressure-mitigation apparatus can vary the contact pressure on a specific anatomical region of the patient by controllably inflating and/or deflating one or more cell. Moreover, a pressure-mitigation system can be readily integrated into a conventional treatment regimen for a variety of different conditions.

US Patent Publication No. 2019/0029903 for Person support apparatus having physiological sensor by inventors Riley et al., filed Oct. 2, 2018 and published Jan. 31, 2019, discloses a person support apparatus including a frame and a support surface cooperating with the frame to support a person. The person support apparatus also has a sensor coupled to one of the frame and the support surface. The sensor detects at least one characteristic associated with the person. A controller is coupled to the sensor. In response to at least one of a condition of the frame, a condition of the support surface, a position of the person, or a condition of the person, the controller operates to control the sensor by at least one of changing a gain of the sensor and changing a manner in which a signal from the sensor is filtered. In some instances, the controller turns the sensor off.

### SUMMARY OF THE INVENTION

The present invention relates to devices and methods adapted for reducing risk of decubitus ulcers, and more specifically to devices and methods for rotating a user to prevent pressure areas contributing to decubitus ulcers from developing.

It is an object of this invention to provide an apparatus for relieving pressure ulcers by turning an individual.

In one embodiment, the present invention is directed to a resting support apparatus, including a flexible body support structure, and a plurality of actuators operable to transform the flexible body support structure from a first configuration to a second configuration, and/or from the second configuration to the first configuration, wherein, in the first configuration, the flexible body support structure is substantially flat and, in the second configuration, the flexible body support structure is folded along a longitudinal axis and/or wrapped at least partially around an individual, wherein, while the flexible body support structure is in the second configuration, the plurality of actuators rotate, tilt, or pivot the flexible body support structure toward a left side or a right side, wherein, after rotating, tilting, or pivoting the flexible body support, the plurality of actuators transform the flexible body support structure from the second configuration to the first configuration, and wherein the flexible body support structure includes a sheet, a blanket, a pad, a net, a mesh, and/or a hammock.

In another embodiment, the present invention is directed to a resting support apparatus, including a flexible body support structure, and a plurality of actuators operable to transform the flexible body support structure from a first configuration to a second configuration, and/or from the second configuration to the first configuration, wherein, in the first configuration, the flexible body support structure is substantially flat and, in the second configuration, the flexible body support structure is folded along a longitudinal axis and/or wrapped at least partially around an individual, wherein, while the flexible body support structure is in the second configuration, the plurality of actuators rotate, tilt, or pivot the flexible body support structure toward a left side or a right side, wherein the flexible body support structure includes a plurality of connectors, and wherein the plurality of connectors are operable to slide along one or more lateral arches extending upwardly from the flexible body support structure, and wherein, after rotating, tilting, or pivoting the flexible body support, the plurality of actuators transform the flexible body support structure from the second configuration to the first configuration.

In yet another embodiment the present invention is directed to a resting support apparatus, including a flexible body support structure, a plurality of actuators operable to transform the flexible body support structure from a first configuration to a second configuration, and/or from the second configuration to the first configuration, a first inflatable member positioned on a first side of the flexible body support structure, and a second inflatable member positioned on a second side of the flexible body support structure, wherein, in the first configuration, the flexible body support structure is substantially flat and, in the second configuration, the flexible body support structure is folded along a longitudinal axis and/or wrapped at least partially around an individual, wherein, while the flexible body support structure is in the second configuration, the first inflatable member and/or the second inflatable members inflates, causing the flexible body support structure to rotate, tilt, or pivot the flexible body support structure toward a left side or a right side, and wherein, after rotating, tilting, or pivoting the flexible body support, the plurality of actuators transform the flexible body support structure from the second configuration to the first configuration.

These and other aspects of the present invention will become apparent to those skilled in the art after a reading of the following description of the preferred embodiment when considered with the drawings, as they support the claimed invention.

### BRIEF DESCRIPTION OF THE DRAWINGS

FIG. 1 illustrates a top view of a configuration-changing flexible body support structure in a first configuration, before the device has been activated according to one embodiment of the present invention.

FIG. 2 illustrates an oblique view of a configuration-changing flexible body support structure in a first configuration, before the device has been activated according to one embodiment of the present invention.

FIG. 3 illustrates a top view of a configuration-changing flexible body support structure in a second configuration in which it enfolds a reclining person lying on a first side according to one embodiment of the present invention.

FIG. 4 illustrates an oblique view of a configuration-changing flexible body support structure in a second configuration in which it enfolds a reclining person lying on a first side according to one embodiment of the present invention.

FIG. 5 illustrates a top view of a configuration-changing flexible body support structure in a third configuration, after the configuration-changing flexible body support structure has been rotated, titled, and/or pivoted such that a reclining person faces the opposite direction according to one embodiment of the present invention.

FIG. 6 illustrates an oblique view of a configuration-changing flexible body support structure in a third configuration, after the configuration-changing flexible body support structure has been rotated, titled, and/or pivoted such that a reclining person faces the opposite direction according to one embodiment of the present invention.

FIG. 7 illustrates a top view of a configuration-changing flexible body support structure in a fourth configuration, after a reclining figure has been fully rotated and the configuration-changing flexible body support structure again lies flat according to one embodiment of the present invention.

FIG. 8 illustrates an oblique view of a configuration-changing flexible body support structure in a fourth configuration, after a reclining figure has been fully rotated and the configuration-changing flexible body support structure again lies flat according to one embodiment of the present invention.

FIG. 9 illustrates a side view of a configuration-changing flexible body support structure in a first configuration, before the device has been activated according to one embodiment of the present invention.

FIG. 10 illustrates a side view of a configuration-changing flexible body support structure in a second configuration in which it enfolds a reclining person lying on a first side according to one embodiment of the present invention.

FIG. 11 illustrates a side view of a configuration-changing flexible body support structure in a third configuration, after the configuration-changing flexible body support structure has been rotated, titled, and/or pivoted such that a reclining person faces the opposite direction according to one embodiment of the present invention.

FIG. 12 illustrates a side view of a configuration-changing flexible body support structure in a fourth configuration, after a reclining figure has been fully rotated and the configuration-changing flexible body support structure again lies flat according to one embodiment of the present invention.

FIG. 13 illustrates a side view of a configuration-changing flexible body support structure in a first configuration, before the device has been activated according to one embodiment of the present invention.

FIG. 14 illustrates a side view of a configuration-changing flexible body support structure in a second configuration in which it enfolds a reclining person lying on a first side according to one embodiment of the present invention.

FIG. 15 illustrates a side view of a configuration-changing flexible body support structure in a third configuration, after the configuration-changing flexible body support structure has been rotated, titled, and/or pivoted by one or more inflatable members such that a reclining person faces the opposite direction according to one embodiment of the present invention.

FIG. 16 illustrates a side view of a configuration-changing flexible body support structure in a fourth configuration, after a reclining figure has been fully rotated by one or more inflatable members and the configuration-changing flexible body support structure again lies flat according to one embodiment of the present invention.

FIG. 17 illustrates a top view of a configuration-changing flexible body support structure attached to longitudinal arches in a first configuration, before the device has been activated according to one embodiment of the present invention.

FIG. 18 illustrates an oblique view of a configuration-changing flexible body support structure attached to longitudinal arches in a first configuration, before the device has been activated according to one embodiment of the present invention.

FIG. 19 illustrates a top view of a configuration-changing flexible body support structure attached to longitudinal arches in a second configuration in which it enfolds a reclining person lying on a first side according to one embodiment of the present invention.

FIG. 20 illustrates an oblique view of a configuration-changing flexible body support structure attached to longitudinal arches in a second configuration in which it enfolds a reclining person lying on a first side according to one embodiment of the present invention.

FIG. 21 illustrates a top view of a configuration-changing flexible body support structure attached to longitudinal arches in a third configuration, after the configuration-changing flexible body support structure has been rotated, titled, and/or pivoted such that a reclining person faces the opposite direction according to one embodiment of the present invention.

FIG. 22 illustrates an oblique view of a configuration-changing flexible body support structure attached to longitudinal arches in a third configuration, after the configuration-changing flexible body support structure has been rotated, titled, and/or pivoted such that a reclining person faces the opposite direction according to one embodiment of the present invention.

FIG. 23 illustrates a top view of a configuration-changing flexible body support structure attached to longitudinal arches in a fourth configuration, after a reclining figure has been fully rotated and the configuration-changing flexible body support structure again lies flat according to one embodiment of the present invention.

FIG. 24 illustrates an oblique view of a configuration-changing flexible body support structure attached to longitudinal arches in a fourth configuration, after a reclining figure has been fully rotated and the configuration-changing flexible body support structure again lies flat according to one embodiment of the present invention.

### DETAILED DESCRIPTION

The present invention relates to devices and methods adapted for reducing risk of decubitus ulcers, and more specifically to devices and methods for rotating a user to prevent pressure areas contributing to decubitus ulcers from developing.

In one embodiment, the present invention is directed to a resting support apparatus, including a flexible body support structure, and a plurality of actuators operable to transform the flexible body support structure from a first configuration to a second configuration, and/or from the second configuration to the first configuration, wherein, in the first configuration, the flexible body support structure is substantially flat and, in the second configuration, the flexible body support structure is folded along a longitudinal axis and/or wrapped at least partially around an individual, wherein, while the flexible body support structure is in the second configuration, the plurality of actuators rotate, tilt, or pivot the flexible body support structure toward a left side or a right side, wherein, after rotating, tilting, or pivoting the flexible body support, the plurality of actuators transform the flexible body support structure from the second configuration to the first configuration, and wherein the flexible body support structure includes a sheet, a blanket, a pad, a net, a mesh, and/or a hammock.

In another embodiment, the present invention is directed to a resting support apparatus, including a flexible body support structure, and a plurality of actuators operable to transform the flexible body support structure from a first configuration to a second configuration, and/or from the second configuration to the first configuration, wherein, in the first configuration, the flexible body support structure is substantially flat and, in the second configuration, the flexible body support structure is folded along a longitudinal axis and/or wrapped at least partially around an individual, wherein, while the flexible body support structure is in the second configuration, the plurality of actuators rotate, tilt, or pivot the flexible body support structure toward a left side or a right side, wherein the flexible body support structure includes a plurality of connectors, and wherein the plurality of connectors are operable to slide along one or more lateral arches extending upwardly from the flexible body support structure, and wherein, after rotating, tilting, or pivoting the flexible body support, the plurality of actuators transform the flexible body support structure from the second configuration to the first configuration.

In yet another embodiment the present invention is directed to a resting support apparatus, including a flexible body support structure, a plurality of actuators operable to transform the flexible body support structure from a first configuration to a second configuration, and/or from the second configuration to the first configuration, a first inflatable member positioned on a first side of the flexible body support structure, and a second inflatable member positioned on a second side of the flexible body support structure, wherein, in the first configuration, the flexible body support structure is substantially flat and, in the second configuration, the flexible body support structure is folded along a longitudinal axis and/or wrapped at least partially around an individual, wherein, while the flexible body support structure is in the second configuration, the first inflatable member and/or the second inflatable members inflates, causing the flexible body support structure to rotate, tilt, or pivot the flexible body support structure toward a left side or a right side, and wherein, after rotating, tilting, or pivoting the flexible body support, the plurality of actuators transform the flexible body support structure from the second configuration to the first configuration.

Previously proposed solutions to the issue of decubitus ulcers include mattresses with arrays of individually inflatable cells that are adjusted to reduce areas of prolonged pressure on a reclining person's body. In some of the prior art, the operation of these inflatable cells is adjusted based on data from an array of pressure sensors which is incorporated into a mattress. However, there are limits to the amount of inter-cell variation in pressure against body tissue when cells are covered by a continuous sheet and/or when the upper surfaces of individual cells are interconnected. Additionally, it is often challenging to manage tissue moisture levels when the upper surfaces of inflatable cells are non-porous.

The prior art also includes moving mattresses which automatically tilt to turn a person from lying on one side to the opposite side. However, it is also challenging to avoid abrupt movements (e.g., sudden “flopping over” movement) and/or having a person fall out of bed when a mattress automatically tilts using these systems. Therefore, there is still a significant unmet clinical need for better devices and methods to prevent decubitus ulcers. This need is increasing due to the increase in the elderly population, economic constraints on human labor to turn patients from one side to the other, and the increase in contagious diseases. The present invention helps to address the limitations of the prior art and to meet this increasing clinical need.

This invention includes novel devices and methods to help prevent decubitus ulcers on people who are in bed for prolonged periods of time. Turning a person from lying on one side to lying on their opposite side in bed helps to avoid decubitus ulcers. In existing methods, this is often done manually, but is labor intensive and sometimes exposes workers to contagious illness. Instead, the devices disclosed herein automatically turn a person from lying on one side to lying on their opposite side. In one example, such a device includes a flexible body support structure such as a sheet or blanket. The support structure has a first configuration in which it is substantially flat and a second configuration in which it is folded or wrapped around a person's body. The device automatically moves the support structure from its first configuration to its second configuration, and vice versa.

In one example, a device for reducing decubitus ulcers automatically turns a person from lying on their first side to lying on their opposite side by: (a) changing a flexible body support structure from a first (flat) configuration to a second configuration as the person is lying on their first side, thereby at least partially enfolding and/or wrapping the person in the support structure; (b) rotating, tilting, and/or pivoting the support structure relative to a longitudinal axis, thereby rotating, tilting, and/or pivoting the person within the support structure; and then (c) changing the support structure from the second configuration back to the first configuration, thereby unfolding or unwrapping the support structure and releasing the person to lay on their opposite side.

Referring now to the drawings in general, the illustrations are for the purpose of describing one or more preferred embodiments of the invention and are not intended to limit the invention thereto.

FIGS. 1-12 show sequential views, from alternating perspectives, of an example of a device which helps a person in bed to avoid decubitus ulcers. This example comprises: a longitudinal flexible body support structure on which a person lies (wherein the support structure is selected from the group consisting of a sheet, blanket, pad, net, mesh, and hammock); wherein the support structure has a first configuration in which it is substantially flat and a second configuration in which it is folded (along a longitudinal axis) and/or wrapped at least partially around the person's body; and a plurality of actuators which change the support structure from its first configuration to its second configuration, or vice versa; wherein the person is moved from lying on their first side (e.g., their right side or left side) to lying on their opposite side (e.g., their left side if the first side is their right side or their right side if their first side is their left side) as follows—(a) activating the actuators to change the support structure from the first configuration to the second configuration as the person is lying on their first side, thereby at least partially enfolding the person in the support structure; activating the actuators to rotate, tilt, and/or pivot the support structure relative to a longitudinal axis, thereby rotating, tilting, and/or pivoting the person within the support structure; and (c) activating the actuators to change the support structure from the second configuration to the first configuration, thereby unfolding or unwrapping the support structure and releasing the person to lay on their second side.

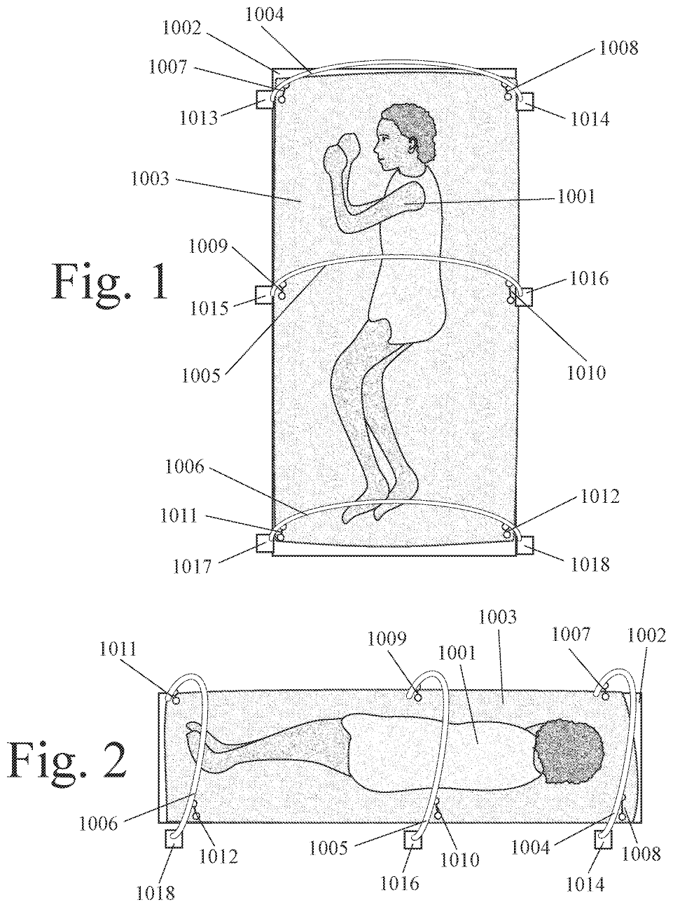

FIGS. 1 and 2 show top-down and oblique side views, respectively, of this example device at a first point in time. FIGS. 1 and 2 show a person 1001 lying on their right side on a flexible body support structure 1003. This support structure is selected from the group consisting of: a sheet, a blanket, a pad, a net, a mesh, and a hammock. This support structure has a first configuration in which it is substantially flat as is shown in FIGS. 1 and 2. This support structure has a second configuration in which it is folded along a longitudinal axis and/or wrapped at least partially around the person's body as will be shown in subsequent figures.

As shown in FIGS. 1 and 2, the structure also includes a plurality of actuators (1013, 1014, 1015, 1016, 1017, and 1018) that change the support structure from its first configuration to its second configuration, or vice versa, as is shown in subsequent figures. In this example, the device further comprises a mattress 1002 below the flexible body support structure. In this example, the device further comprises three lateral arches, ribs, beams, or arms (1004, 1005, and 1006), which span the mattress laterally (e.g., right to left). In this example, the device further comprises six connectors (1007, 1008, 1009, 1010, 1011, and 1012) which connect edges of the flexible body support structure to the three lateral arches, ribs, beams or arms. In this example, actuators move the connectors (e.g., right, left, up, and/or down) along the arches, ribs, beams or arms, thereby also moving the flexible body support structure which is attached to the connectors. In one example, the connectors slide along channels or tracks in the arches, ribs, beams or arms.

FIGS. 1 and 2 show top-down and oblique side views, respectively, of this example device at a first point in time. At this first time, a person is lying on their first side (e.g., right side in this example) on the longitudinal flexible body support structure. This is before the device has been activated to move the person.

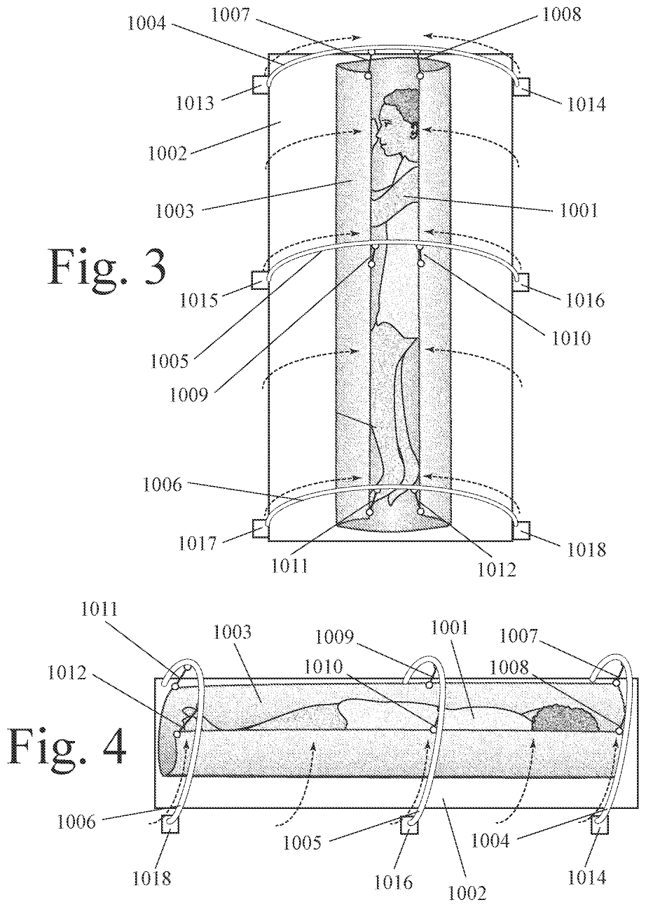

FIGS. 3 and 4 show top-down and oblique side views, respectively, of this example device at a second point in time. At this second time, the actuators have moved the support structure from its first (flat) configuration to its second (folded and/or wrapped) configuration. This at least partially enfolds or wraps the person in the support structure. In this example, this is done by having the actuators move the right-side and left-side connectors upward and inward along the arches, ribs, beams, or arms, toward a (central) longitudinal axis of the device. In one example, this partially or completely lifts the person off the mattress. In one example, this holds the lateral axis of the person's torso in a substantially vertical orientation.

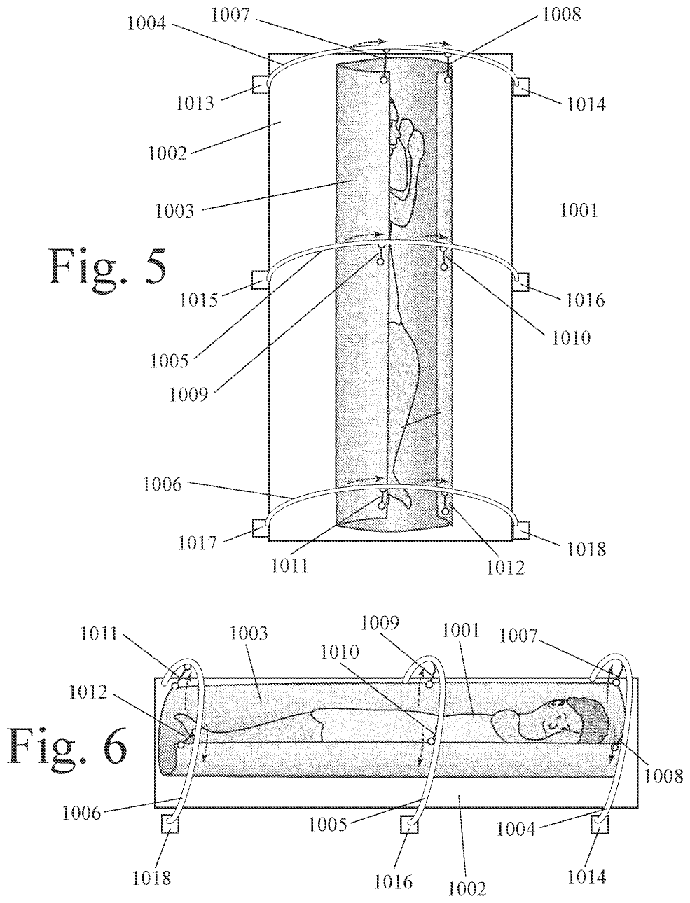

FIGS. 5 and 6 show top-down and oblique side views, respectively, of the device at a third point in time. At this third time, the actuators have rotated, tilted, and/or pivoted the support structure relative to a (central) longitudinal axis of the support structure, thereby rotating, tilting, and/or pivoting the person within the support structure. This changes the direction in which the person faces from one side of the mattress (e.g., the left side) to the other side of the mattress (e.g., the right side).

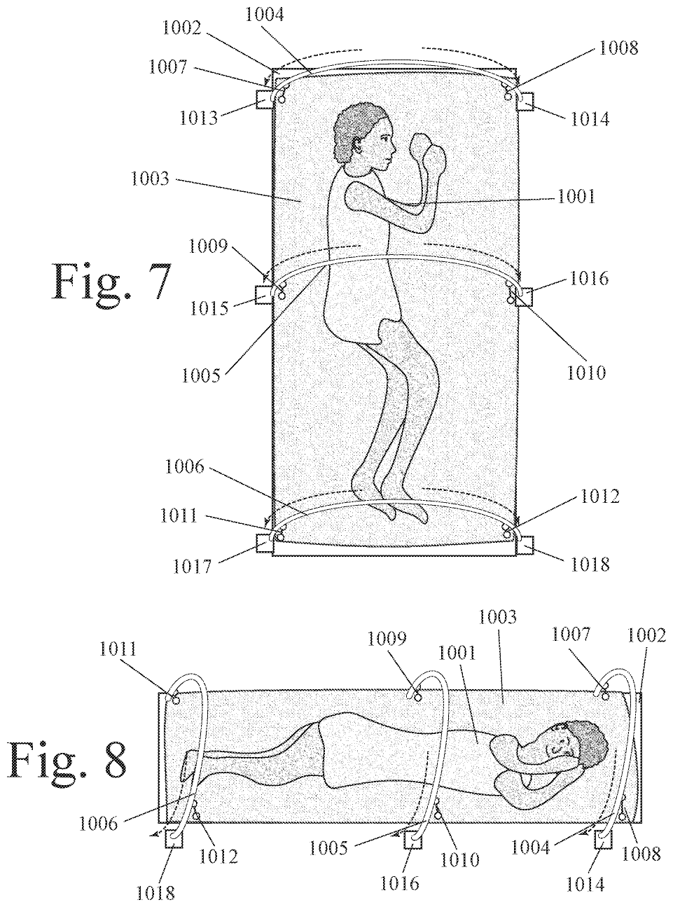

FIGS. 7 and 8 show top-down and oblique side views, respectively, of the example device at a fourth point in time. At this fourth time, the actuators have moved the support structure from its second (folded and/or wrapped) configuration back to its first (flat) configuration. This unfolds or unwraps the support structure and releases the person who is now lying on their left side.

The sequence of motions shown in FIGS. 1 through 8 shows how the device automatically turns a person from lying on their first side (e.g., their right side in this example) to lying on their opposite side (e.g., their left side in this example). Such a device is also able to move (e.g., turn) a person in the opposite direction, from lying on their left side to lying on their right side, using a symmetric sequence of motions and/or configurations.

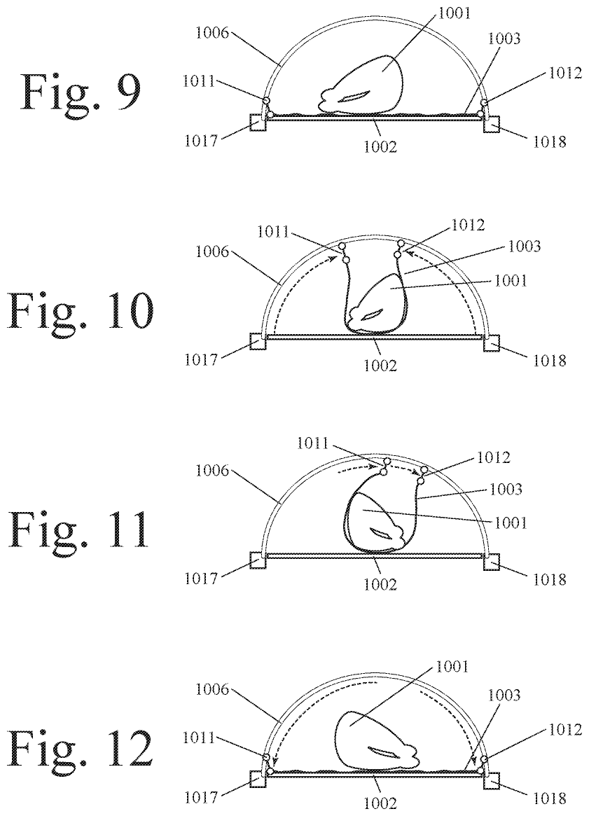

FIGS. 9-12 show additional views of the device and the sequence of motions which were just shown in FIGS. 1-8. FIGS. 9-12 show this device and this sequence from a different side perspective looking at the foot of the bed. FIGS. 9-12 show this device at the four points in time, respectively, corresponding to the four pairs of sequential top-down and oblique side views which were shown in FIGS. 1-8.

FIG. 9 shows a side view (looking at the foot of the bed) of a person lying on their right side at a first point in time, before the device is activated and before the person has been moved. FIG. 10 shows this side view (looking at the foot of the bed) of the person lying on their right side at a second point in time, after the device has been activated to lift up the sides of the support structure (e.g., sheet, blanket, pad, net, mesh, or hammock) so as to at least partially enfold and/or wrap the person within that support structure. FIG. 11 shows this side view (looking at the foot of the bed) of the person lying on their right side at a third point in time, after the device has been activated to rotate, tilt, and/or pivot the support structure, thereby rotating, tilting, and/or pivoting the person within the support structure. FIG. 12 shows this side view (looking at the foot of the bed) of the person lying on their right side at a fourth point in time, after the support structure has unfolded and/or unwrapped the person, thereby releasing the person to lay on their left side. Example variations discussed elsewhere in this disclosure or priority-linked disclosures are also able to be applied to this example where relevant.

In one example, a flexible body support structure is a sheet or blanket. In one example, a flexible body support structure is a mattress pad. In another example, a flexible body support structure is a net or mesh. In yet another example, a flexible body support structure is a hammock. In one example, a flexible body support structure is rectangular or square. In another example, a flexible body support structure has a rounded rectangular shape. In yet another example, a flexible body support structure has an oval or elliptical shape. In one example, a flexible body support structure is made from cotton, polyester, and/or nylon. In another example, a flexible body support structure is sufficiently strong to enfold and lift a person (e.g., 100 to 300 pounds in weight), but also sufficiently porous that it does not obstruct breathing when close to the person.

In one example, a flexible body support structure has lateral (e.g., left to right) variation in material, structure, strength, flexibility, durometer, porosity, and/or thickness. In one example, a flexible body support structure is conceptually divided into multiple (e.g., three) longitudinal segments. In one example, a central and/or middle longitudinal segment is made with a different (combination of) material than right and left side longitudinal segments. In one example, a central and/or middle longitudinal segment has a different level of strength than right and left side longitudinal segments. In one example, a central and/or middle longitudinal segment has a different level of flexibility than right and left side longitudinal segments. In one example, a central and/or middle longitudinal segment has a different durometer level than right and left side longitudinal segments. In one example, a central and/or middle longitudinal segment has a different porosity level than right and left side longitudinal segments. In one example, a central and/or middle longitudinal segment has a different thickness than right and left side longitudinal segments.

In one example, a central and/or middle longitudinal segment has a greater level of strength than right and left side longitudinal segments. In one example, a central and/or middle longitudinal segment has a greater level of flexibility than right and left side longitudinal segments. In one example, a central and/or middle longitudinal segment has a greater durometer level than right and left side longitudinal segments. In one example, a central and/or middle longitudinal segment has a greater porosity level than right and left side longitudinal segments. In one example, a central and/or middle longitudinal segment has a greater thickness than right and left side longitudinal segments.

In one example, a central and/or middle longitudinal segment has a lower level of strength than right and left side longitudinal segments. In one example, a central and/or middle longitudinal segment has a lower level of flexibility than right and left side longitudinal segments. In one example, a central and/or middle longitudinal segment has a lower durometer level than right and left side longitudinal segments. In one example, a central and/or middle longitudinal segment has a lower porosity level than right and left side longitudinal segments. In one example, a central and/or middle longitudinal segment has a lower thickness than right and left side longitudinal segments.

In one example, a laterally-central portion of a body support structure is made with a different material, and/or combination of materials, than laterally-non-central portions of a body support structure. In one example, a laterally-central portion of a body support structure has a different level of strength than laterally-non-central portions of a body support structure. In one example, a laterally-central portion of a body support structure has a different level of flexibility than laterally-non-central portions of a body support structure. In one example, a laterally-central portion of a body support structure has a different durometer level than laterally-non-central portions of a body support structure. In one example, a laterally-central portion of a body support structure has a different porosity level than laterally-non-central portions of a body support structure. In one example, a laterally-central portion of a body support structure has a different thickness than laterally-non-central portions of a body support structure.

In one example, a laterally-central portion of a body support structure has a greater level of strength than laterally-non-central portions of a body support structure. In one example, a laterally-central portion of a body support structure has a greater level of flexibility than laterally-non-central portions of a body support structure. In one example, a laterally-central portion of a body support structure has a greater durometer level than laterally-non-central portions of a body support structure. In one example, a laterally-central portion of a body support structure has a greater porosity level than laterally-non-central portions of a body support structure. In one example, a laterally-central portion of a body support structure has a greater thickness than laterally-non-central portions of a body support structure.

In one example, a laterally-central portion of a body support structure has a lower level of strength than laterally-non-central portions of a body support structure. In one example, a laterally-central portion of a body support structure has a lower level of flexibility than laterally-non-central portions of a body support structure. In one example, a laterally-central portion of a body support structure has a lower durometer level than laterally-non-central portions of a body support structure. In one example, a laterally-central portion of a body support structure has a lower porosity level than laterally-non-central portions of a body support structure. In one example, a laterally-central portion of a body support structure has a lower thickness than laterally-non-central portions of a body support structure.

In one example, a flexible body support structure has multiple layers. In one example, a lower layer is stronger than an upper layer. In one example, an upper layer is softer (e.g., more flexible and/or lower durometer) than a lower layer. In one example, an upper layer is more porous than a lower layer. In one example, an upper layer is made from a different material than a lower layer. In one example, an upper layer has a different thickness than a lower layer. In one example: an upper layer is a relatively-soft sheet, blanket, or pad; and a lower layer is a relatively strong net or mesh.

In one example, a lower layer of a body support structure has a greater level of strength than an upper layer of a body support structure. In one example, a lower layer of a body support structure has a greater level of flexibility than an upper layer of a body support structure.

In one example, a lower layer of a body support structure has a greater durometer level than an upper layer of a body support structure. In one example, a lower layer of a body support structure has a greater porosity level than an upper layer of a body support structure. In one example, a lower layer of a body support structure has a greater thickness than an upper layer of a body support structure.

In one example, a lower layer of a body support structure has a lower level of strength than an upper layer of a body support structure. In one example, a lower layer of a body support structure has a lower level of flexibility than an upper layer of a body support structure. In one example, a lower layer of a body support structure has a lower durometer level than an upper layer of a body support structure. In one example, a lower layer of a body support structure has a lower porosity level than an upper layer of a body support structure. In one example, a lower layer of a body support structure has a lower thickness than an upper layer of a body support structure.

In one example, a device has multiple lateral arches, ribs, beams, or arms which span over a flexible body support structure (and/or mattress) in a lateral (e.g., left to right) manner. In one example, a device has multiple concave (e.g., downward opening) beams and/or arms which span over a flexible body support structure (and/or mattress) in a lateral (e.g., left to right) manner. In one example, a device has three such lateral arches, ribs, beams, or arms. In one example, a device has four or five lateral arches, ribs, beams, or arms. In one example, a device has six or more lateral arches, ribs, beams, or arms which span over a mattress in a lateral (e.g., left to right) manner. In one example, the peak of a lateral arch, rib, beam, or arm is between 2 and 4 feet above a flexible body support structure in its first (flat) configuration. In one example, the peak of a lateral arch, rib, beam, or arm is between 3 and 5 feet above a flexible body support structure in its first (flat) configuration.

In one example, a lateral arch, rib, beam, or arm is stationary, but there are one or more moving connectors which slide along it (e.g., on a track or channel), wherein the one or more connectors are also connected to the flexible body support structure. In one example, a connector comprises a strap, strip, cord, band, loop, hook, or chain. In one example, a connector has a fixed length. In one example, a connector has an (automatically) adjustable length. In one example, a connector is elastic. In one example, a connector slides along a track or channel on a lateral arch, rib, beam, or arm. In one example, a connector comprises a loop which encircles and slides along a lateral arch, rib, beam, or arm (like a curtain slides along a curtain rod).

In one example, one or more connectors are moved along an arch, rib, beam, or arm by one or more actuators. In one example, the lengths of one or more connectors are changed by one or more actuators. In one example, an actuator is an electromagnetic actuator. In one example, an actuator is an electromagnetic motor. In one example, an actuator pulls, rotates, or otherwise moves a cord, chain, link, or belt which, in turn, moves a connector. In one example, one or more actuators are located on the right and/or left sides of the device (e.g., right and/or left sides of a mattress). In one example, one or more actuators are within an arch, rib, beam, or arm. In one example, there is one actuator for each connector. In one example, one actuator moves a plurality of connectors. In an alternative example, an actuator is a hydraulic or pneumatic actuator.

In one example, sliding one or more connectors along one or more arches, ribs, beams, or arms changes the configuration of a flexible body support structure. In one example, sliding one or more connectors along one or more arches, ribs, beams, or arms changes the configuration of a flexible body support structure from a first (substantially flat) configuration to a second (folded or wrapped) configuration, or vice versa. In one example, a flexible body support structure in its first configuration has a generally horizontal and linear cross-sectional shape (as viewed from the foot of the bed). In one example, a flexible body support structure in its second configuration has a generally U-shaped, C-shaped, circular, or elliptical cross-sectional shape (as viewed from the foot of the bed).

In one example, moving a first connector and a second connector closer together along a lateral arch, rib, beam, or arm draws the left side and the right side of a flexible body support structure closer together, thereby causing the flexible body support structure to at least partially enfold and/or wrap around a person on the flexible body support structure. In one example, moving both first and second connectors toward the center of a lateral arch, rib, beam, or arm draws the left and right sides of a flexible body support structure closer together, thereby causing the flexible body support structure to at least partially enfold and/or wrap around a person on the flexible body support structure. In one example, moving both first and second connectors toward one side of a lateral arch, rib, beam, or arm rotates, tilts, and/or pivots a folded flexible body support structure, thereby rotating, tilting, or pivoting the torso of a person enfolded and/or wrapped within the flexible body support structure. In one example, moving first and second connectors away from the center and toward the left and right sides, respectively, of a lateral arch, rib, beam, or arm unfolds and/or unwraps a flexible body support structure, thereby causing the flexible body support structure to release a person to lie on their side.

In one example, a lateral arch, rib, beam, or arm is connected to a flexible body support structure by (a pair of) first and second connectors. In one example, these first and second connectors are separated by a first distance when the flexible body support structure is in its first configuration and a second distance when the flexible body support structure is in its second configuration. In one example, the second distance is less than the first distance. In one example, the second distance is 1 to 2 feet less than the first distance. In one example, the second distance is 1 to 4 feet less than the first distance. In one example, one or more actuators slides first and second connectors up or down (and right or left) along a lateral arch, rib, beam, or arm. In one example, a body support surface comprises grommets along its sides to which connectors are attached. In one example, connectors are sewn or woven into, or otherwise an integral part of, a body support surface.

In one example, a flexible body support structure lifts a person up off a mattress and shifts them to the right or left before: rotating, tilting, or pivoting the person; and unfolding or unwrapping the person to lay on their other side. In one example, a flexible body support structure lifts a person up off the mattress and then shift them to the right or left in order to center them on a mattress before unfolding and releasing them to lay on their other side.

In one example, a device which helps a person in bed to avoid decubitus ulcers comprises: a longitudinal flexible body support structure on which a person lies; wherein the support structure is selected from the group consisting of a sheet, blanket, pad, net, mesh, and hammock; wherein the support structure has a first configuration in which it is substantially flat and a second configuration in which it is folded along a longitudinal axis and/or wrapped at least partially around the person's body; and a plurality of actuators which change the support structure from its first configuration to its second configuration, or vice versa; wherein the person is moved from lying on their first side, wherein their first side is their right side or left side, to lying on their opposite side, wherein their opposite side is their left side if the first side is their right side or is their right side if their first side is their left side, as follows: (a) activating the actuators to change the support structure from the first configuration to the second configuration as the person is lying on their first side, thereby at least partially enfolding the person in the support structure; (b) activating the actuators to move the support structure, and thereby also move the person, laterally to the right or left; (c) activating the actuators to rotate, tilt, and/or pivot the support structure relative to a longitudinal axis, thereby rotating, tilting, and/or pivoting the person within the support structure; and (d) activating the actuators to change the support structure from the second configuration to the first configuration, thereby unfolding or unwrapping the support structure and releasing the person to lay on their second side.

In an alternative example, a device has longitudinal arches, ribs, beams, and/or arms which longitudinally span a bed from head to foot (or vice versa). In one example, a flexible body support structure is connected to longitudinal arches, ribs, beams, and/or arms by a plurality of connectors. In one example, a flexible body support structure is directly attached to longitudinal arches, ribs, beams, and/or arms. In one example, channels in a flexible body support structure slides onto longitudinal arches, ribs, beams, and/or arms. In one example, a plurality of longitudinal arches, ribs, beams, and/or arms can move and thereby move an attached flexible body support structure.

In one example, the left side (e.g., left edge) of a flexible body support surface is attached to a first (left-side) longitudinal arch, rib, beam, and/or arm and the right side (e.g., right edge) of the support surface is attached to a second (right-side) longitudinal arch, rib, beam, and/or arm. In one example, when the first (left-side) longitudinal arch, rib, beam, and/or arm is moved right toward the longitudinal center of the device and the second (right-side) longitudinal arch, rib, beam, and/or arm is moved left toward the longitudinal center of the device, then this changes the support surface from its first configuration to its second configuration—lifting the sides of the support surface and enfolding the person within the support surface. In one example, when the first (left-side) longitudinal arch, rib, beam, and/or arm is moved left away from the longitudinal center of the device and the second (right-side) longitudinal arch, rib, beam, and/or arm is moved right away from the longitudinal center of the device, then this changes the support surface from its second configuration back to its first configuration—lowering the sides of the support surface and letting the person down onto the support surface.

In one example, a plurality of longitudinal arches, ribs, beams, and/or arms move laterally (e.g., left or right) with respect to a mattress and thereby move a flexible body support structure from its first configuration to its second configuration. In one example, a plurality of longitudinal arches, ribs, beams, and/or arms rotates, tilts, and/or pivots around joints which are located at the head and foot of a bed. In one example, a plurality of longitudinal arches, ribs, beams, and/or arms rotate, tilt, and/or pivot around joints which are centrally located at the head and foot of a bed.

In one example, this device further comprises one or more sensors selected from the group consisting of: motion sensor (e.g., accelerometer, gyroscope, or inclinometer); pressure sensor; moisture and/or humidity sensor; and biological and/or chemical sensor; camera; infrared sensor; ultrasonic sensor; and spectroscopic sensor. In one example, one or more sensors are attached to (or integrated into) a flexible body support structure. In one example, one or more sensors are attached to (or integrated into) a mattress. In one example, one or more sensors are attached to (or integrated into) a smart garment with which the device is in electromagnetic communication.

In one example, the device is triggered to automatically turn a person (from lying one side to the other) when data from one or more sensors indicates a high risk of the person getting a decubitus ulcer if they are not turned. In one example, the device is triggered to turn a person (from lying one side to the other) when data from one or more sensors indicates poor tissue oxygenation. In one example, a device is triggered to prompt a person for permission to turn the person (from lying one side to the other) when data from one or more sensors indicates a high risk of the person getting a decubitus ulcer if they are not turned. In one example, a person self-initiates and/or activates the device to turn the person from lying one side to the other. In one example, a person self-initiates such turning with an oral command. In one example, a person self-initiates such turning by touching a screen or pushing a button.

In one example, a device is triggered to turn a person (from lying one side to the other) when data from a motion sensor indicates a high risk of the person getting a decubitus ulcer if they are not turned. In one example, a device is triggered to turn a person (from lying one side to the other) when data from a pressure sensor indicates a high risk of the person getting a decubitus ulcer if they are not turned. In one example, a device is triggered to turn a person (from lying one side to the other) when data from a moisture and/or humidity sensor indicates a high risk of the person getting a decubitus ulcer if they are not turned. In one example, a device is triggered to turn a person (from lying one side to the other) when data from a biological and/or chemical sensor indicates a high risk of the person getting a decubitus ulcer if they are not turned.

In one example, a device is triggered to turn a person (from lying one side to the other) when data from a camera indicates a high risk of the person getting a decubitus ulcer if they are not turned. In one example, a device is triggered to turn a person (from lying one side to the other) when data from an infrared sensor (e.g., infrared scan) indicates a high risk of the person getting a decubitus ulcer if they are not turned. In one example, a device is triggered to turn a person (from lying one side to the other) when data from an ultrasonic sensor (e.g., ultrasound scan) indicates a high risk of the person getting a decubitus ulcer if they are not turned. In one example, a device is triggered to turn a person (from lying one side to the other) when data from a spectroscopic sensor indicates a high risk of the person getting a decubitus ulcer if they are not turned.

In one example, a device is only able to turn a person when the person consents for the device to do so. In one example, this consent is verbal. In one example, a device prompts a person, asking for their consent to turn the person, on a periodic basis. In one example, this periodic basis is programmed. In example, periodic turning is programmed with a first frequency while a person is awake and a second frequency while the person is asleep. In one example, the frequency with which a person is prompted for permission to turn the person is changed based on data from one or more sensors selected from the group consisting of: motion sensor (e.g., accelerometer, gyroscope, or inclinometer); pressure sensor; moisture and/or humidity sensor; and biological and/or chemical sensor; camera; infrared sensor; ultrasonic sensor; and spectroscopic sensor. In one example, the frequency with which a person is prompted for permission to turn the person is changed based on the degree of self-movement by the person as detected by sensors. In one example, the frequency with which a person is prompted for permission to turn the person is changed based on changes in the posture and/or configuration of the person as detected by sensors.

In one example, a device prompts a person for their consent to be moved (turned) and will not move (turn) the person from one side to the other without the person's (verbal) consent to do so. In one example, a device prompts a person at periodic intervals and does not move (turn) the person unless the device receives the person's (verbal) consent to do so. In one example, a device is triggered by one or more (motion, location, pressure, moisture, or biological) sensors which indicate a high risk of a person getting a decubitus ulcer unless the person is moved (turned). In one example, a person has voluntary control of the device so the device does not move (turn) the person unless the person activates it to do so.

In one example, a device further comprises safety mechanisms which protect a person from too much force or rapid movement during the turning process. In one example, a device further comprises pressure sensors and/or motion sensors which adjust the operation of the device to ensure that a person is not enfolded or wrapped with too much pressure or force. In one example, a device further comprises a microphone which monitors for breathing sounds to ensure that respiration is not harmed during the turning process and/or monitors for verbal commands to adjust or abandon the turning process.

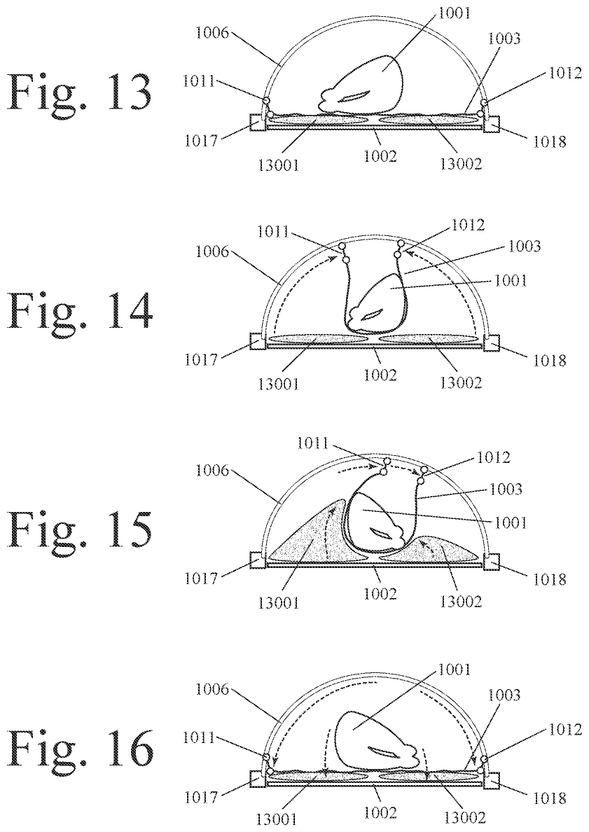

FIGS. 13-16 show four sequential side views (looking at the foot of the bed) of another example of a device to help avoid decubitus ulcers. This example is like the example shown in FIGS. 1-12, except that it further comprises right-side and left-side inflatable members. These inflatable members are selected from the group consisting of: inflatable cushion, pillow, wedge, compartment, mattress section, bladder, and balloon. Selective inflation and deflation of these members helps to rotate, tilt, and/or pivot the flexible body support structure in order to help turn the person from facing one direction (e.g., to the right) to facing the opposite direction (e.g., to the left).

In one example, selective inflation of one or more both of these inflatable members pushes the lower portion of the folded and/or wrapped flexible body support structure (at the third point in time) to the right or left, thereby rotating, tilting, and/or pivoting the person's torso. In one example, selection inflation and deflation of the right-side and left-side inflatable members pushes against the lower portion of the flexible body support structure to the right or left, while movement of connectors pulls the upper portion of the flexible body support structure to the left or right, thereby causing the body support structure to rotate, tilt, and/or pivot. This rotates, tilts, and/or pivots the person's body from facing in one lateral direction (e.g., left) to facing in the opposite lateral direction (e.g., right).

FIGS. 13 through 16 show this device at four sequential points in time, respectively, analogous to the four pairs of sequential top-down and oblique side views shown in FIGS. 1 through 8, but also including right-side and left-side inflatable members.

FIGS. 13-16 show four sequential side views (looking at the foot of the bed) of an example of a device which helps a person in bed to avoid decubitus ulcers. This device comprises: a longitudinal flexible body support structure 1003 on which a person 1001 lies (wherein the support structure is selected from the group consisting of a sheet, blanket, pad, net, mesh, and hammock); a plurality of actuators (including 1017 and 1018); a right-side inflatable member 13002, wherein the right-side inflatable member is selected from the group consisting of an inflatable cushion, pillow, wedge, compartment, mattress section, bladder, and balloon; and a left-side inflatable member 13001, wherein the left-side inflatable member is selected from the group consisting of an inflatable cushion, pillow, wedge, compartment, mattress section, bladder, and balloon; wherein the person is moved from lying on their first side (wherein their first side is their right side or left side) to lying on their opposite side (wherein their opposite side is their left side if the first side is their right side or is their right side if their first side is their left side) as follows: (a) activating the actuators to lift the right and left sides of the support structure, thereby at least partially wrapping the person in the support structure; (b) inflating the right-side and/or left-side inflatable members such that one or both of the inflatable members push against one or both sides of the support structure, thereby tilting, pivoting, and/or rotating the person's body around a longitudinal axis; and (c) activating the actuators to lower the right and left sides of the support structure, thereby unwrapping the support structure from the person's torso and lowering the person down to lay on their opposite side.

In the example shown in FIGS. 13-16, the device further comprises a mattress 1002 below the flexible body support structure. In this example, the device also comprises arches, ribs, beams or arms (including 1006) which span the mattress laterally (e.g., right to left). In this example, the device also comprises connectors (including 1011 and 1012) which connect edges of the flexible body support structure to lateral arches, ribs, beams or arms. In this example, the device the actuators move the connectors (e.g., right, left, up, and/or down) along the arches, ribs, beams or arms, thereby also moving the flexible body support structure which is attached to the connectors. In one example, the connectors slide along channels or tracks in the arches, ribs, beams or arms.

FIG. 13 shows a side view (looking at the foot of the bed) of a person lying on their right side at a first point in time, before the device is activated and before the person has been moved. FIG. 14 shows this side view (looking at the foot of the bed) of the person lying on their right side at a second point in time, after the device has been activated to lift up the sides of the support structure (e.g., sheet, a blanket, a pad, a net, a mesh, and a hammock) so as to at least partially enfold and/or wrap the person within that support structure. FIG. 15 shows this side view (looking at the foot of the bed) of the person lying on their right side at a third point in time, after the device has been activated to rotate, tilt, and/or pivot the support structure and the right-side and left-side inflatable members have been selectively inflated, thereby rotating, tilting, and/or pivoting the person within the support structure. FIG. 16 shows this side view (looking at the foot of the bed) of the person lying on their right side at a fourth point in time, after the inflatable members have been deflated and the support structure has unfolded and/or unwrapped the person, thereby releasing the person to lay on their left side.

In one example, a left-side inflatable member is inflated more than a right-side inflatable member as a person is turned from lying on their right side to lying on their left side. In one example, a left-side inflatable member is inflated more than a right-side inflatable member as a person is turned from lying on their right side to lying on their left side in order to rotate the person's torso in a clockwise direction (as viewed from the foot of the bed). In one example, a right-side inflatable member is inflated more than a left-side inflatable member as a person is turned from lying on their left side to lying on their right side. In one example, a right-side inflatable member is inflated more than a left-side inflatable member as a person is turned from lying on their left side to lying on their right side in order to rotate the person's torso in a counter-clockwise direction (as viewed from the foot of the bed).

In one example, a left-side inflatable member is inflated less than a right-side inflatable member as a person is turned from lying on their right side to lying on their left side. In one example, a left-side inflatable member is inflated less than a right-side inflatable member as a person is turned from lying on their right side to lying on their left side in order to rotate the person's torso in a clockwise direction (as viewed from the foot of the bed). In one example, a right-side inflatable member is inflated less than a left-side inflatable member as a person is turned from lying on their left side to lying on their right side. In one example, a right-side inflatable member is inflated less than a left-side inflatable member as a person is turned from lying on their left side to lying on their right side in order to rotate the person's torso in a counter-clockwise direction (as viewed from the foot of the bed).

In one example, a left-side inflatable member is inflated more than a right-side inflatable member as a person is turned from lying on their right side to lying on their left side. In one example, a left-side inflatable member is inflated more than a right-side inflatable member as a person is turned from lying on their right side to lying on their left side in order to rotate the person's torso in a counter-clockwise direction (as viewed from the foot of the bed). In one example, a right-side inflatable member is inflated more than a left-side inflatable member as a person is turned from lying on their left side to lying on their right side. In one example, a right-side inflatable member is inflated more than a left-side inflatable member as a person is turned from lying on their left side to lying on their right side in order to rotate the person's torso in a clockwise direction (as viewed from the foot of the bed).

In one example, a left-side inflatable member is inflated less than a right-side inflatable member as a person is turned from lying on their right side to lying on their left side. In one example, a left-side inflatable member is inflated less than a right-side inflatable member as a person is turned from lying on their right side to lying on their left side in order to rotate the person's torso in a counter-clockwise direction (as viewed from the foot of the bed). In one example, a right-side inflatable member is inflated less than a left-side inflatable member as a person is turned from lying on their left side to lying on their right side. In one example, a right-side inflatable member is inflated less than a left-side inflatable member as a person is turned from lying on their left side to lying on their right side in order to rotate the person's torso in a clockwise direction (as viewed from the foot of the bed).

In one example, an inflatable member on one side is inflated first, and then the inflatable member on the other side is inflated, as a person is turned from lying on one side to lie on their other side. In one example, a right-side inflatable member is inflated as a left-side connector is moved (toward a central longitudinal axis of a mattress) in order to rotate, tilt, and/or pivot a person who is enfolded or wrapped within a folded flexible body support structure (in its second configuration). In one example, a left-side inflatable member is inflated as a right-side connector is moved (toward a central longitudinal axis of a mattress) in order to rotate, tilt, and/or pivot a person who is enfolded or wrapped within a folded flexible body support structure (in its second configuration).

The example shown in FIGS. 13-16 includes right-side and left-side expandable members which are inflated or deflated with a gas. In an alternative example, right-side and left-side expandable members are expanded or contracted by filling or draining a liquid. In this alternative example, right-side and left-side expandable members are hydraulic members instead of inflatable members. Example variations discussed elsewhere in this disclosure or priority-linked disclosures are also able to be applied to this example where relevant.

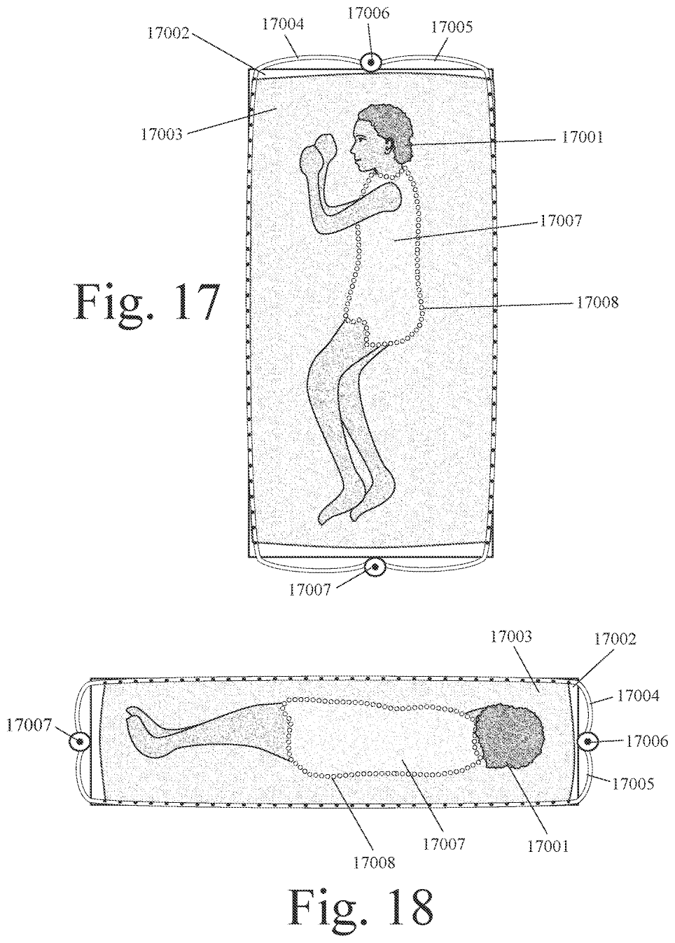

FIGS. 17-24 show another example of a device to help avoid decubitus ulcers. This example is like the one shown in FIGS. 1 through 12, except that it has longitudinal arches, ribs, beams, or arms instead of lateral arches, ribs, beams, or arms. Also, in this example a flexible body support structure is directly attached to the arches, ribs, beams, or arms. The arches, ribs, beams, or arms move in order to change the flexible body support structure from its first (flat) configuration to its second (folded or wrapped) configuration.

FIGS. 17-24 show sequential views, from alternating perspectives, of an example of a device which helps a person in bed to avoid decubitus ulcers. This example comprises: a longitudinal flexible body support structure on which a person lies (wherein the support structure is selected from the group consisting of a sheet, blanket, pad, net, mesh, and hammock); wherein the support structure has a first configuration in which it is substantially flat and a second configuration in which it is folded along a longitudinal axis and/or wrapped at least partially around the person's body; and a plurality of actuators which change the support structure from its first configuration to its second configuration, or vice versa; wherein the person is moved from lying on their first side (wherein their first side is their right side or left side) to lying on their opposite side (wherein their opposite side is their left side if the first side is their right side or is their right side if their first side is their left side) as follows: (a) activating the actuators to change the support structure from the first configuration to the second configuration as the person is lying on their first side, thereby at least partially enfolding the person in the support structure; (b) activating the actuators to rotate, tilt, and/or pivot the support structure relative to a longitudinal axis, thereby rotating, tilting, and/or pivoting the person within the support structure; and (c) activating the actuators to change the support structure from the second configuration to the first configuration, thereby unfolding or unwrapping the support structure and releasing the person to lay on their second side.

FIGS. 17 and 18 show top-down and oblique side views, respectively, of this example device at a first point in time. FIGS. 17 and 18 show a person 17001 lying on their right side on a flexible body support structure 17003. This support structure is selected from the group consisting of: a sheet, a blanket, a pad, a net, a mesh, and a hammock. This support structure has a first configuration in which it is substantially flat as is shown in FIGS. 17 and 18. This support structure also has a second configuration in which it is folded along a longitudinal axis and/or wrapped at least partially around the person's body as is shown in subsequent figures.

In the example shown in FIGS. 17 and 18, the device further comprises a mattress 17002 below the flexible body support structure. In this example, the device further comprises two longitudinal arches, ribs, beams or arms 17004 and 17005 which are rotated, tilted, and/or pivoted by actuators 17006 and 17007. In this example, a flexible body support structure is directly attached to the longitudinal arches, ribs, beams or arms. In this example, the actuators move the arches, ribs, beams or arms, thereby also moving the flexible body support structure.

FIGS. 17 and 18 show top-down and oblique side views, respectively, of this example device at a first point in time. At this first time, the person is lying on their first side (e.g., right side in this example) on the longitudinal flexible body support structure. This is before the device has been activated to move the person. In one embodiment, the person is covered by a garment 17007 with pressure sensors 17008.

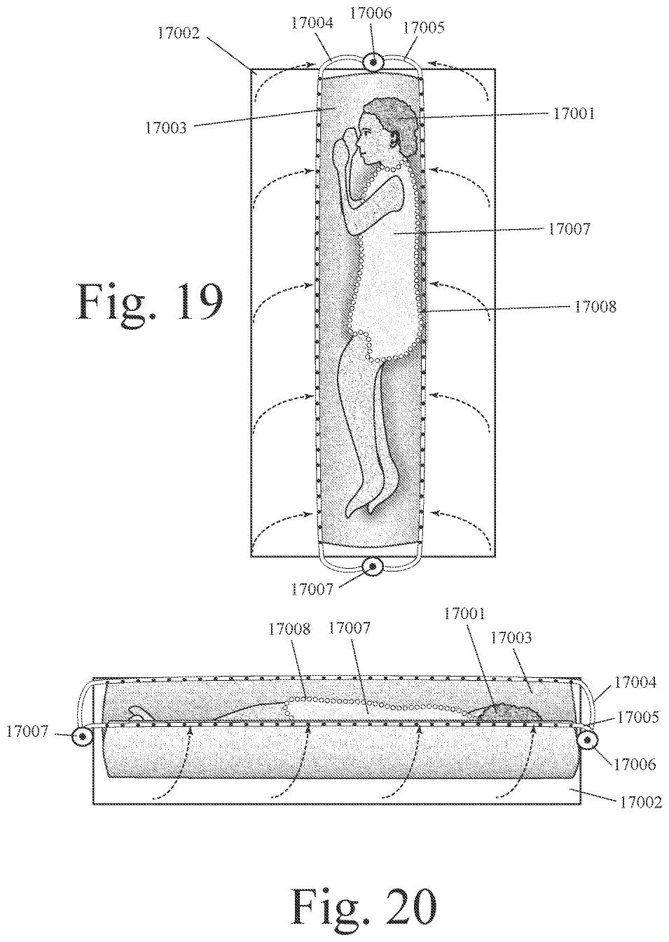

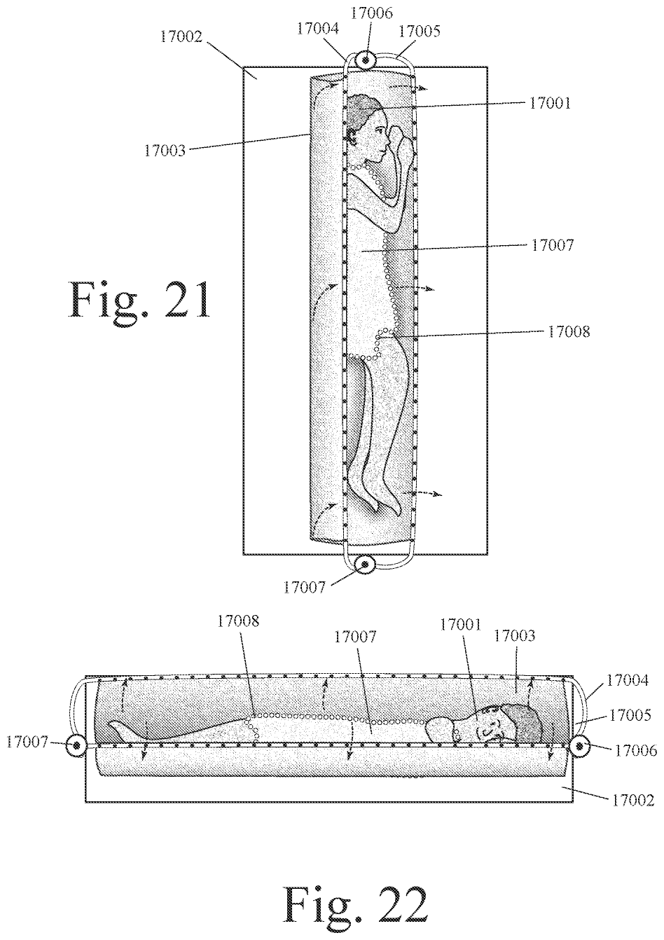

FIGS. 19 and 20 show top-down and oblique side views, respectively, of this example device at a second point in time. At this second time, the actuators have moved the two arches, ribs, beams or arms toward the center of the mattress. This at least partially enfolds or wraps the person in the support structure. In one example, this partially or completely lifts the person off the mattress. In one example, this holds the lateral (right to left) axis of the person's torso in a substantially vertical orientation.

FIGS. 21 and 22 show top-down and oblique side views, respectively, of this example device at a third point in time. At this third time, the actuators have rotated, tilted, and/or pivoted the support structure relative to a (central) longitudinal axis of the support structure, thereby rotating, tilting, and/or pivoting the person within the support structure. This changes the direction in which the person faces from facing toward one side of the mattress (e.g., the left side) to facing toward the other side of the mattress (e.g., the right side).

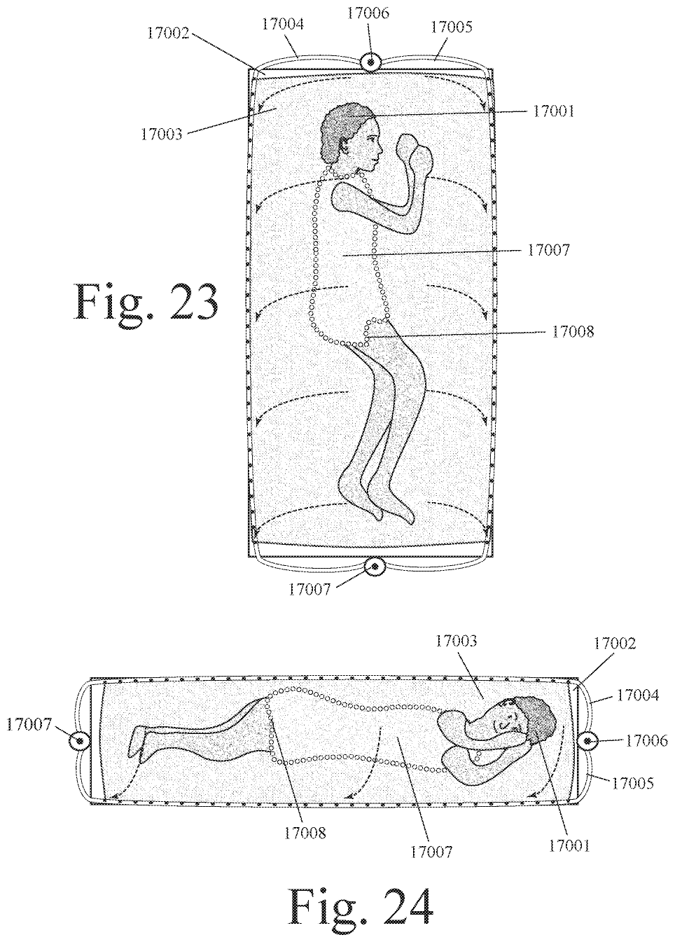

FIGS. 23 and 24 show top-down and oblique side views, respectively, of this example device at a fourth point in time. At this fourth time, the actuators have moved the support structure from its second (folded and/or wrapped) configuration back to its first (flat) configuration. This releases the person, who is now lays on their left side. The sequence of device motions shown in FIGS. 17 through 24 shows how the device automatically turns a person from lying on their first side (e.g., their right side in this example) to lying on their opposite side (e.g., their left side in this example). Such a device also moves (e.g., turn) a person in the opposite direction, from lying on their left side to lying on their right side, using a symmetric sequence of motions and/or configurations.

In an alternative example, a device has longitudinal arches, ribs, beams, and/or arms which longitudinally span a bed from head to foot (or vice versa). In one example, a flexible body support structure is connected to longitudinal arches, ribs, beams, and/or arms by a plurality of connectors. In one example, a flexible body support structure is directly attached to longitudinal arches, ribs, beams, and/or arms. In one example, channels in a flexible body support structure slides onto longitudinal arches, ribs, beams, and/or arms. In one example, a plurality of longitudinal arches, ribs, beams, and/or arms move and thereby move an attached flexible body support structure.

In one example, the left side (e.g., left edge) of a flexible body support surface is attached to a first (left-side) longitudinal arch, rib, beam, and/or arm and the right side (e.g., right edge) of the support surface is attached to a second (right-side) longitudinal arch, rib, beam, and/or arm. In one example, when the first (left-side) longitudinal arch, rib, beam, and/or arm is moved right toward the longitudinal center of the device and the second (right-side) longitudinal arch, rib, beam, and/or arm is moved left toward the longitudinal center of the device, then this changes the support surface from its first configuration to its second configuration—lifting the sides of the support surface and enfolding the person within the support surface. In one example, when the first (left-side) longitudinal arch, rib, beam, and/or arm is moved left away from the longitudinal center of the device and the second (right-side) longitudinal arch, rib, beam, and/or arm is moved right away from the longitudinal center of the device, then this changes the support surface from its second configuration back to its first configuration—lowering the sides of the support surface and letting the person down onto the support surface.

In one example, a plurality of longitudinal arches, ribs, beams, and/or arms moves laterally (e.g., left or right) with respect to a mattress and thereby move a flexible body support structure from its first configuration to its second configuration. In one example, a plurality of longitudinal arches, ribs, beams, and/or arms rotate, tilt, and/or pivot around joints which are located at the head and foot of a bed. In one example, a plurality of longitudinal arches, ribs, beams, and/or arms rotate, tilt, and/or pivot around joints which are centrally located at the head and foot of a bed. Example variations discussed elsewhere in this disclosure or priority-linked disclosures are also applied to this example where relevant.

In variations on the examples herein, a “beam” is further specified as an “arcuate beam.” In variations on the examples herein, a “beam” is alternatively specified as a “rib,” “rod,” “arch,” or “arm.” In variations on the examples herein, a “flexible support structure” or “support structure” is alternatively specified as a “net,” “mesh,” “hammock,” “sleeping bag,” “mattress pad,” “sling,” “sheet,” or “blanket.” In variations on the examples herein, an actuator is further specified as an “electromagnetic actuator,” “pneumatic actuator,” or “hydraulic actuator.” In variations on the examples herein, a “cushion” is alternatively specified as a “compartment,” “bladder,” “pad,” or “pillow.” In variations on the examples herein, an “expandable” member is further specified as an “inflatable” member.

In variations on the examples herein, a device is triggered to move a person at regular and/or periodic intervals in order to avoid prolonged periods of pressure on tissue on a given side of the person's body. In variations on the examples herein, a device is triggered to move a person lying on their first (e.g., right) side to lying on their opposite (left or right) side at regular and/or periodic intervals in order to avoid prolonged periods of pressure on tissue on a given side of the person's body. In variations on the examples herein, a device is triggered to move a person lying on their first (e.g., right) side to lying on their opposite (left or right) side at a periodic interval between 1 hour and 6 hours in order to avoid prolonged periods of pressure on tissue on a given side of the person's body. In variations on the examples herein, a device is triggered to move a person lying on their first (e.g., right) side to lying on their opposite (left or right) side at a periodic interval, wherein the length of the period interval is based on data from one or more sensors selected from the group consisting of: body motion sensor; inertial sensor; stretch sensor; moisture or humidity sensor; temperature sensor; pressure sensor; tissue oxygenation sensor; electromagnetic energy sensor; spectroscopic or other light energy sensor; and sonic energy sensor.

In variations on the examples herein, a device is triggered to move a person based on data from one or more environmental sensors (e.g., pressure sensors, motion sensors, temperature sensors, or moisture sensors) which are incorporated into a support structure which is under the person's body and/or embedded into a garment which is worn by the person. In variations on the examples herein, a device is triggered to move a person based on data from one or more biometric sensors (e.g., tissue oxygenation sensors, body temperature sensors, or blood flow sensors) which are incorporated into a support structure which is under the person's body and/or embedded into a garment which is worn by the person. In variations on the examples herein, a device is triggered to move a person based on data from one or more sensors selected from the group consisting of: body motion sensor; inertial sensor; stretch sensor; moisture or humidity sensor; temperature sensor; pressure sensor; tissue oxygenation sensor; electromagnetic energy sensor; spectroscopic or other light energy sensor; and sonic energy sensor.

In variations on the examples herein, a device is triggered to move a person based on data from one or more sensors which are incorporated into a support structure, wherein the sensors are selected from the group consisting of: body motion sensor; inertial sensor; stretch sensor; moisture or humidity sensor; temperature sensor; pressure sensor; tissue oxygenation sensor; electromagnetic energy sensor; spectroscopic or other light energy sensor; and sonic energy sensor. In variations on the examples herein, a device is triggered to move a person based on data from one or more sensors which are incorporated into an article of clothing or garment, wherein the sensors are selected from the group consisting of: body motion sensor; inertial sensor; stretch sensor; moisture or humidity sensor; temperature sensor; pressure sensor; tissue oxygenation sensor; electromagnetic energy sensor; spectroscopic or other light energy sensor; and sonic energy sensor.

In variations on the examples herein, a device is triggered to move a person based on analysis of images from a camera. In variations on the examples herein, a device is triggered to move based on data from one or more environmental sensors (e.g., pressure sensors, motion sensors, temperature sensors, or moisture sensors) which are incorporated into a support structure which is under the person's body and/or embedded into a garment which is worn by the person. In variations on the examples herein, a device is triggered to move based on data from one or more biometric sensors (e.g., tissue oxygenation sensors, body temperature sensors, or blood flow sensors) which are incorporated into a support structure which is under the person's body and/or embedded into a garment which is worn by the person. In variations on the examples herein, a device is triggered to move based on data from one or more sensors selected from the group consisting of: body motion sensor; inertial sensor; stretch sensor; moisture or humidity sensor; temperature sensor; pressure sensor; tissue oxygenation sensor; electromagnetic energy sensor; spectroscopic or other light energy sensor; and sonic energy sensor.

In variations on the examples herein, a device is triggered to move based on data from one or more sensors which are incorporated into a support structure, wherein the sensors are selected from the group consisting of: body motion sensor; inertial sensor; stretch sensor; moisture or humidity sensor; temperature sensor; pressure sensor; tissue oxygenation sensor; electromagnetic energy sensor; spectroscopic or other light energy sensor; and sonic energy sensor. In variations on the examples herein, a device is triggered to move based on data from one or more sensors which are incorporated into an article of clothing or garment, wherein the sensors are selected from the group consisting of: body motion sensor; inertial sensor; stretch sensor; moisture or humidity sensor; temperature sensor; pressure sensor; tissue oxygenation sensor; electromagnetic energy sensor; spectroscopic or other light energy sensor; and sonic energy sensor. In variations on the examples herein, a device is triggered to move based on analysis of images from a video camera.

In one example, a device which helps a person to avoid decubitus ulcers comprises: a support structure (such as a mattress) on which a person lies, wherein the support structure further comprises a plurality of height-adjustable portions whose heights are individually adjusted; a camera which records images which are analyzed to determine the location of a selected part of the person's body on the support structure at a selected time; wherein the heights of the portions which are below the selected part of the person's body at the selected time are set lower than the heights of the rest of the portions. Alternatively, a device to help a person in bed to avoid decubitus ulcers comprises: a support structure (such as a mattress) on which a person lies, wherein the support structure further comprises a plurality of inflated portions (e.g., cells, compartments, bladders, or columns) whose inflation levels are individually adjusted; a camera which records images which are analyzed to determine the location of a selected part of the person's body on the support structure at a selected time; wherein the inflated portions which are below the selected part of the person's body at the selected time are inflated less than the rest of the inflated portions.

A device to help a person in bed to avoid decubitus ulcers also comprises: a flexible support structure (such as a net, mesh, hammock, sling, sheet, blanket, mattress pad, folding mattress, articulating mattress, or shape-changing mattress) with a longitudinal axis, wherein a person lies on the flexible support structure on their right side or on their left side at different times, wherein the support structure has a first configuration which is substantially flat, wherein the support structure has a second configuration with a concavity which faces toward a selected (e.g., right or left) side and the person's body is at least partially within the concavity, and wherein the support structure has a third configuration with a concavity which faces toward the opposite (e.g., left or right) side and the person's body is at least partially within the concavity; a camera; and a plurality of actuators which are triggered at least in part by analysis of images from the camera to move the support structure from its first configuration to its second configuration to its third configuration and then back to its first configuration. Alternatively, a device to help a person in bed to avoid decubitus ulcers comprises: a concave flexible support structure (e.g., net, mesh, hammock, sling, sheet, or blanket) on which a person lies; a first arch which spans over the width of the support structure, wherein the first arch is less than two feet away from the head of the support structure, wherein two corners or edges of the support structure are connected to the first arch; a second arch which spans over the width of the support structure, wherein the second arch is less than two feet away from the foot of the support structure, wherein two other corners or edges of the support structure are connected to the second arch, and wherein the support structure is suspended between the first arch and the second arch; and a plurality of actuators which move the locations of the connections between the support structure and the arches along (tracks on) the arches, thereby changing the slope and/or shape of the support structure suspended between the first and second arches, thereby helping the person to turn from lying on their first (e.g., right) side to lying on their second (e.g., left) side.

In one example, a device which helps to prevent decubitus ulcers comprises: a longitudinal flexible support structure on which a person lies, wherein the support structure further comprises a head portion which is closer to the person's head and a foot portion which is closer to the person's foot; a first arcuate beam which curves over the width of the support structure, wherein corners (or edges or sides) of the head portion of the support structure are connected to the first beam at a plurality of connections; a second arcuate beam which curves over the width of the support structure, wherein corners (or edges or sides) of the foot portion of the support structure are connected to the second arcuate beam at a plurality of connections; and a plurality of actuators which move the connections on the first arcuate beam and the connections on the second arcuate beam; wherein the plurality of actuators move the connections in the following sequential manner; firstly, the actuators move the connections on the first arcuate beam closer together and the connections on the second arcuate beam closer together, thereby gently folding the support structure around the person's body as the person is lying on their first side; secondly, the actuators jointly move the connections on the first arcuate beam along the first arcuate beam and jointly move the connections on the second arcuate beam along the second arcuate beam, thereby rotating and/or tilting the person's body; and thirdly, the actuators move the connections on the first arcuate beam farther apart and move the connections on the second arcuate beam farther apart, thereby gently unfolding the support structure from the person's body and leaving the person lying on their second side. Alternatively, a device to help a person in bed to avoid decubitus ulcers comprises: a concave flexible support structure (e.g., net, mesh, hammock, sling, sheet, or blanket) on which a person lies; a first arcuate beam which spans (in an arc) over and across the width of the support structure, wherein the first arcuate beam is less than two feet away from the head of the support structure, wherein two sides or edges of the support structure are connected to the first arcuate beam; a second arcuate beam which spans (in an arc) over and across the width of the support structure, wherein the second arcuate beam is less than two feet away from the foot of the support structure, wherein two other sides or edges of the support structure are connected to the second arcuate beam, and wherein the support structure is suspended between the first arcuate beam and the second arcuate beam; and a plurality of actuators which move the locations of the connections between the support structure and the arcuate beams, thereby changing the slope and/or shape of the support structure suspended between the first and second arcuate beams, thereby helping the person to turn from lying on their first (e.g., right) side to lying on their second (e.g., left) side.

In another example, a device to help a person in bed to avoid decubitus ulcers comprises: a flexible support structure (e.g., net, mesh, hammock, sling, sheet, or blanket) on which a person lies; a first arcuate beam which spans (in an arc) over and across the width of the support structure, wherein two corners or edges of the support structure are connected to the first arcuate beam; a second arcuate beam which spans (in an arc) over and across the width of the support structure, wherein the first arcuate beam is closer to the head of the support structure than the second arcuate beam, wherein two other corners or edges of the support structure are connected to the second arcuate beam, and wherein the support structure is suspended between the first arcuate beam and the second arcuate beam; and a plurality of actuators which move the connections between the support structure and the same arcuate beam closer together or farther apart, thereby changing the slope and/or shape of the support structure suspended between the first and second arcuate beams, and thereby helping the person to turn from lying on their first (e.g., right) side to lying on their second (e.g., left) side.

Alternatively, a device to help a person in bed to avoid decubitus ulcers comprises: a longitudinal flexible support structure on which a person lies, wherein the support structure further comprises a head portion which is closer to the person's head and a foot portion which is closer to the person's foot; a first beam which spans the width of the support structure, wherein corners (or edges) of the head portion of the support structure are connected to the first beam at a plurality of connections; a second beam which spans the width of the support structure, wherein corners (or edges) of the foot portion of the support structure are connected to the second beam at a plurality of connections; and a plurality of actuators which move the connections on the first beam and the connections on the second beam; wherein the plurality of actuators move the connections in the following sequential manner; firstly, the actuators move the connections on the first beam closer together and the connections on the second beam closer together, thereby gently folding the support structure around the person's body as the person is lying on their first side; secondly, the actuators jointly move the connections on the first beam along the first beam and jointly move the connections on the second beam along the second beam, thereby rotating and/or tilting the person's body; and thirdly, the actuators move the connections on the first beam farther apart and move the connections on the second beam farther apart, thereby gently unfolding the support structure from the person's body and leaving the person lying on their second side.

In one example, a device which helps a person in bed to avoid decubitus ulcers comprises: a bed mattress with a concave upper surface on which a person lies; a first inflatable compartment (or cushion) with an inflation level which varies over time on a first (right or left) side of the mattress; a second inflatable compartment (or cushion) with an inflation level which varies over time on a second (left or right) side of the mattress; wherein the first and second inflatable compartments are both inflated during a first time period, but the first compartment is inflated more than the second compartment; wherein the first and second inflatable compartments are both deflated during a second time period, but the first compartment is deflated more than the second compartment; and wherein the person is moved from lying on their first (e.g., right) side to lying on their second (e.g., left) side during the first and second time periods by sequential inflation and deflation of the first and second inflatable compartments. Alternatively, a device to help a person in bed to avoid decubitus ulcers comprises: an article of clothing which is worn by a person lying in a bed; a first set of one or more pressure sensors integrated into a first portion of the article of clothing; a second set of one or more pressure sensors integrated into a second portion of the article of clothing; a first porous array of inflatable micro-bladders integrated into the first portion of the article of clothing; a second porous array of inflatable micro-bladders integrated into the second portion of the article of clothing; wherein the first net or mesh is inflated based on pressure level and/or duration measured by the first set of one or more pressure sensors; and wherein the second net or mesh is inflated based on pressure level and/or duration measured by the second set of one or more pressure sensors.

For example, a device to help a person in bed to avoid decubitus ulcers comprises: an article of clothing which is worn by a person lying in a bed; a first set of one or more pressure sensors integrated into a first portion of the article of clothing; a second set of one or more pressure sensors integrated into a second portion of the article of clothing; a first nested array of inflatable micro-bladders integrated into the first portion of the article of clothing; a second nested array of inflatable micro-bladders integrated into the second portion of the article of clothing; wherein the first net or mesh is inflated based on pressure level and/or duration measured by the first set of one or more pressure sensors; and wherein the second net or mesh is inflated based on pressure level and/or duration measured by the second set of one or more pressure sensors. Alternatively, a device to help a person in bed to avoid decubitus ulcers comprises: an article of clothing which is worn by a person lying in a bed; a first set of one or more pressure sensors integrated into a first portion of the article of clothing; a second set of one or more pressure sensors integrated into a second portion of the article of clothing; a first porous grid of inflatable micro-bladders integrated into the first portion of the article of clothing; a second porous grid of inflatable micro-bladders integrated into the second portion of the article of clothing; wherein the first net or mesh is inflated based on pressure level and/or duration measured by the first set of one or more pressure sensors; and wherein the second net or mesh is inflated based on pressure level and/or duration measured by the second set of one or more pressure sensors.

In another example, a device which helps a person in bed to avoid decubitus ulcers comprises: an article of clothing which is worn by a person lying in a bed; a first set of one or more pressure sensors integrated into a first portion of the article of clothing; a second set of one or more pressure sensors integrated into a second portion of the article of clothing; a first porous grid of inflatable micro-bubbles integrated into the first portion of the article of clothing; a second porous grid of inflatable micro-bubbles integrated into the second portion of the article of clothing; wherein the first net or mesh is inflated based on pressure level and/or duration measured by the first set of one or more pressure sensors; and wherein the second net or mesh is inflated based on pressure level and/or duration measured by the second set of one or more pressure sensors. Alternatively, a device to help a person in bed to avoid decubitus ulcers comprises: an article of clothing which is worn by a person lying in a bed; a first set of one or more pressure sensors on a first portion of the article of clothing; a second set of one or more pressure sensors on a second portion of the article of clothing; a first inflatable net or mesh on the first portion of the article of clothing; a second inflatable net or mesh on the second portion of the article of clothing; wherein the first net or mesh is inflated based on data from the first set of one or more pressure sensors; and wherein the second net or mesh is inflated based on data from the second set of one or more pressure sensors.

In one example, a device to help a person in bed to avoid decubitus ulcers comprises: an article of clothing which is worn by a person lying in a bed; a first set of one or more pressure sensors on a first portion or section of the article of clothing; a second set of one or more pressure sensors on a second portion or section of the article of clothing; a first concentric array of inflatable micro-bladders on the first portion or section of the article of clothing; a second concentric array of inflatable micro-bladders on the second portion or section of the article of clothing; wherein the first net or mesh is inflated based on pressure level and/or duration measured by the first set of one or more pressure sensors; and wherein the second net or mesh is inflated based on pressure level and/or duration measured by the second set of one or more pressure sensors. Alternatively, a device to help a person in bed to avoid decubitus ulcers comprises: an article of clothing which is worn by a person lying in a bed; a first set of one or more pressure sensors on a first portion or section of the article of clothing; a second set of one or more pressure sensors on a second portion or section of the article of clothing; a first radial array of inflatable micro-bladders on the first portion or section of the article of clothing; a second radial array of inflatable micro-bladders on the second portion or section of the article of clothing; wherein the first net or mesh is inflated based on pressure level and/or duration measured by the first set of one or more pressure sensors; and wherein the second net or mesh is inflated based on pressure level and/or duration measured by the second set of one or more pressure sensors.

In another embodiment, a device to help a person in bed to avoid decubitus ulcers comprises: an article of clothing which is worn by a person lying in a bed; a first set of one or more pressure sensors on a first portion or section of the article of clothing; a second set of one or more pressure sensors on a second portion or section of the article of clothing; a first porous grid of inflatable micro-chambers on the first portion or section of the article of clothing; a second porous grid of inflatable micro-chambers on the second portion or section of the article of clothing; wherein the first net or mesh is inflated based on pressure level and/or duration measured by the first set of one or more pressure sensors; and wherein the second net or mesh is inflated based on pressure level and/or duration measured by the second set of one or more pressure sensors. Alternatively, a device which helps to prevent decubitus ulcers comprises: an article of clothing which is worn by a person lying in a bed; a first set of one or more pressure sensors which is attached to a first area of the article of clothing; a second set of one or more pressure sensors which is attached to a second area of the article of clothing; a first porous but inflatable net or mesh which is attached to the first area of the article of clothing; a second porous but inflatable net or mesh which is attached to the second area of the article of clothing; wherein the first net or mesh is inflated based on data from the first set of one or more pressure sensors; and wherein the second net or mesh is inflated based on data from the second set of one or more pressure sensors.

In another example, a device to help a person in bed to avoid decubitus ulcers comprises: an article of clothing which is worn by a person lying in a bed; a first set of one or more pressure sensors which is attached to a first area of the article of clothing; a second set of one or more pressure sensors which is attached to a second area of the article of clothing; a first porous but inflatable net or mesh which is attached to the first area of the article of clothing; a second porous but inflatable net or mesh which is attached to the second area of the article of clothing; wherein the first net or mesh is inflated based on pressure level and/or duration measured by the first set of one or more pressure sensors; and wherein the second net or mesh is inflated based on pressure level and/or duration measured by the second set of one or more pressure sensors. Alternatively, a device which helps a person in bed to avoid decubitus ulcers comprises: an article of clothing which is worn by a person lying in a bed; a first set of one or more pressure sensors which is woven into a first area of the article of clothing; a second set of one or more pressure sensors which is woven into a second area of the article of clothing; a first porous but inflatable net or mesh which is woven into the first area of the article of clothing; a second porous but inflatable net or mesh which is woven into the second area of the article of clothing; wherein the first net or mesh is inflated based on pressure level and/or duration measured by the first set of one or more pressure sensors; and wherein the second net or mesh is inflated based on pressure level and/or duration measured by the second set of one or more pressure sensors.

In one example, a device to help a person in bed to avoid decubitus ulcers comprises: a flexible and breathable (e.g., porous to gas and liquid) upper support surface (e.g., sheet, pad, blanket, net, or mesh) on which a sleeping person lies; a flexible and breathable (e.g., porous to gas and liquid) middle support surface (e.g., sheet, pad, blanket, net, or mesh) below the upper support surface, wherein the middle support surface is automatically moved along a first (e.g., longitudinal or lateral) axis by one or more actuators, wherein the middle support surface has a first surface portion with a first elasticity level and an arcuate (e.g., circular) second surface portion with a second elasticity level, wherein the second elasticity level is greater than the first elasticity level, and wherein the second surface portion is smaller than (and nested within) the first surface portion; and a flexible and breathable (e.g., porous to gas and liquid) lower support surface (e.g., sheet, pad, blanket, net, or mesh) below the middle support surface, wherein the lower support surface is automatically moved along a second axis by one or more actuators, wherein the second axis is perpendicular to the first axis, wherein the middle support surface has a third surface portion with a third elasticity level and an arcuate (e.g., circular) fourth surface portion with a fourth elasticity level, wherein the fourth elasticity level is greater than the third elasticity level, wherein the fourth surface portion is smaller than (and nested within) the third surface portion, and wherein middle support surface and the lower support surface are moved so as to overlap the second surface portion and the fourth surface portion, thereby creating a localized surface portion with greater elasticity below a selected part of the sleeping person's body that has a pressure ulcer and/or is particularly vulnerable to developing a pressure ulcer.

Alternatively, a device to help a person in bed to avoid decubitus ulcers comprises: a flexible and breathable (e.g., porous to gas and liquid) upper support surface (e.g., sheet, pad, blanket, net, or mesh) on which a sleeping person lies; a flexible and breathable (e.g., porous to gas and liquid) middle support surface (e.g., sheet, pad, blanket, net, or mesh) below the upper support surface, wherein the middle support surface is automatically moved along a first (e.g., longitudinal or lateral) axis by one or more actuators, wherein the middle support surface has a first surface portion with a first durometer level and an arcuate (e.g., circular) second surface portion with a second durometer level, wherein the second durometer level is lower than the first durometer level, and wherein the second surface portion is smaller than (and nested within) the first surface portion; and a flexible and breathable (e.g., porous to gas and liquid) lower support surface (e.g., sheet, pad, blanket, net, or mesh) below the middle support surface, wherein the lower support surface is automatically moved along a second axis by one or more actuators, wherein the second axis is perpendicular to the first axis, wherein the middle support surface has a third surface portion with a third durometer level and an arcuate (e.g., circular) fourth surface portion with a fourth durometer level, wherein the fourth durometer level is lower than the third durometer level, wherein the fourth surface portion is smaller than (and nested within) the third surface portion, and wherein middle support surface and the lower support surface are moved so as to overlap the second surface portion and the fourth surface portion, thereby creating a localized surface portion with lower durometer below a selected part of the sleeping person's body that has a pressure ulcer and/or is particularly vulnerable to developing a pressure ulcer.

For example, a device to help a person in bed to avoid decubitus ulcers comprises: a flexible and breathable (e.g., porous to gas and liquid) upper support surface (e.g., sheet, pad, blanket, net, or mesh) on which a sleeping person lies; a flexible and breathable (e.g., porous to gas and liquid) middle support surface (e.g., sheet, pad, blanket, net, or mesh) below the upper support surface, wherein the middle support surface is automatically moved along a first (e.g., longitudinal or lateral) axis by one or more actuators, wherein the middle support surface has a first surface portion with a first stretchability level and an arcuate (e.g., circular) second surface portion with a second stretchability level, wherein the second stretchability level is greater than the first stretchability level, and wherein the second surface portion is smaller than (and nested within) the first surface portion; and a flexible and breathable (e.g., porous to gas and liquid) lower support surface (e.g., sheet, pad, blanket, net, or mesh) below the middle support surface, wherein the lower support surface is automatically moved along a second axis by one or more actuators, wherein the second axis is perpendicular to the first axis, wherein the middle support surface has a third surface portion with a third stretchability level and an arcuate (e.g., circular) fourth surface portion with a fourth stretchability level, wherein the fourth stretchability level is greater than the third stretchability level, wherein the fourth surface portion is smaller than (and nested within) the third surface portion, and wherein middle support surface and the lower support surface are moved so as to overlap the second surface portion and the fourth surface portion, thereby creating a localized surface portion with greater stretchability below a selected part of the sleeping person's body that has a pressure ulcer and/or is particularly vulnerable to developing a pressure ulcer.

Alternatively, a device to help a person in bed to avoid decubitus ulcers comprises: a flexible and breathable (e.g., porous to gas and liquid) upper support surface (e.g., sheet, pad, blanket, net, or mesh) on which a sleeping person lies; a flexible and breathable (e.g., porous to gas and liquid) middle support surface (e.g., sheet, pad, blanket, net, or mesh) below the upper support surface, wherein the middle support surface is automatically moved along a first (e.g., longitudinal or lateral) axis by one or more actuators, wherein the middle support surface has a first surface portion with a first flexibility level and an arcuate (e.g., circular) second surface portion with a second flexibility level, wherein the second flexibility level is greater than the first flexibility level, and wherein the second surface portion is smaller than (and nested within) the first surface portion; and a flexible and breathable (e.g., porous to gas and liquid) lower support surface (e.g., sheet, pad, blanket, net, or mesh) below the middle support surface, wherein the lower support surface is automatically moved along a second axis by one or more actuators, wherein the second axis is perpendicular to the first axis, wherein the middle support surface has a third surface portion with a third flexibility level and an arcuate (e.g., circular) fourth surface portion with a fourth flexibility level, wherein the fourth flexibility level is greater than the third flexibility level, wherein the fourth surface portion is smaller than (and nested within) the third surface portion, and wherein middle support surface and the lower support surface are moved so as to overlap the second surface portion and the fourth surface portion, thereby creating a localized surface portion with greater stretchability below a selected part of the sleeping person's body that has a pressure ulcer and/or is particularly vulnerable to developing a pressure ulcer.

In another example, a device to help a person in bed to avoid decubitus ulcers comprises: a flexible and breathable (e.g., porous to gas and liquid) upper support surface (e.g., sheet, pad, blanket, net, or mesh) on which a sleeping person lies; a flexible and breathable (e.g., porous to gas and liquid) middle support surface (e.g., sheet, pad, blanket, net, or mesh) below the upper support surface, wherein the middle support surface is suspended between first and second rollers; wherein the middle support surface is automatically moved between the first and second rollers by one or more actuators, wherein the middle support surface has a first opening (or hole); and a flexible and breathable (e.g., porous to gas and liquid) lower support surface (e.g., sheet, pad, blanket, net, or mesh) below the middle support surface, wherein the lower support surface is suspended between third and fourth rollers; wherein the lower support surface is automatically moved between the third and fourth rollers, wherein the middle support surface has a second opening (or hole), and wherein middle support surface and the lower support surface are moved so as to overlap the first and second openings (or holes), thereby creating a localized opening (or hole) below a selected part of the sleeping person's body that has a pressure ulcer and/or is particularly vulnerable to developing a pressure ulcer.

Alternatively, a device which helps a person in bed avoid decubitus ulcers comprises: a flexible and breathable (e.g., porous to gas and liquid) upper support surface (e.g., sheet, pad, blanket, net, or mesh) on which a sleeping person lies; a flexible and breathable (e.g., porous to gas and liquid) middle support surface (e.g., sheet, pad, blanket, net, or mesh) below the upper support surface, wherein the middle support surface is suspended between first and second rollers; wherein the middle support surface is manually moved between the first and second rollers, wherein the middle support surface has a first surface portion with a first elasticity level and a second surface portion with a second elasticity level, wherein the second elasticity level is greater than the first elasticity level, and wherein the second surface portion is smaller than (and nested within) the first surface portion; and a flexible and breathable (e.g., porous to gas and liquid) lower support surface (e.g. sheet, pad, blanket, net, or mesh) below the middle support surface, wherein the lower support surface is suspended between third and fourth rollers; wherein the lower support surface is manually moved between the third and fourth rollers, wherein the middle support surface has a third surface portion with a third elasticity level and a fourth surface portion with a fourth elasticity level, wherein the fourth elasticity level is greater than the third elasticity level, wherein the fourth surface portion is smaller than (and nested within) the third surface portion, and wherein middle support surface and the lower support surface are moved so as to overlap the second surface portion and the fourth surface portion, thereby creating a localized surface portion with greater elasticity below a selected part of the sleeping person's body that has a pressure ulcer and/or is particularly vulnerable to developing a pressure ulcer.

A device to help a person in bed to avoid decubitus ulcers comprises: a flexible upper support surface on which a sleeping person lies; a flexible middle support surface below the upper support surface, wherein the middle support surface is automatically moved along a first axis by one or more actuators, wherein the middle support surface has a first surface portion with a first elasticity level and a second surface portion with a second elasticity level, wherein the second elasticity level is greater than the first elasticity level, and wherein the second surface portion is smaller than the first surface portion; and a flexible lower support surface below the middle support surface, wherein the lower support surface is automatically moved along a second axis by one or more actuators, wherein the second axis is perpendicular to the first axis, wherein the middle support surface has a third surface portion with a third elasticity level and a fourth surface portion with a fourth elasticity level, wherein the fourth elasticity level is greater than the third elasticity level, wherein the fourth surface portion is smaller than the third surface portion, and wherein middle support surface and the lower support surface are moved so as to overlap the second surface portion and the fourth surface portion, thereby creating a localized surface portion with greater elasticity below a selected part of the sleeping person's body that has a pressure ulcer and/or is particularly vulnerable to developing a pressure ulcer. Alternatively, a device which helps to prevent decubitus ulcers comprises: a flexible support structure (such as a net, mesh, sling, hammock, pad, sheet, or blanket) on which a person lies; a laterally-moving loop of flexible material with an uneven surface which is under the flexible support structure, wherein the loop comprises an upper portion which moves in a selected lateral direction (e.g., right-to-left or left-to-right) and a lower portion which moves in the opposite lateral direction (e.g., left-to-right or right-to-left); and a plurality of actuators which lift the flexible support structure up off the loop of flexible material, move (and/or rotate) the loop of flexible material laterally, and then lower the flexible support structure back down onto the loop of flexible material.

In another embodiment, a device to help a person in bed to avoid decubitus ulcers comprises: a flexible support structure (such as a net, mesh, sling, hammock, pad, sheet, or blanket) on which a person lies; a laterally-moving loop of padding which is under the flexible support structure, wherein the loop comprises an upper portion which moves in a selected lateral direction (e.g., right-to-left or left-to-right) and a lower portion which moves in the opposite lateral direction (e.g., left-to-right or right-to-left); a plurality of actuators which lift the flexible support structure up off the loop of padding, move (and/or rotate) the loop of padding laterally, and then lower the flexible support structure back down onto the loop of padding; and a sanitizing or disinfecting mechanism which sanitizes or disinfects the loop of padding as it passes through the lower portion of the loop. Alternatively, a device to help a person in bed to avoid decubitus ulcers comprises: a flexible support structure (such as a net, mesh, sling, hammock, pad, sheet, or blanket) on which a person lies; a laterally-moving loop of padding which is under the flexible support structure, wherein the loop comprises an upper portion which moves in a selected lateral direction (e.g., right-to-left or left-to-right) and a lower portion which moves in the opposite lateral direction (e.g., left-to-right or right-to-left); a plurality of actuators which lift the flexible support structure up off the loop of padding, move (and/or rotate) the loop of padding laterally, and then lower the flexible support structure back down onto the loop of padding; and a padding-reconditioning mechanism, wherein the padding-reconditioning mechanism reconditions the loop of padding when it passes through the lower portion; and wherein the padding-reconditioning mechanism performs one of more functions selected from the group consisting of: drying or dehumidifying the padding (e.g., using thermal energy); sanitizing or disinfecting the padding (e.g., using light energy or microwave energy); cleaning the padding (e.g., using soap and water; and fluffing or expanding the padding (e.g., using positive or negative air pressure).

In another example, a device to help a person in bed to avoid decubitus ulcers comprises: a flexible support surface (such as a flexible net, mesh, sling, hammock, pad, sheet, or blanket) on which a person lies; a laterally-scrolling loop of padding (such as a loop of compressible foam or a loop of compressible textile padding) which is under the upper support structure; two rollers, one roller closer to the right side of the support surface and one roller closer to the left side of the support surface, wherein the laterally-scrolling loop of padding loops around the two rollers and scrolls laterally between the two rollers; and a plurality of actuators; and using at least one actuator to lift the flexible support surface up off the loop of padding; (b) using at least one actuator to scroll the loop of padding laterally, thereby changing which portion of the loop of padding is directly underneath a selected location on the person's body; and then (c) using at least one actuator to lower the flexible support surface back down onto the loop of padding. Alternatively, a device to help a person in bed to avoid decubitus ulcers comprises: a flexible support structure (such as a net, mesh, sling, hammock, pad, sheet, or blanket) on which a person lies; a longitudinally-moving loop of flexible material with an uneven surface which is under the flexible support structure, wherein the loop comprises an upper portion which moves in a selected longitudinal direction (e.g., head-to-toe or toe-to-head) and a lower portion which moves in the opposite longitudinal direction (e.g., toe-to-head or head-to-toe); and a plurality of actuators which lift the flexible support structure up off the loop of flexible material, move (and/or rotate) the loop of flexible material longitudinally, and then lower the flexible support structure back down onto the loop of flexible material.

In one example, a device which helps a person to avoid decubitus ulcers comprises: a flexible support structure (such as a net, mesh, sling, hammock, pad, sheet, or blanket) on which a person lies; a longitudinally-moving loop of padding which is under the flexible support structure, wherein the loop comprises an upper portion which moves in a selected longitudinal direction (e.g., head-to-toe or toe-to-head) and a lower portion which moves in the opposite longitudinal direction (e.g., toe-to-head or head-to-toe); a plurality of actuators which lift the flexible support structure up off the loop of padding, move (and/or rotate) the loop of padding longitudinally, and then lower the flexible support structure back down onto the loop of padding; and a sanitizing or disinfecting mechanism which sanitizes or disinfects the loop of padding as it passes through the lower portion of the loop. Alternatively, a device to help a person in bed to avoid decubitus ulcers comprises: a flexible support structure (such as a net, mesh, sling, hammock, pad, sheet, or blanket) on which a person lies; a longitudinally-moving loop of padding which is under the flexible support structure, wherein the loop comprises an upper portion which moves in a selected longitudinal direction (e.g., head-to-toe or toe-to-head) and a lower portion which moves in the opposite longitudinal direction (e.g., toe-to-head or head-to-toe); a plurality of actuators which lift the flexible support structure up off the loop of padding, move (and/or rotate) the loop of padding longitudinally, and then lower the flexible support structure back down onto the loop of padding; and a padding-reconditioning mechanism, wherein the padding-reconditioning mechanism reconditions the loop of padding when it passes through the lower portion; and wherein the padding-reconditioning mechanism performs one of more functions selected from the group consisting of: drying or dehumidifying the padding (e.g., using thermal energy); sanitizing or disinfecting the padding (e.g., using light energy or microwave energy); cleaning the padding (e.g., using soap and water; and fluffing or expanding the padding (e.g., using positive or negative air pressure).

For example, a device which helps a person in bed avoid decubitus ulcers comprises: a flexible support structure (such as a net, mesh, sling, hammock, pad, sheet, or blanket) on which a person lies; a longitudinally-moving textile loop which is under the flexible support structure, wherein the loop comprises an upper portion which moves in a selected longitudinal direction (e.g., head-to-toe) and a lower portion which moves in the opposite longitudinal direction (e.g., toe-to-head); and a plurality of actuators which sequentially lift the flexible support structure up off the loop, move (and/or rotate) the loop longitudinally, and then lower the flexible support structure back down onto the loop. Alternatively, a device to help a person in bed to avoid decubitus ulcers comprises: a flexible support structure (such as a net, mesh, sling, hammock, pad, sheet, or blanket) on which a person lies; a longitudinally-moving undulating padded loop which is under the flexible support structure, wherein the loop comprises an upper portion which moves in a selected longitudinal direction (e.g., head-to-toe) and a lower portion which moves in the opposite longitudinal direction (e.g., toe-to-head); and a plurality of actuators which sequentially lift the flexible support structure up off the loop, move (and/or rotate) the loop longitudinally, and then lower the flexible support structure back down onto the loop.

In another example, a device to help a person in bed to avoid decubitus ulcers comprises: a flexible net, mesh, sling, hammock, pad, sheet, or blanket on which a person lies; a longitudinally-scrolling loop of padding which is under the upper support structure; and a plurality of actuators; and using at least one actuator to lift the flexible net, mesh, sling, hammock, pad, sheet, or blanket up off the lower support structure; (b) using at least one actuator to scroll the loop of padding longitudinally, thereby changing which portion of the loop of padding is directly underneath a selected location on the person's body; and then (c) using at least one actuator to lower the flexible net, mesh, sling, hammock, pad, sheet, or blanket back down onto the lower support structure. Alternatively, a device to help a person in bed to avoid decubitus ulcers comprises: a flexible support structure (such as a net, mesh, sling, hammock, pad, sheet, or blanket) on which a person lies; a loop of padding which is under the flexible support structure; a plurality of actuators which lift the flexible support structure up off the loop of padding, move (and/or rotate) the loop of padding (laterally or longitudinally), and then lower the flexible support structure back down onto the loop of padding; and a reconditioning mechanism, wherein the reconditioning mechanism reconditions one portion of the loop of padding at a time at a location where the person's body is not pressing against the loop of padding.

A device to help a person in bed to avoid decubitus ulcers comprises: a flexible net, mesh, sling, hammock, pad, sheet, or blanket on which a person lies; a loop of padding which is under the upper support structure; and a plurality of actuators; and using at least one actuator to lift the flexible net, mesh, sling, hammock, pad, sheet, or blanket up off the lower support structure; (b) using at least one actuator to scroll the loop of padding longitudinally, thereby changing which portion of the loop of padding is directly underneath a selected location on the person's body; and then (c) using at least one actuator to lower the flexible net, mesh, sling, hammock, pad, sheet, or blanket back down onto the lower support structure. Alternatively, a device which helps to prevent decubitus ulcers comprises: a mattress on which a person lies; a lower first-side cushion on a first (e.g., right or left) side of the person; an upper first-side cushion which is also on the first side of the person, but above the lower first-side cushion; a lower second-side cushion on a second (e.g., left or right) side of the person; an upper second-side cushion which is also on the second side of the person, but above the lower second-side cushion; wherein the person is turned from lying on their first (e.g., right) side to lying on their second (e.g., left) side by inflating and deflating the cushions, wherein inflation and deflation of cushions on the first vs. second sides is asymmetric with respect to a vertical plane between them, and wherein inflation and deflation of lower vs. upper cushions is asymmetric with respect to a horizontal plane between them.

In one example, a device to help a person in bed to avoid decubitus ulcers comprises: a mattress on which a person lies; a lower first-side cushion on a first (e.g., right or left) side of the person; an upper first-side cushion which is also on the first side of the person, but above the lower first-side cushion; a lower second-side cushion on a second (e.g., left or right) side of the person; an upper second-side cushion which is also on the second side of the person, but above the lower second-side cushion; wherein the person is turned from lying on their first (e.g., right) side to lying on their second (e.g., left) side by inflating and deflating the cushions, wherein the level of inflation (and deflation) of cushions on the first vs. second sides is asymmetric with respect to a vertical plane between them, and wherein the level of inflation (and deflation) of lower vs. upper cushions is asymmetric with respect to a horizontal plane between them. Alternatively, a device which helps a person in bed to avoid decubitus ulcers comprises: a mattress on which a person lies; a lower first-side cushion on a first (e.g., right or left) side of the person; an upper first-side cushion which is also on the first side of the person, but above the lower first-side cushion; a lower second-side cushion on a second (e.g., left or right) side of the person; an upper second-side cushion which is also on the second side of the person, but above the lower second-side cushion; wherein the person is turned from lying on their first (e.g., right) side to lying on their second (e.g., left) side by inflating and deflating the cushions, and wherein the lower cushions are inflated first and the upper cushions are inflated second.

In another example, a device to help a person in bed to avoid decubitus ulcers comprises: an upper support structure (such as a flexible net, mesh, sling, hammock, pad, sheet, or blanket) on which a person lies; a lower support structure (such as a loop of compressible foam or textile) which is under the upper support structure; and a plurality of actuators; and (a) using at least one actuator to lift the upper support structure up off the lower support structure; (b) using at least one actuator to scroll and/or rotate the lower support structure (e.g., laterally or longitudinally), thereby changing which portion of the lower support structure is directly underneath a selected location on the person's body; and then (c) using at least one actuator to lower the upper support structure back down onto the lower support structure. Alternatively, a device which helps a person in bed avoid decubitus ulcers comprises: an upper support structure (such as a flexible net, mesh, sling, hammock, pad, sheet, or blanket) on which a person lies; a lower support structure (such as a moving foam layer, foam loop, textile layer, or textile loop) which is under the upper support structure; and a plurality of actuators; and (a) using at least one actuator to lift the upper support structure up off the lower support structure; (b) using at least one actuator to move (e.g., shift, scroll, and/or rotate) the lower support structure (e.g., laterally, longitudinally, or radially), thereby changing which portion of the lower support structure is directly underneath a selected location on the person's body; and then (c) using at least one actuator to lower the upper support structure back down onto the lower support structure.

A device to help a person in bed to avoid decubitus ulcers comprises: an upper support surface on which a person lies; a lower support surface below the upper support surface; and a plurality of cushions around the person's torso; wherein the person is turned from lying on one side to the other side by the following sequence—the cushions are inflated, the upper support surface is tilted and/or rotated between 90 and 180 degrees around its longitudinal axis in a first (clockwise or counter-clockwise) direction, the cushions are deflated, and the upper support surface is tilted and/or rotated between 90 and 180 degrees around its longitudinal axis in the opposite (counter-clockwise or clockwise) direction. Alternatively, a device to help a person in bed to avoid decubitus ulcers comprises: an upper support surface on which a person lies; a lower support surface below the upper support surface; and inflatable cushions on the right and left sides of lower support surface; wherein the cushions are inflated on both sides of the person, the upper support surface is tilted and/or rotated, and the cushions are deflated.

For example, a device to help a person in bed to avoid decubitus ulcers comprises: a longitudinal flexible body support surface (such as a net, mesh, pad, sheet, or blanket) on which a person lies; a mattress under the support surface, wherein the mattress further comprises right-side inflatable compartment and a left-side inflatable compartment; and a plurality of actuators; wherein the person is moved from lying on their first (e.g., right) side to lying on their second (e.g., left) side in the following steps (a) lifting the right and left sides of the support surface using the actuators, thereby wrapping the support surface at least partially around the person's torso and lifting the person who was lying on their first (e.g., right) side at least partially up off the mattress with the lateral axis of their torso being substantially vertical; (b) inflating the second side compartment so that the second-side inflatable compartment pushes against the support surface and tilts, pivots, and/or rotates the person's body around a longitudinal axis; and then (c) lowering the right and left sides of the support surface using the actuators, thereby unwrapping the support surface from around the person's torso and lowering the person down onto the mattress lying on their second (e.g., left) side.

Alternatively, a device to help a person in bed to avoid decubitus ulcers comprises: a longitudinal flexible body support surface (such as a net, mesh, pad, sheet, or blanket) on which a person lies; a mattress under the support surface, wherein the mattress further comprises right-side inflatable compartment and a left-side inflatable compartment; and a plurality of actuators; wherein the person is moved from lying on their first (e.g., right) side to lying on their second (e.g., left) side in the following steps (a) lifting the right and left sides of the support surface using the actuators, thereby wrapping the support surface at least partially around the person's torso and lifting the person who was lying on their first (e.g., right) side at least partially up off the mattress; (b) inflating the second side compartment so that the second-side inflatable compartment pushes against the support surface and tilts, pivots, and/or rotates the person's body around a longitudinal axis; (c) lowering the right and left sides of the support surface using the actuators, thereby unwrapping the support surface from around the person's torso and lowering the person down onto the mattress lying on their second (e.g., left) side; and then (d) deflating the second side compartment.

In another example, a device which helps to prevent decubitus ulcers comprises: an upper support surface on which a sleeping person lies; a middle support surface below the upper support surface, wherein the middle support surface has a first surface portion with a first elasticity level and a second surface portion with a second elasticity level, wherein the second elasticity level is greater than the first elasticity level, and wherein the second surface portion is smaller than the first surface portion; and a lower support surface below the middle support surface, wherein the middle support surface has a third surface portion with a third elasticity level and a fourth surface portion with a fourth elasticity level, wherein the fourth elasticity level is greater than the third elasticity level, wherein the fourth surface portion is smaller than the third surface portion, and wherein middle support surface and the lower support surface are moved so as to overlap the second surface portion and the fourth surface portion, thereby creating a localized surface portion with greater elasticity below a selected part of the sleeping person's body that has a pressure ulcer and/or is particularly vulnerable to developing a pressure ulcer. Alternatively, a device to help a person in bed to avoid decubitus ulcers comprises: an upper support surface on which a sleeping person lies; a middle support surface below the upper support surface, wherein the middle support surface has a first surface portion with a first elasticity level and a second surface portion with a second elasticity level, wherein the second elasticity level is greater than the first elasticity level, and wherein the second surface portion is smaller than the first surface portion; and a lower support surface below the middle support surface, wherein the middle support surface has a third surface portion with a third elasticity level and a fourth surface portion with a fourth elasticity level, wherein the fourth elasticity level is greater than the third elasticity level, wherein the fourth surface portion is smaller than the third surface portion, and wherein the middle support surface and the lower support surface are moved to align the second surface portion and the fourth surface portion to create a localized area with greater elasticity below a selected part of the sleeping person's body that has a pressure ulcer and/or is particularly vulnerable to developing a pressure ulcer.

In one example, a device which helps a person in bed to avoid decubitus ulcers comprises: an upper support surface on which a sleeping person lies; a middle support surface below the upper support surface, wherein the middle support surface has a first surface portion with a first elasticity level and a second surface portion with a second elasticity level, wherein the second elasticity level is greater than the first elasticity level, and wherein the second surface portion is smaller than the first surface portion; and a lower support surface below the middle support surface, wherein the middle support surface has a third surface portion with a third elasticity level and a fourth surface portion with a fourth elasticity level, wherein the fourth elasticity level is greater than the third elasticity level, wherein the fourth surface portion is smaller than the third surface portion, and wherein the middle support surface and the lower support surface are manually moved to overlap the second surface portion and the fourth surface portion to create a localized area with greater elasticity below a selected part of the sleeping person's body that has a pressure ulcer and/or is particularly vulnerable to developing a pressure ulcer. Alternatively, a device to help a person in bed to avoid decubitus ulcers comprises: a flexible support surface (such as a flexible net, mesh, sling, hammock, pad, sheet, or blanket) on which a person lies; a moving layer of padding (such as a layer of compressible foam or textile padding) which is under the upper support structure; and a plurality of actuators; and using at least one actuator to lift the flexible support surface up off the loop of padding; (b) using at least one actuator to shift the layer of padding laterally, thereby changing which portion of the layer of padding is directly underneath a selected location on the person's body; and then (c) using at least one actuator to lower the flexible support surface back down onto the layer of padding.

In another embodiment, a device to help a person in bed to avoid decubitus ulcers comprises: a flexible support surface (such as a flexible net, mesh, sling, hammock, pad, sheet, or blanket) on which a person lies; a moving layer of padding (such as a layer of compressible foam or textile padding) which is under the upper support structure; and a plurality of actuators; and using at least one actuator to lift the flexible support surface up off the loop of padding; (b) using at least one actuator to rotate the layer of padding radially, thereby changing which portion of the layer of padding is directly underneath a selected location on the person's body; and then (c) using at least one actuator to lower the flexible support surface back down onto the layer of padding. Alternatively, a device to help a person in bed to avoid decubitus ulcers comprises: a support structure on which a person lies; a plurality of actuators which change the cross-sectional shape of the support structure from flat to concave, or vice versa; a garment worn by the person; and one or more sensors on the garment selected from the group consisting of motion sensor, pressure sensor, and moisture sensor; wherein the plurality of actuators are triggered to change the cross-sectional shape of the support structure from flat to concave, then tilt and/or rotate the support structure, and then change the cross-sectional shape of the support structure back to flat—based on data from the one or more sensors.

In another example, a device to help a person in bed to avoid decubitus ulcers comprises: a flexible support structure on which a sleeping person lies, wherein the support structure has a longitudinal axis, wherein the support structure has a first configuration in which it is substantially flat and a second configuration in which it is folded and/or wrapped around a portion of the person's torso; a plurality of actuators which change the support structure from its first configuration to its second configuration, or vice versa; wherein a person is moved from lying on their first (e.g., right) side to lying on their second (e.g., left) side by: (a) using the actuators to change the support structure from its first configuration to its second configuration as the person lies on their first (e.g., right) side; (b) using the actuators to slowly rotate and/or tilt the support structure relative to a longitudinal axis, thereby also slowly rotating and/or tilting the person's body which is partially enfolded within the support structure; and (c) then using the actuators to change the support structure from its second configuration to its first configuration, thereby leaving the person lying on their second (e.g., left) side. Alternatively, a device which helps a person in bed avoid decubitus ulcers comprises: a support structure (such as a mattress) on which a person lies, wherein the support structure further comprises a concentric array of compressible rings; a plurality of actuators which move the concentric array of compressible rings; and a camera which records images which are analyzed to determine the location of a selected part of the person's body at a selected time; wherein the concentric array of compressible rings is moved so that its center is under the selected part of the person's body.

In one example, a device to help a person in bed to avoid decubitus ulcers comprises: a support structure (such as a mattress) on which a person lies, wherein the support structure further comprises a concentric array of foam rings; a plurality of actuators which move the concentric array of foam rings; and a camera which records images which are analyzed to determine the location of a selected part of the person's body at a selected time; wherein the concentric array of foam rings is moved so that its center is under the selected part of the person's body. Alternatively, a device which helps a person in bed avoid decubitus ulcers comprises: a support structure (such as a mattress) on which a person lies, wherein the support structure further comprises a concentric array of inflated rings; a plurality of actuators which move the concentric array of inflated rings; a plurality of actuators which moves the concentric array of inflated rings; a garment (or dressing) worn by the person, wherein the garment (or dressing) further comprises an electromagnetic energy emitter; and a plurality of electromagnetic energy sensors which are used to determine the location of the at least one electromagnetic energy emitter; wherein the concentric array of inflated rings is moved so that its center is under the electromagnetic energy emitter.

For example, a device to help a person in bed to avoid decubitus ulcers comprises: a longitudinal flexible support structure on which a person lies; a plurality of arches which span laterally over the support structure, wherein the support structure is connected to the arches at a plurality of movable connections, and wherein the support structure is suspended between the arches; and a plurality of actuators which move the connections; wherein moving the connections changes the slope and/or shape of the support structure which, in turn, helps the person to move from lying on their first (e.g., right) side to lying on their second (e.g., left) side. Alternatively, a device which helps a person in bed avoid decubitus ulcers comprises: a longitudinal flexible support structure (such as a reinforced sheet, pad, blanket, net, mesh, or sling) on which a person lies; a plurality of beams (or ribs) which laterally span the support structure above the support structure, wherein the support structure is connected to the beams at a plurality of connections which are moved along the beams (or ribs); and a plurality of actuators which move the connections along the beams (or ribs); wherein moving the connections along the beams (or ribs) changes the slope and/or shape of the support structure which, in turn, helps the person to move from lying on their first (e.g., right) side to lying on their second (e.g., left) side.

In another example, a device to help a person in bed to avoid decubitus ulcers comprises: a longitudinal flexible support structure on which a person lies; a plurality of beams which span laterally over the support structure, wherein the support structure is connected to the beams at a plurality of movable connections; and a plurality of actuators which move the connections closer together or farther apart in a sequential manner; wherein moving the connections closer together or farther apart in a sequential manner changes the slope and/or shape of the support structure in a sequential manner which, in turn, helps the person to move from lying on their first (e.g., right) side to lying on their second (e.g., left) side by gently lifting the person from lying on their first side and gently lowering them onto their second side. Alternatively, a device to help a person in bed to avoid decubitus ulcers comprises: a longitudinal flexible support structure on which a person lies; a plurality of beams which span laterally over the support structure, wherein corners of the support structure are connected to the beams at a plurality of movable connections; and a plurality of actuators which move the connections closer together and farther apart; wherein moving the connections closer together and farther apart changes the slope and/or shape of the support structure in a sequential manner which, in turn, helps the person to move from lying on their first (e.g., right) side to lying on their second (e.g., left) side.

In another embodiment, a device to help a person in bed to avoid decubitus ulcers comprises: a longitudinal flexible support structure on which a person lies; a plurality of beams which span laterally over the support structure, wherein the support structure is connected to the beams at a plurality of movable connections; and a plurality of actuators which move the connections closer together or farther apart; wherein moving the connections closer together or farther apart changes the slope and/or shape of the support structure which, in turn, helps the person to move from lying on their first (e.g., right) side to lying on their second (e.g., left) side. Alternatively, a device which helps to prevent decubitus ulcers comprises: a longitudinal flexible support structure on which a person lies; a plurality of beams which span laterally over the support structure, wherein corners of the support structure are connected to the beams at a plurality of movable connections; and a plurality of actuators which move the connections of laterally-aligned corners of the support structure closer together and farther apart; wherein moving these connections closer together and farther apart changes the slope and/or shape of the support structure which, in turn, helps the person to move from lying on their first (e.g., right) side to lying on their second (e.g., left) side.

A device to help a person in bed to avoid decubitus ulcers comprises: a longitudinal flexible support structure on which a person lies; a plurality of beams which span laterally over the support structure, wherein corners (and/or sides) of the support structure are connected to the beams at a plurality of movable connections; and a plurality of actuators which move the connections; wherein the plurality of actuators move the connections in the following three-step sequence—firstly, the actuators move the connections so as to fold the support structure around the person's body as they lie on their first side; secondly, the actuators move the connections so as to rotate and/or tilt the person's body; and then thirdly, the actuators move the connections so as to unfold the support structure from the person's body, leaving them lying on their second side. Alternatively, a device which helps a person in bed to avoid decubitus ulcers comprises: a longitudinal flexible support structure on which a person lies; a plurality of beams which span laterally over the support structure, wherein corners of the support structure are connected to the beams at a plurality of movable connections; and a plurality of actuators which move the connections; wherein moving the connections changes the slope and/or shape of the support structure which, in turn, helps the person to move from lying on their first (e.g., right) side to lying on their second (e.g., left) side.

In another example, a device to help a person in bed to avoid decubitus ulcers comprises: a longitudinal flexible support structure on which a person lies; a plurality of beams which span laterally over the support structure, wherein the support structure is connected to the beams at a plurality of movable connections; and a plurality of actuators which move the connections; wherein moving the connections changes the slope and/or shape of the support structure which, in turn, helps the person to move from lying on their first (e.g., right) side to lying on their second (e.g., left) side. Alternatively, a device which helps to prevent decubitus ulcers comprises: a longitudinal flexible support structure on which a person lies; a plurality of beams which span laterally over the support structure, wherein the support structure is connected to the beams at a plurality of movable connections; and a plurality of actuators which move the connections; wherein moving the connections enfolds the support structure around the person's body and turns the person from lying on their first (e.g., right) side to lying on their second (e.g., left) side.

In one example, a device to help a person in bed to avoid decubitus ulcers comprises: a longitudinal flexible support structure on which a person lies; a plurality of beams which span laterally over the support structure, wherein the support structure is connected to the beams at a plurality of movable connections; and a plurality of actuators which raise or lower the connections; wherein raising or lowering the connections changes the slope and/or shape of the support structure which, in turn, helps the person to move from lying on their first (e.g., right) side to lying on their second (e.g., left) side. Alternatively, a device to help a person in bed to avoid decubitus ulcers comprises: a support structure on which a person lies, wherein the support structure further comprises a plurality of adjustable portions (e.g., cells, columns, bladders, or compartments) whose sizes and/or shapes are able to be individually adjusted; a plurality of electromagnetic energy sensors; and a garment (or dressing) which is worn by the person, wherein the garment (or dressing) further comprises an electromagnetic energy emitter, wherein the adjustable portions which are within a selected distance (e.g., between 2″ and 12″) from the electromagnetic energy emitter at a selected time are identified by the electromagnetic energy sensors, and wherein the sizes and/or shapes of the identified adjustable portions at the selected time are adjusted relative to the sizes and/or shapes of the other adjustable portions.

In another example, a device to help a person in bed to avoid decubitus ulcers comprises: one or more garments which are worn by a person who lies in a bed, wherein the garments further comprise electromagnetic markers on pant legs and shirt sleeves; a plurality of electromagnetic sensors which detect the locations of the markers; a human-to-computer interface (e.g., voice command interface) which is controlled by the person; a first soft support structure with one or more openings into which the person places their knees; a second soft support structure with one or more openings into which the person places their elbows; wherein the support structures engage the person's knees and elbows if the person gives the appropriate command and the sensors indicate that the person's knees and elbows are properly positioned; and wherein the support structures are simultaneously and gently moved, spanning an arc in 3D space, from a first (right or left) side of the bed to a second (left or right) side of the bed, thereby gently moving the person from lying on their first (e.g., right) side to lying on their second (e.g., left) side at their command. Alternatively, a device which helps a person to avoid decubitus ulcers comprises: one or more garments which are worn by a person who lies in a bed, wherein the garments further comprise electromagnetic markers on pant legs and torso; a plurality of electromagnetic sensors which detect the locations of the markers; a human-to-computer interface (e.g., voice command interface) which is controlled by the person; a first soft support structure with one or more openings into which the person places their knees; a second soft support structure with one or more openings into which the person places their torso; wherein the support structures engage the person's knees and torso if the person gives the appropriate command and the sensors indicate that the person's knees and torso are properly positioned; and wherein the support structures are simultaneously and gently moved, spanning an arc in 3D space, from a first (right or left) side of the bed to a second (left or right) side of the bed, thereby gently moving the person from lying on their first (e.g., right) side to lying on their second (e.g., left) side at their command.

For example, a device to help a person in bed to avoid decubitus ulcers comprises: one or more garments which are worn by a person who lies in a bed, wherein the garments further comprise electromagnetic markers on pant legs and torso; a plurality of electromagnetic sensors which detect the locations of the markers; a human-to-computer interface (e.g., voice command interface) which is controlled by the person; a first sling structure onto which the person places their knees; a second sling structure onto which the person places their torso; wherein the sling structures move (a) if the person gives the appropriate command and (b) if the sensors indicate that the person's knees and torso are properly positioned in the support structures; and wherein the support structures are moved in arc in 3D space from a first (right or left) side of the bed to a second (left or right) side of the bed, thereby gently moving the person from lying on their first (e.g., right) side to lying on their second (e.g., left) side at their command. Alternatively, a device which helps to prevent decubitus ulcers comprises: one or more garments which are worn by a person who lies in a bed, wherein the garments further comprise electromagnetic markers on pant legs and torso; a plurality of electromagnetic sensors which detect the locations of the markers; a human-to-computer interface (e.g., voice command interface) which is controlled by the person; a first set of robotic arms which gently engages the person's knees; a second set of robotic arms which gently engage the person's torso; wherein the robotic arms move the person's knees and torso in a sequence of at least five gradual and limited moves, along an arcuate path in 3D space, from a first (right or left) side of the bed to a second (right or left) side of the bed: (a) if the person gives the appropriate command to continue for each of the five sequential gradual and limited moves; and (b) if the sensors indicate that the person's knees and torso are properly positioned for each of the five sequential gradual and limited moves.

In one example, a device to help a person in bed to avoid decubitus ulcers comprises: one or more garments which are worn by a person who lies in a bed, wherein the garments further comprise electromagnetic markers on pant legs and shirt sleeves; a plurality of electromagnetic sensors which detect the locations of the markers; a human-to-computer interface (e.g., voice command interface) which is controlled by the person; a first soft C-shaped structure into which the person is able to place their knees; a second soft C-shaped structure into which the person is able to place their elbows; wherein the support structures move (a) if the person gives the appropriate command and (b) if the sensors indicate that the person's knees and elbows are properly positioned in the support structures; and wherein the support structures are moved, spanning an arc in 3D space, from a first (right or left) side of the bed to a second (left or right) side of the bed, thereby gently moving the person from lying on their first (e.g., right) side to lying on their second (e.g., left) side at their command. Alternatively, a device which helps a person in bed avoid decubitus ulcers comprises: one or more garments which are worn by a person who lies in a bed, wherein the garments further comprise electromagnetic markers on pant legs and shirt sleeves; a plurality of electromagnetic sensors which detect the locations of the markers; a human-to-computer interface (e.g., voice command interface) which is controlled by the person; a first set of robotic arms which gently engages the person's knees; a second set of robotic arms which gently engage the person's elbows; wherein the robotic arms move the person's knees and elbows, in an arcuate manner, from a first (right or left) side of the bed to a second (right or left) side of the bed: (a) if the person gives the appropriate command; and (b) if the sensors indicate that the person's knees and elbows are properly positioned.

In one example, a device to help a person in bed to avoid decubitus ulcers comprises: a longitudinal flexible support structure on which a person lies; a plurality of lateral beams (or ribs) which laterally span the width of the support structure above the support structure, wherein the right and left sides (or edges or corners) of the support structure are connected to right and left sides, respectively, of the lateral beams; a longitudinal beam which spans longitudinally under a central portion of the support structure and which is connected to the support structure; and a plurality of actuators which move the connections between the support structure and the lateral beams, thereby changing the slope and/or shape of the support structure to help the person to move from lying on their first (e.g., right) side to lying on their second (e.g., left) side.

Alternatively, a device to help a person in bed to avoid decubitus ulcers comprises: a plurality of longitudinal cords; a plurality of lateral cords; wherein the longitudinal cords and the lateral cords together create an orthogonal mesh or grid which supports a sleeping person's body; and a plurality of actuators which move (selected) longitudinal cords in a lateral manner and move (selected) lateral cords in a longitudinal manner in order to create an opening (or hole) in the mesh or grid at a selected location; wherein the selected location is located under a portion of the sleeping person's body which has a pressure ulcer or is particularly vulnerable to getting a pressure ulcer.

In another example, a device to help a person in bed to avoid decubitus ulcers comprises: a plurality of longitudinal flexible strips; a plurality of lateral flexible strips; wherein the longitudinal flexible strips and the lateral flexible strips together form an orthogonal mesh or grid which supports a sleeping person's body; and a plurality of actuators which move selected longitudinal strips apart from each other and move selected lateral strips apart from each other in order to enlarge a quadrilateral-shaped opening in the mesh or grid at a selected location; wherein the selected location is located under a portion of the sleeping person's body which has a pressure ulcer or is particularly vulnerable to getting a pressure ulcer.

Alternatively, a device which helps a person in bed to avoid decubitus ulcers comprises: a plurality of longitudinal strips; a plurality of lateral strips; wherein the longitudinal strips and the lateral strips are woven together create an orthogonal mesh or grid which supports a sleeping person's body; and a plurality of actuators which move (selected) longitudinal strips away from each other and move (selected) lateral strips away from each other in order to create an opening (or hole) in the mesh or grid at a selected location; wherein the selected location is located under a portion of the sleeping person's body which has a pressure ulcer or is particularly vulnerable to getting a pressure ulcer.

A device to help a person in bed to avoid decubitus ulcers comprises: a plurality of longitudinal strips; a plurality of lateral strips; wherein the longitudinal strips and the lateral strips together create an orthogonal mesh or grid which supports a sleeping person's body; and a plurality of actuators which move (selected) longitudinal strips apart from each other and move (selected) lateral strips apart from each other in order to create a quadrilateral-shaped opening in the mesh or grid at a selected location; wherein the selected location is located under a portion of the sleeping person's body which has a pressure ulcer or is particularly vulnerable to getting a pressure ulcer. Alternatively, a device which helps a person in bed to avoid decubitus ulcers comprises: a plurality of porous longitudinal strips; a plurality of porous lateral strips; wherein the longitudinal strips and the lateral strips together create an orthogonal porous mesh or grid which supports a sleeping person's body; and a plurality of actuators which move (selected) longitudinal strips in a lateral manner and move (selected) lateral strips in a longitudinal manner in order to create an opening (or hole) in the mesh or grid at a selected location; wherein the selected location is located under a portion of the sleeping person's body which has a pressure ulcer or is particularly vulnerable to getting a pressure ulcer.

In another example, a device to help a person in bed to avoid decubitus ulcers comprises: a plurality of porous longitudinal strips; a plurality of porous lateral strips; wherein the longitudinal strips and the lateral strips together create an orthogonal porous mesh or grid which supports a sleeping person's body; and a plurality of actuators which move (selected) longitudinal strips and move (selected) lateral strips to create an opening (or hole) in the mesh or grid at a selected location; wherein the selected location is located under a portion of the sleeping person's body which has a pressure ulcer or is particularly vulnerable to getting a pressure ulcer. Alternatively, a device which helps to prevent decubitus ulcers comprises: a longitudinal flexible support structure (such as a reinforced sheet, blanket, pad, mesh, net, or sling) on which a person lies; a right side longitudinal beam to the right of the support structure; a left side longitudinal beam to the left of the support structure; and a central longitudinal beam under a central portion of the support structure; wherein the support structure is attached to the right side, left side, and central longitudinal beams; and a plurality of actuators which move the right side and left side beams closer together and then farther apart, thereby changing the slope and/or shape of the support structure and helping the person to move from lying on their first (e.g., right) side to lying on their second (e.g., left) side.

For example, a device to help a person in bed to avoid decubitus ulcers comprises: a longitudinal flexible support structure (such as a reinforced sheet, blanket, pad, mesh, net, or sling) on which a person lies; a right side longitudinal beam to the right of the support structure; a left side longitudinal beam to the left of the support structure; and a central longitudinal beam under a central portion of the support structure; wherein the support structure is attached to the right side, left side, and central longitudinal beams; and a plurality of actuators which move the beams closer together or farther apart in a sequential manner, thereby changing the slope and/or shape of the support structure in a sequential manner and helping the person to move from lying on their first (e.g., right) side to lying on their second (e.g., left) side. Alternatively, a device to help a person in bed to avoid decubitus ulcers comprises: a longitudinal flexible support structure on which a person lies; a right side longitudinal beam to the right of the support structure; a left side longitudinal beam to the left of the support structure; and a central longitudinal beam under a central portion of the support structure; wherein the support structure is attached to the right side, left side, and central longitudinal beams; and a plurality of actuators which move the right side and left side beams closer together and then farther apart, thereby changing the slope and/or shape of the support structure and helping the person to move from lying on their first (e.g., right) side to lying on their second (e.g., left) side.

In another embodiment, a device to help a person in bed to avoid decubitus ulcers comprises: a longitudinal flexible support structure on which a person lies; a right-side cushion (or pillow) to the right of the person; a left-side cushion (or pillow) to the left of the person; wherein the person is turned from lying on their first (e.g., right) side to lying on their second (e.g., left) side by—moving the right-side and left-side cushions (or pillows) toward the person in a laterally-asymmetric manner, tilting and/or rotating the right-side and left-side cushions around their longitudinal axes, and moving the right-side and left-side cushions away from the person in a laterally-asymmetric manner. Alternatively, a device which helps a person in bed avoid decubitus ulcers comprises: a longitudinal flexible support structure on which a person lies; a right-side inflatable cushion (or pillow); a left-side inflatable cushion (or pillow); wherein the right-side and left-side cushions are asymmetrically inflated around the person, then tilted and/or rotated, and then deflated.

In another example, a device to help a person in bed to avoid decubitus ulcers comprises: a longitudinal flexible support structure on which a person lies; a right-side inflatable cushion; a left-side inflatable cushion, wherein the right-side and left-side cushions are inflated during a first period of time, wherein the right-side and left-side cushions are deflated during a second period of time, wherein a first cushion is inflated more than a second cushion during the first period of time, and wherein the second cushion is inflated more than the first cushion during the second period of time. Alternatively, a device which helps to prevent decubitus ulcers comprises: a longitudinal flexible support structure on which a person lies; a right-side inflatable lateral-wedge-shaped chamber on the right side of the support structure; a left-side inflatable lateral-wedge-shaped chamber on the left side of the support structure; wherein the right-side and left-side chambers are inflated during a first period of time; wherein the right-side and left-side chambers are deflated during a second period of time; wherein a first chamber on a first selected side is inflated more rapidly than a second chamber on a second side during the first period of time; and wherein the first chamber is deflated more rapidly than the second chamber during the second period of time.

In one example, a device to help a person in bed to avoid decubitus ulcers comprises: a longitudinal flexible support structure on which a person lies; a right-side inflatable lateral-wedge-shaped chamber on the right side of the support structure; a left-side inflatable lateral-wedge-shaped chamber on the left side of the support structure; wherein the right-side and left-side chambers are moved toward the person and inflated during a first period of time; and wherein the right-side and left-side chambers are deflated and moved away from the person during a second period of time. Alternatively, a device which helps a person in bed to avoid decubitus ulcers comprises: a longitudinal flexible support structure on which a person lies; a right-side inflatable longitudinal air compartment on the right side of the support structure; a left-side inflatable longitudinal air compartment on the left side of the support structure; wherein the right-side and left-side air compartments are inflated during a first period of time; wherein the right-side and left-side air compartments are deflated during a second period of time; wherein a first air compartment on a first selected side is inflated more rapidly than a second air compartment on a second side during the first period of time; and wherein the first air compartment is deflated more rapidly than the second air compartment during the second period of time.

In another example, a device to help a person in bed to avoid decubitus ulcers comprises: a longitudinal flexible support structure on which a person lies; a right-side inflatable longitudinal air compartment on the right side of the support structure; a left-side inflatable longitudinal air compartment on the left side of the support structure; wherein the right-side and left-side air compartments are inflated during a first period of time; wherein the right-side and left-side air compartments are deflated during a second period of time; wherein a first air compartment on a first selected side is inflated to a larger size than a second air compartment on a second side. Alternatively, a device to help a person in bed to avoid decubitus ulcers comprises: a longitudinal flexible support structure on which a person lies; a right-side inflatable longitudinal cushion on the right side of the support structure; a left-side inflatable longitudinal cushion on the left side of the support structure; wherein the right-side and left-side cushions are inflated during a first period of time; wherein the right-side and left-side cushions are deflated during a second period of time; wherein a first cushion on a first (right or left) side is inflated to a larger size than a second cushion on a second (left or right) side.

In another embodiment, a device to help a person in bed to avoid decubitus ulcers comprises: a longitudinal flexible body support surface (such as a net, mesh, pad, sheet, or blanket) on which a person lies; a right-side inflatable member (such as a compartment, bladder, cushion, or wedge) and a left-side inflatable member (such as a compartment, bladder, cushion, or wedge) under the support surface; a mattress under the support surface; and a plurality of actuators; wherein the person is moved from lying on their first (e.g., right) side to lying on their second (e.g., left) side in the following steps (a) lifting the right and left sides of the support surface using the actuators, thereby wrapping the support surface at least partially around the person's torso and lifting the person who was lying on their first (e.g., right) side at least partially up off the mattress with the lateral axis of their torso being substantially vertical; (b) inflating the second side inflatable member so that the second-side inflatable member pushes against the support surface and tilts, pivots, and/or rotates the person's body around a longitudinal axis; and then (c) lowering the right and left sides of the support surface using the actuators, thereby unwrapping the support surface from around the person's torso and lowering the person down onto the mattress lying on their second (e.g., left) side.

Alternatively, a device which helps to prevent decubitus ulcers comprises: a longitudinal flexible body support surface (such as a net, mesh, pad, sheet, or blanket) on which a person lies; a right-side inflatable member (such as a compartment, bladder, cushion, or wedge) and a left-side inflatable member (such as a compartment, bladder, cushion, or wedge) under the support surface; a mattress under the support surface; and a plurality of actuators; wherein the person is moved from lying on their first (e.g., right) side to lying on their second (e.g., left) side as follows (a) lifting the right and left edges of the support surface using the actuators, thereby wrapping the support surface at least partially around the person's torso and lifting the person who was lying on their first (e.g., right) side at least partially up off the mattress; (b) inflating the right-side and/or left-side inflatable members such that one or both of the inflatable members push against the side of the support surface, thereby tilting, pivoting, and/or rotating the person's body around a longitudinal axis; and then (c) lowering the right and left edges of the support surface using the actuators, thereby unwrapping the support surface from being around the person's torso and lowering the person down onto the mattress lying on their second (e.g., left) side.

For example, a device to help a person in bed to avoid decubitus ulcers comprises: a longitudinal flexible body support surface (such as a net, mesh, pad, sheet, or blanket) on which a person lies; a right-side inflatable member (such as a compartment, bladder, cushion, or wedge) and a left-side inflatable member (such as a compartment, bladder, cushion, or wedge) under the support surface; a mattress under the support surface; and a plurality of actuators; wherein the person is moved from lying on their first (e.g., right) side to lying on their second (e.g., left) side as follows (a) lifting the right and left edges of the support surface using the actuators, thereby wrapping the support surface at least partially around the person's torso and lifting the person who was lying on their first (e.g., right) side at least partially up off the mattress; (b) inflating the right-side and/or left-side inflatable members such that one or both of the inflatable members push against the side of the support surface, thereby tilting, pivoting, and/or rotating the person's body around a longitudinal axis; lowering the right and left edges of the support surface using the actuators, thereby unwrapping the support surface from being around the person's torso and lowering the person down onto the mattress lying on their second (e.g., left) side; and then (d) deflating the right-side and/or left-side inflatable members. Alternatively, a device which helps a person to avoid decubitus ulcers comprises: a longitudinal flexible body support surface (such as a net, mesh, pad, sheet, or blanket) on which a person lies; a right-side inflatable wedge and a left-side inflatable wedge under the support surface; and a plurality of actuators; wherein the person is moved from lying on their first (e.g., right) side to lying on their second (e.g., left) side in the following steps (a) lifting the right and left sides of the support surface using the actuators, thereby wrapping the support surface at least partially around the person's torso and lifting the person who was lying on their first (e.g., right) side at least partially up off the mattress with the lateral axis of their torso being substantially vertical; (b) inflating the second side (opposite the first side) inflatable wedge so that the second-side inflatable compartment pushes against the support surface and tilts, pivots, and/or rotates the person's body around a longitudinal axis; and then (c) lowering the right and left sides of the support surface using the actuators, thereby unwrapping the support surface from around the person's torso and lowering the person down onto the mattress lying on their second (e.g., left) side.

In another example, a device to help a person in bed to avoid decubitus ulcers comprises: a longitudinal flexible body support surface (such as a net, mesh, pad, sheet, or blanket) on which a person lies; a right-side inflatable wedge and a left-side inflatable wedge under the support surface; and a plurality of actuators; wherein the person is moved from lying on their first (e.g., right) side to lying on their second (e.g., left) side in the following steps (a) lifting the right and left sides of the support surface using the actuators, thereby lifting the person who was lying on their first (e.g., right) side at least partially up off the mattress; (b) inflating the second side (opposite the first side) inflatable wedge so that the second-side inflatable compartment pushes against the support surface and tilts, pivots, and/or rotates the person's body around a longitudinal axis; (c) lowering the right and left sides of the support surface using the actuators, thereby lowering the person down onto the mattress lying on their second (e.g., left) side; and then (d) deflating the second side inflatable wedge. Alternatively, a device which helps a person in bed avoid decubitus ulcers comprises: a longitudinal flexible support structure on which a person lies; a right-side inflatable wedge-shaped cushion (or pillow); a left-side inflatable wedge-shaped cushion (or pillow); wherein the right-side and left-side cushions are moved toward the person and asymmetrically inflated during a first period of time; wherein the right-side and left-side cushions are deflated and moved away from the person during a second period of time.

A device to help a person in bed to avoid decubitus ulcers comprises: a longitudinal flexible support structure on which a person lies; a right-side inflatable wedge-shaped cushion, wherein the narrower side of the cushion faces toward the person's body; a left-side inflatable wedge-shaped cushion; wherein the narrower side of the cushion faces toward the person's body, wherein the right-side and left-side cushions are inflated during a first period of time, wherein the right-side and left-side cushions are deflated during a second period of time, wherein a first cushion is inflated more than a second cushion during the first period of time, and wherein the second cushion is inflated more than the first cushion during the second period of time.

Alternatively, a device to help a person in bed to avoid decubitus ulcers comprises: a reinforced sheet (or blanket or pad) on which a person lies; a right-side longitudinal beam (or arm) to which the right side of the sheet is attached; a left-side longitudinal beam (or arm) to which the left side of the sheet is attached; a central longitudinal beam (or arm) to which a central longitudinal portion of the sheet is attached; and a plurality of actuators which move the right-side and left-side longitudinal beams (or arms) closer together or farther apart, in a sequential manner, thereby changing the shape of the sheet and helping the person to move from lying on their first (e.g., right) side to lying on their second (e.g., left) side.

In another example, a device to help a person in bed to avoid decubitus ulcers comprises: a reinforced sheet (or blanket or pad) on which a person lies; a right-side longitudinal beam (or arm) to which the right side of the sheet is attached; a left-side longitudinal beam (or arm) to which the left side of the sheet is attached; a central longitudinal beam (or arm) to which a central longitudinal portion of the sheet is attached; and a plurality of actuators which move the longitudinal beams (or arms) closer together or farther apart, in a sequential manner, thereby changing the shape of the sheet and helping the person to move from lying on their first (e.g., right) side to lying on their second (e.g., left) side. Alternatively, a device which helps a person in bed to avoid decubitus ulcers comprises: a reinforced sheet (or blanket or pad) on which a person lies; a right-side longitudinal beam (or arm) to which the right side of the sheet is attached; a left-side longitudinal beam (or arm) to which the left side of the sheet is attached; a central longitudinal beam (or arm) to which a central longitudinal portion of the sheet is attached; and a plurality of actuators which move the longitudinal beams (or arms) closer together or farther apart, thereby enfolding around a portion of the persons torso, moving the person from lying on their first (e.g., right) side to lying on their second (e.g., left) side, and unfolding from around the portion of the person's torso.

In one example, a device to help a person in bed to avoid decubitus ulcers comprises: a longitudinal flexible support structure on which a person lies; a right-side longitudinal cushion along the right side of the support structure; a left-side longitudinal cushion along the left side of the support structure; wherein the right-side and left-side cushions are inflated during a first period of time; wherein the right-side and left-side cushions are deflated during a second period of time; wherein a first cushion on a first selected side is inflated more than a second cushion on a second side during the first period of time; and wherein the first cushion is deflated more than the second cushion during the second period of time. Alternatively, a device which helps to prevent decubitus ulcers comprises: a first arcuate beam (or rib) which arcs over the width of a bed on which a person lies; a second arcuate beam (or rib) which arcs over the width of the bed, wherein the first beam is closer to the head of the bed than the second arcuate beam; a flexible support structure whose corners (or sides) are connected to the first beam and the second beam; and a plurality of actuators move the locations of the connections between the support structure and the first and second beams, thereby changing the slope and/or shape of the support structure which, in turn, helps the person to turn from lying on their first (e.g., right) side to lying on their second (e.g., left) side.

In one example, a device to help a person in bed to avoid decubitus ulcers comprises: a first body support surface with a first configuration in which it is below a person's (lower) torso and a second configuration in which it is above a person's (lower) torso, wherein the first body support surface is in its first configuration during a first period of time and in its second configuration during a second period of time; a second body support surface with a third configuration in which it is below the person's (lower) torso and a fourth configuration in which it is above the person's (lower) torso, wherein the second body support surface is in its fourth configuration during the first period of time and in its third configuration during the second period of time; and a plurality of actuators, wherein the actuators rotate the first body support surface from its first configuration to its second configuration and rotate the second body support surface from its fourth configuration to its third configuration.

Alternatively, a device which helps a person in bed to avoid decubitus ulcers comprises: a first pivoting (and/or rotating) arcuate rib which spans from a first pivot joint at the foot of a bed to a second pivot joint at the head of the bed, wherein the first pivoting arcuate rib has a concave shape which opens toward the bed mattress, wherein the first pivoting arcuate rib has a first configuration in which it spans (from the foot of the bed to the head of the bed) around a portion of the perimeter of the bed mattress and the plane of its concavity is substantially horizontal, wherein the first pivoting arcuate rib has a second configuration in which it spans (from the foot of the bed to the head of the bed) over the bed mattress and the plane of its concavity is substantially vertical, and wherein the first pivoting arcuate rib is manually (or automatically using at least one actuator) pivoted (and/or rotated) from its first configuration to its second configuration, or vice versa; a second pivoting (and/or rotating) arcuate rib which spans from the first pivot joint at the foot of a bed to the second pivot joint at the head of the bed, wherein the second pivoting arcuate rib has a concave shape which opens toward the bed mattress, wherein the second pivoting arcuate rib has a third configuration in which it spans (from the foot of the bed to the head of the bed) around a portion of the perimeter of the bed mattress and the plane of its concavity is substantially horizontal, wherein the second pivoting arcuate rib has a fourth configuration in which it spans (from the foot of the bed to the head of the bed) over the bed mattress and the plane of its concavity intersects a horizontal plane at an angle greater than 45 degrees, and wherein the second pivoting arcuate rib is manually (or automatically using at least one actuator) pivoted (and/or rotated) from its third configuration to its fourth configuration, or vice versa; and a flexible support structure (e.g., reinforced sheet, blanket, pad, net, mesh, strap, or sling) on which a person lies, wherein a first (e.g., right or left) side of the support structure is attached to the first pivoting arcuate rib and a second (e.g., left or right) side of the support structure is attached to the second pivoting arcuate rib, and wherein changing the first pivoting arcuate rib from its first configuration to its second configuration (or vice versa) and changing the second pivoting arcuate rib from its third configuration to its fourth configuration (or vice versa) assists in turning (or automatically turns) the person from lying on their first (e.g., right or left) side to lying on their second (e.g., left or right) side.

In another example, a device to help a person in bed to avoid decubitus ulcers comprises: a first pivoting (and/or rotating) C-shaped rib which spans from a first pivot joint at the foot of a bed to a second pivot joint at the head of the bed, wherein the first pivoting C-shaped rib has a concave shape which opens toward the bed mattress, wherein the first pivoting C-shaped rib has a first configuration in which it spans (from the foot of the bed to the head of the bed) around a portion of the perimeter of the bed mattress and the plane of its concavity is substantially horizontal, wherein the first pivoting C-shaped rib has a second configuration in which it spans (from the foot of the bed to the head of the bed) over the bed mattress and the plane of its concavity is substantially vertical, and wherein the first pivoting C-shaped rib is manually (or automatically using at least one actuator) pivoted (and/or rotated) from its first configuration to its second configuration, or vice versa; a second pivoting (and/or rotating) C-shaped rib which spans from the first pivot joint at the foot of a bed to the second pivot joint at the head of the bed, wherein the second pivoting C-shaped rib has a concave shape which opens toward the bed mattress, wherein the second pivoting C-shaped rib has a third configuration in which it spans (from the foot of the bed to the head of the bed) around a portion of the perimeter of the bed mattress and the plane of its concavity is substantially horizontal, wherein the second pivoting C-shaped rib has a fourth configuration in which it spans (from the foot of the bed to the head of the bed) over the bed mattress and the plane of its concavity intersects a horizontal plane at an angle greater than 45 degrees, and wherein the second pivoting C-shaped rib is manually (or automatically using at least one actuator) pivoted (and/or rotated) from its third configuration to its fourth configuration, or vice versa; and a flexible support structure (e.g., reinforced sheet, blanket, pad, net, mesh, strap, or sling) on which a person lies, wherein a first (e.g., right or left) side of the support structure is attached to the first pivoting C-shaped rib and a second (e.g., left or right) side of the support structure is attached to the second pivoting C-shaped rib, and wherein changing the first pivoting C-shaped rib from its first configuration to its second configuration (or vice versa) and changing the second pivoting C-shaped rib from its third configuration to its fourth configuration (or vice versa) assists in turning (or automatically turns) the person from lying on their first (e.g., right or left) side to lying on their second (e.g., left or right) side.

Alternatively, a device to help a person in bed to avoid decubitus ulcers comprises: a first pivoting (and/or rotating) rib which spans from a (laterally-central) pivot joint at the foot of a bed to a (laterally-central) pivot joint at the head of the bed, wherein the first pivoting rib has a concave shape which opens toward the bed mattress, wherein the first pivoting rib has a first configuration in which it spans (from the foot of the bed to the head of the bed) around a portion of the perimeter of the bed mattress and the plane of its concavity is substantially horizontal, wherein the first pivoting rib has a second configuration in which it spans (from the foot of the bed to the head of the bed) over the bed mattress and the plane of its concavity is substantially vertical, and wherein the first pivoting rib is manually (or automatically using at least one actuator) pivoted (and/or rotated) from its first configuration to its second configuration, or vice versa; a second pivoting (and/or rotating) rib which spans from a (laterally-central) pivot joint at the foot of a bed to a (laterally-central) pivot joint at the head of the bed, wherein the second pivoting rib has a concave shape which opens toward the bed mattress, wherein the second pivoting rib has a third configuration in which it spans (from the foot of the bed to the head of the bed) around a portion of the perimeter of the bed mattress and the plane of its concavity is substantially horizontal, wherein the second pivoting rib has a fourth configuration in which it spans (from the foot of the bed to the head of the bed) over the bed mattress and the plane of its concavity is substantially vertical, and wherein the second pivoting rib is manually (or automatically using at least one actuator) pivoted (and/or rotated) from its third configuration to its fourth configuration, or vice versa; and a flexible support structure (e.g., reinforced sheet, blanket, pad, net, mesh, strap, or sling) on which a person lies, wherein a first (e.g., right or left) side of the support structure is attached to the first pivoting rib and a second (e.g., left or right) side of the support structure is attached to the second pivoting rib, and wherein changing the first pivoting rib from its first configuration to its second configuration (or vice versa) and changing the second pivoting rib from its third configuration to its fourth configuration (or vice versa) assists in turning (or automatically turns) the person from lying on their first (e.g., right or left) side to lying on their second (e.g., left or right) side.

For example, a device to help a person in bed to avoid decubitus ulcers comprises: a first pivoting (and/or rotating) rib which spans from a pivot joint at the foot of a bed to a pivot joint at the head of the bed, wherein the first pivoting rib has a concave shape which opens toward the bed mattress, wherein the first pivoting rib has a first configuration in which it spans (from the foot of the bed to the head of the bed) around a portion of the perimeter of the bed mattress, wherein the first pivoting rib has a second configuration in which it spans (from the foot of the bed to the head of the bed) over the bed mattress, and wherein the first pivoting rib is manually (or automatically using at least one actuator) pivoted (and/or rotated) from its first configuration to its second configuration, or vice versa; a second pivoting (and/or rotating) rib which spans from a pivot joint at the foot of a bed to a pivot joint at the head of the bed, wherein the second pivoting rib has a concave shape which opens toward the bed mattress, wherein the second pivoting rib has a third configuration in which it spans (from the foot of the bed to the head of the bed) around a portion of the perimeter of the bed mattress, wherein the second pivoting rib has a fourth configuration in which it spans (from the foot of the bed to the head of the bed) over the bed mattress, and wherein the second pivoting rib is manually (or automatically using at least one actuator) pivoted (and/or rotated) from its third configuration to its fourth configuration, or vice versa; and a flexible support structure (e.g., reinforced sheet, blanket, pad, net, mesh, strap, or sling) on which a person lies, wherein a first (e.g., right or left) side of the support structure is attached to the first pivoting rib and a second (e.g., left or right) side of the support structure is attached to the second pivoting rib, wherein the support structure spans the entire foot longitudinal half of the bed mattress but does not span the entire head half longitudinal half of the bed mattress, and wherein changing the first pivoting rib from its first configuration to its second configuration (or vice versa) and changing the second pivoting rib from its third configuration to its fourth configuration (or vice versa) assists in turning (or automatically turns) the person from lying on their first (e.g., right or left) side to lying on their second (e.g., left or right) side.

Alternatively, a device which helps to prevent decubitus ulcers comprises: a first pivoting (and/or rotating) rib which spans from a pivot joint at the foot of a bed to a pivot joint at the head of the bed, wherein the first pivoting rib has a concavity which opens toward the bed mattress, wherein the first pivoting rib has a first configuration in which it spans around a first (e.g., right or left) side of the bed mattress and the plane of its concavity is substantially horizontal, wherein the first pivoting rib has a second configuration in which it spans over the bed mattress and the plane of its concavity is substantially vertical, and wherein the first pivoting rib is manually (or automatically using at least one actuator) pivoted (and/or rotated) from its first configuration to its second configuration, or vice versa; a second pivoting (and/or rotating) rib which spans from a pivot joint at the foot of a bed to a second pivot joint at the head of the bed, wherein the second pivoting rib has a concavity which opens toward the bed mattress, wherein the second pivoting rib has a third configuration in which it spans around a second (e.g., left or right) side of the bed mattress and the plane of its concavity is substantially horizontal, wherein the second pivoting rib has a fourth configuration in which it spans over the bed mattress and the plane of its concavity intersects a horizontal plane at an angle greater than 45 degrees, and wherein the second pivoting rib is manually (or automatically using at least one actuator) pivoted (and/or rotated) from its third configuration to its fourth configuration, or vice versa; and a flexible support structure (e.g., reinforced sheet, blanket, pad, net, mesh, strap, or sling) on which a person lies, wherein a first (e.g., right or left) side of the support structure is attached to the first pivoting rib and a second (e.g., left or right) side of the support structure is attached to the second pivoting rib, and wherein changing the first pivoting rib from its first configuration to its second configuration (or vice versa) and changing the second pivoting rib from its third configuration to its fourth configuration (or vice versa) assists in turning (or automatically turns) the person from lying on their first (e.g., right or left) side to lying on their second (e.g., left or right) side.

In another example, a device to help a person in bed to avoid decubitus ulcers comprises: a first pivoting (and/or rotating) rib which spans from a pivot joint at the lateral center of the foot of a bed to a pivot joint at the lateral center of the head of the bed, wherein the first pivoting rib has a concavity which opens toward the bed mattress, wherein the first pivoting rib has a first configuration in which it spans around a first (e.g., right or left) side of the bed mattress, wherein the first pivoting rib has a second configuration in which it spans over the bed mattress, and wherein the first pivoting rib is manually (or automatically using at least one actuator) pivoted (and/or rotated) from its first configuration to its second configuration, or vice versa; a second pivoting (and/or rotating) rib which spans from a pivot joint at the lateral center of the foot of a bed to a second pivot joint at the lateral center of the head of the bed, wherein the second pivoting rib has a concavity which opens toward the bed mattress, wherein the second pivoting rib has a third configuration in which it spans around a second (e.g., left or right) side of the bed mattress, wherein the second pivoting rib has a fourth configuration in which it spans over the bed mattress, and wherein the second pivoting rib is manually (or automatically using at least one actuator) pivoted (and/or rotated) from its third configuration to its fourth configuration, or vice versa; and a flexible support structure (e.g., reinforced sheet, blanket, pad, net, mesh, strap, or sling) on which a person lies, wherein a first (e.g., right or left) side of the support structure is attached to the first pivoting rib and a second (e.g., left or right) side of the support structure is attached to the second pivoting rib, and wherein changing the first pivoting rib from its first configuration to its second configuration (or vice versa) and changing the second pivoting rib from its third configuration to its fourth configuration (or vice versa) assists in turning (or automatically turns) the person from lying on their first (e.g., right or left) side to lying on their second (e.g., left or right) side.

Alternatively, a device which helps a person in bed avoid decubitus ulcers comprises: a first pivoting (and/or rotating) rib which spans from a rotating joint at the foot of a bed to a rotating joint at the head of the bed, wherein the first pivoting rib has a concavity which opens toward a bed mattress, wherein the first pivoting rib has a first configuration in which it spans around a first (e.g., right or left) side of the bed mattress, wherein the first pivoting rib has a second configuration in which it spans over the bed mattress, and wherein the first pivoting rib is manually (or automatically using at least one actuator) pivoted (and/or rotated) from its first configuration to its second configuration, or vice versa; a second pivoting (and/or rotating) rib which spans from a rotating joint at the foot of a bed to a rotating joint at the head of the bed, wherein the second pivoting rib has a concavity which opens toward the bed mattress, wherein the second pivoting rib has a third configuration in which it spans around a second (e.g., left or right) side of the bed mattress, wherein the second pivoting rib has a fourth configuration in which it spans over the bed mattress, and wherein the second pivoting rib is manually (or automatically using at least one actuator) pivoted (and/or rotated) from its third configuration to its fourth configuration, or vice versa; and a flexible support structure (e.g., reinforced sheet, blanket, pad, net, mesh, strap, or sling) on which a person lies, wherein a first (e.g., right or left) side of the support structure is attached to the first pivoting rib and a second (e.g., left or right) side of the support structure is attached to the second pivoting rib, and wherein changing the first pivoting rib from its first configuration to its second configuration (or vice versa) and changing the second pivoting rib from its third configuration to its fourth configuration (or vice versa) assists in turning (or automatically turns) the person from lying on their first (e.g., right or left) side to lying on their second (e.g., left or right) side.

In one example, a device to help a person in bed to avoid decubitus ulcers comprises: a first pivoting (and/or rotating) rib which spans from a first pivot joint at the foot of a bed to a second pivot joint at the head of the bed, wherein the first pivoting rib has a concave shape which opens toward the bed mattress, wherein the first pivoting rib has a first configuration in which it spans (from the foot of the bed to the head of the bed) around a portion of the perimeter of the bed mattress and the plane of its concavity is substantially horizontal, wherein the first pivoting rib has a second configuration in which it spans (from the foot of the bed to the head of the bed) over the bed mattress and the plane of its concavity is substantially vertical, and wherein the first pivoting rib is manually (or automatically using at least one actuator) pivoted (and/or rotated) from its first configuration to its second configuration, or vice versa; a second pivoting (and/or rotating) rib which spans from the first pivot joint at the foot of a bed to the second pivot joint at the head of the bed, wherein the second pivoting rib has a concave shape which opens toward the bed mattress, wherein the second pivoting rib has a third configuration in which it spans (from the foot of the bed to the head of the bed) around a portion of the perimeter of the bed mattress and the plane of its concavity is substantially horizontal, wherein the second pivoting rib has a fourth configuration in which it spans (from the foot of the bed to the head of the bed) over the bed mattress and the plane of its concavity intersects a horizontal plane at an angle greater than 45 degrees, and wherein the second pivoting rib is manually (or automatically using at least one actuator) pivoted (and/or rotated) from its third configuration to its fourth configuration, or vice versa; and a flexible support structure (e.g., reinforced sheet, blanket, pad, net, mesh, strap, or sling) on which a person lies, wherein a first (e.g., right or left) side of the support structure is attached to the first pivoting rib and a second (e.g., left or right) side of the support structure is attached to the second pivoting rib, and wherein changing the first pivoting rib from its first configuration to its second configuration (or vice versa) and changing the second pivoting rib from its third configuration to its fourth configuration (or vice versa) assists in turning (or automatically turns) the person from lying on their first (e.g., right or left) side to lying on their second (e.g., left or right) side.

Alternatively, a device which helps to prevent decubitus ulcers comprises: a first pivoting (and/or rotating) square-wave-shaped rib which spans from a first pivot joint at the foot of a bed to a second pivot joint at the head of the bed, wherein the first pivoting square-wave-shaped rib has a concave shape which opens toward the bed mattress, wherein the first pivoting square-wave-shaped rib has a first configuration in which it spans (from the foot of the bed to the head of the bed) around a portion of the perimeter of the bed mattress and the plane of its concavity is substantially horizontal, wherein the first pivoting square-wave-shaped rib has a second configuration in which it spans (from the foot of the bed to the head of the bed) over the bed mattress and the plane of its concavity is substantially vertical, and wherein the first pivoting square-wave-shaped rib is manually (or automatically using at least one actuator) pivoted (and/or rotated) from its first configuration to its second configuration, or vice versa; a second pivoting (and/or rotating) square-wave-shaped rib which spans from the first pivot joint at the foot of a bed to the second pivot joint at the head of the bed, wherein the second pivoting square-wave-shaped rib has a concave shape which opens toward the bed mattress, wherein the second pivoting square-wave-shaped rib has a third configuration in which it spans (from the foot of the bed to the head of the bed) around a portion of the perimeter of the bed mattress and the plane of its concavity is substantially horizontal, wherein the second pivoting square-wave-shaped rib has a fourth configuration in which it spans (from the foot of the bed to the head of the bed) over the bed mattress and the plane of its concavity intersects a horizontal plane at an angle greater than 45 degrees, and wherein the second pivoting square-wave-shaped rib is manually (or automatically using at least one actuator) pivoted (and/or rotated) from its third configuration to its fourth configuration, or vice versa; and a flexible support structure (e.g., reinforced sheet, blanket, pad, net, mesh, strap, or sling) on which a person lies, wherein a first (e.g., right or left) side of the support structure is attached to the first pivoting square-wave-shaped rib and a second (e.g., left or right) side of the support structure is attached to the second pivoting square-wave-shaped rib, and wherein changing the first pivoting square-wave-shaped rib from its first configuration to its second configuration (or vice versa) and changing the second pivoting square-wave-shaped rib from its third configuration to its fourth configuration (or vice versa) assists in turning (or automatically turns) the person from lying on their first (e.g., right or left) side to lying on their second (e.g., left or right) side.

A device to help a person in bed to avoid decubitus ulcers comprises: a first plurality of parallel flexible strips; a second plurality of parallel flexible strips; a third plurality of parallel flexible strips; wherein the first, second, and third pluralities of parallel flexible strips are woven together to create a hexagonal mesh or grid which supports a sleeping person's body; and a plurality of actuators which move selected strips apart from each other in order to enlarge a hexagonal-shaped opening in the mesh or grid at a selected location; wherein the selected location is located under a portion of the sleeping person's body which has a pressure ulcer or is particularly vulnerable to getting a pressure ulcer. Alternatively, a device to help a person in bed to avoid decubitus ulcers comprises: a first plurality of parallel flexible strips; a second plurality of parallel flexible strips; wherein the first and second pluralities of parallel flexible strips are woven together to create an orthogonal mesh or grid which supports a sleeping person's body; and a plurality of actuators which move selected strips apart from each other in order to enlarge a quadrilateral-shaped opening in the mesh or grid at a selected location; wherein the selected location is located under a portion of the sleeping person's body which has a pressure ulcer or is particularly vulnerable to getting a pressure ulcer.

In another example, a device to help a person in bed to avoid decubitus ulcers comprises: a first roller (or tube) at the head a bed (or bed mattress); a second roller (or tube) at the foot of the bed; one or more actuators; and a plurality of moving loops, wherein each loop has longitudinal variation in thickness, wherein an upper portion of each loop spans the length of the bed between the rollers in a first direction; wherein a lower portion of each moving loop spans the length of the bed between the rollers in a second direction; and wherein each loop is rotated around the rollers by the one or more actuators. Alternatively, a device which helps a person in bed to avoid decubitus ulcers comprises: a first roller (or tube) at the head a bed (or bed mattress); a second roller (or tube) at the foot of the bed; one or more actuators; and a plurality of moving sinusoidal loops, wherein each loop has sinusoidal variation in thickness, wherein an upper portion of each loop spans the length of the bed between the rollers in a first direction; wherein a lower portion of each moving loop spans the length of the bed between the rollers in a second direction; and wherein each loop is rotated around the rollers by the one or more actuators.

In one example, a device to help a person in bed to avoid decubitus ulcers comprises: a first roller (or tube) at the head a bed (orbed mattress); a second roller (or tube) at the foot of the bed; one or more actuators; and a plurality of moving loops, wherein each loop has longitudinal variation in thickness, wherein an upper portion of each loop spans the length of the bed between the rollers in a first direction; wherein a lower portion of each moving loop spans the length of the bed between the rollers in a second direction; wherein each loop is rotated around the rollers by the one or more actuators; and wherein different loops are moved and/or rotated in different directions. Alternatively, a device which helps a person to avoid decubitus ulcers comprises: a first roller (or tube) at the head a bed (or bed mattress); a second roller (or tube) at the foot of the bed; one or more actuators; and a plurality of moving sinusoidal loops, wherein each loop has sinusoidal variation in thickness, wherein an upper portion of each loop spans the length of the bed between the rollers in a first direction; wherein a lower portion of each moving loop spans the length of the bed between the rollers in a second direction; wherein each loop is rotated around the rollers by the one or more actuators; and wherein different loops are moved and/or rotated in different directions.

In another example, a device to help a person in bed to avoid decubitus ulcers comprises: a first roller (or tube) at the head a bed (orbed mattress); a second roller (or tube) at the foot of the bed; one or more actuators; and a plurality of moving loops, wherein each loop has longitudinal variation in thickness, wherein an upper portion of each loop spans the length of the bed between the rollers in a first direction; wherein a lower portion of each moving loop spans the length of the bed between the rollers in a second direction; wherein each loop is rotated around the rollers by the one or more actuators; and wherein adjacent loops are moved and/or rotated in opposite longitudinal directions. Alternatively, a device which helps a person in bed avoid decubitus ulcers comprises: a first roller (or tube) at the head a bed (or bed mattress); a second roller (or tube) at the foot of the bed; one or more actuators; and a plurality of moving sinusoidal loops, wherein each loop has sinusoidal variation in thickness, wherein an upper portion of each loop spans the length of the bed between the rollers in a first direction; wherein a lower portion of each moving loop spans the length of the bed between the rollers in a second direction; wherein each loop is rotated around the rollers by the one or more actuators; and wherein adjacent loops are moved and/or rotated in opposite longitudinal directions.

For example, a device to help a person in bed to avoid decubitus ulcers comprises: a first roller (or tube) on a first (e.g., right) side of a bed (or bed mattress); a second roller (or tube) on a second (e.g., left) side of the bed; one or more actuators; and a plurality of moving loops, wherein each loop has lateral variation in thickness, wherein an upper portion of each loop spans the width of the bed between the rollers in a first direction; wherein a lower portion of each moving loop spans the width of the bed between the rollers in a second direction; and wherein each loop is rotated around the rollers by the one or more actuators.

Alternatively, a device to help a person in bed to avoid decubitus ulcers comprises: a first roller (or tube) on a first (e.g., right) side of a bed (or bed mattress); a second roller (or tube) on a second (e.g., left) side of the bed; one or more actuators; and a plurality of moving sinusoidal loops, wherein each loop has sinusoidal variation in thickness, wherein an upper portion of each loop spans the width of the bed between the rollers in a first direction; wherein a lower portion of each moving loop spans the width of the bed between the rollers in a second direction; and wherein each loop is rotated around the rollers by the one or more actuators.

In another embodiment, a device to help a person in bed to avoid decubitus ulcers comprises: a first roller (or tube) on a first (e.g., right) side of a bed (or bed mattress); a second roller (or tube) on a second (e.g., left) side of the bed; one or more actuators; and a plurality of moving loops, wherein each loop has lateral variation in thickness, wherein an upper portion of each loop spans the width of the bed between the rollers in a first direction; wherein a lower portion of each moving loop spans the width of the bed between the rollers in a second direction; wherein each loop is rotated around the rollers by the one or more actuators; and wherein different loops are moved and/or rotated in different directions. Alternatively, a device which helps to prevent decubitus ulcers comprises: a first roller (or tube) on a first (e.g., right) side of a bed (or bed mattress); a second roller (or tube) on a second (e.g., left) side of the bed; one or more actuators; and a plurality of moving sinusoidal loops, wherein each loop has sinusoidal variation in thickness, wherein an upper portion of each loop spans the width of the bed between the rollers in a first direction; wherein a lower portion of each moving loop spans the width of the bed between the rollers in a second direction; wherein each loop is rotated around the rollers by the one or more actuators; and wherein different loops are moved and/or rotated in different directions.

In another example, a device to help a person in bed to avoid decubitus ulcers comprises: a first roller (or tube) on a first (e.g., right) side of a bed (or bed mattress); a second roller (or tube) on a second (e.g., left) side of the bed; one or more actuators; and a plurality of moving loops, wherein each loop has lateral variation in thickness, wherein an upper portion of each loop spans the width of the bed between the rollers in a first direction; wherein a lower portion of each moving loop spans the width of the bed between the rollers in a second direction; wherein each loop is rotated around the rollers by the one or more actuators; and wherein adjacent loops are moved and/or rotated in opposite lateral directions. Alternatively, a device which helps a person in bed to avoid decubitus ulcers comprises: a first roller (or tube) on a first (e.g., right) side of a bed (or bed mattress); a second roller (or tube) on a second (e.g., left) side of the bed; one or more actuators; and a plurality of moving sinusoidal loops, wherein each loop has sinusoidal variation in thickness, wherein an upper portion of each loop spans the width of the bed between the rollers in a first direction; wherein a lower portion of each moving loop spans the width of the bed between the rollers in a second direction; wherein each loop is rotated around the rollers by the one or more actuators; and wherein adjacent loops are moved and/or rotated in opposite lateral directions.

In one example, a device to help a person in bed to avoid decubitus ulcers comprises: a first support surface with a first configuration in which it is below a person's (lower) torso and a second configuration in which it is above a person's (lower) torso, wherein the first support surface is in its first configuration during a first period of time and in its second configuration during a second period of time; a second support surface with a third configuration in which it is below the person's (lower) torso and a fourth configuration in which it is above the person's (lower) torso, wherein the second support surface is in its fourth configuration during the first period of time and in its third configuration during the second period of time; and a plurality of actuators; wherein a person is turned from lying on their first (e.g., right or left) side to lying on their second (e.g., left or right side) in the following manner—the first support surface and/or second support surface is inflated; the actuators rotate the first body support surface from its first configuration to its second configuration and rotate the second body support surface from its fourth configuration to its third configuration, and the first support surface and/or the second support surface is deflated. Alternatively, a device which helps to prevent decubitus ulcers comprises: a first support surface with a first configuration in which it is below a person's (lower) torso and a second configuration in which it is above a person's (lower) torso, wherein the first support surface is in its first configuration during a first period of time and in its second configuration during a second period of time; a second support surface with a third configuration in which it is below the person's (lower) torso and a fourth configuration in which it is above the person's (lower) torso, wherein the second support surface is in its fourth configuration during the first period of time and in its third configuration during the second period of time; and a plurality of actuators; wherein a person is turned from lying on their first (e.g., right or left) side to lying on their second (e.g., left or right side) in the following manner—the second support surface is inflated; the actuators rotate the first body support surface from its first configuration to its second configuration and rotate the second body support surface from its fourth configuration to its third configuration, and the second support surface is deflated.

In another example, a device to help a person in bed to avoid decubitus ulcers comprises: a first support surface with a first configuration in which it is below a person's (lower) torso and a second configuration in which it is above a person's (lower) torso, wherein the first support surface is in its first configuration during a first period of time and in its second configuration during a second period of time; a second support surface with a third configuration in which it is below the person's (lower) torso and a fourth configuration in which it is above the person's (lower) torso, wherein the second support surface is in its fourth configuration during the first period of time and in its third configuration during the second period of time; and a plurality of actuators; wherein a person is turned from lying on their first (e.g., right or left) side to lying on their second (e.g., left or right side) in the following manner—the second support surface is inflated; the actuators rotate the first body support surface from its first configuration to its second configuration and rotate the second body support surface from its fourth configuration to its third configuration, and the first support surface is deflated. Alternatively, a device to help a person in bed to avoid decubitus ulcers comprises: a concave bed mattress on which a person lies; an actuator which rotates and/or tilts the bed mattress around a longitudinal (head-to-toe) axis; wherein rotation and/or tilting of the bed mattress helps the person to turn from lying on their first (e.g., right) side to lying on their second (e.g., left) side; a right side cushion (or pillow or chamber) on the right side of the bed mattress; and a left side cushion (or pillow or chamber) on the left side of the bed mattress; wherein the right side cushion and/or the left side cushion are changed from a less-inflated configuration to more-inflated configurations, or vice versa; and wherein the right side cushion is in its more-inflated configuration longer than the left side cushion as the mattress is rotated and/or tilted in a counter-clockwise direction; and wherein the left side cushion is in its more-inflated configuration longer than the right side cushion as the mattress is rotated and/or tilted in a clockwise direction.

A device to help a person in bed to avoid decubitus ulcers comprises: an arcuate bed mattress on which a person lies; an actuator which rotates and/or tilts the bed mattress around a longitudinal axis; wherein rotation and/or tilting of the bed mattress helps the person to turn from lying on their first (e.g., right) side to lying on their second (e.g., left) side; a right side cushion on the right side of the bed mattress; and a left side cushion on the left side of the bed mattress; wherein the inflation levels of the right side cushion and/or the left side cushion are automatically changed over time; wherein the right side cushion is more inflated or inflated longer than the left side cushion when the mattress is rotated and/or tilted in a clockwise direction; and wherein the left side cushion is more inflated or inflated longer than the right side cushion when the mattress is rotated and/or tilted in a counter-clockwise direction. Alternatively, a device which helps a person in bed to avoid decubitus ulcers comprises: a bed mattress with a concave upper surface on which a person lies; an actuator which rotates and/or tilts the bed mattress in a clockwise or counter-clockwise direction around a longitudinal head-to-toe axis, wherein rotation and/or tilting of the bed mattress helps the person to turn from lying on a their first (e.g., right) side to their second (e.g., left) side; a first cushion on a first (right or left) side of the bed mattress with an inflation level which is automatically changed over time; a second cushion on a second (left or right) side of the bed mattress with an inflation level which is automatically changed over time; wherein the average inflation level of the first cushion is greater than the average inflation level of the second cushion as the mattress is rotated and/or tilted in a clockwise direction; and wherein the average inflation level of the second cushion is greater than the average inflation level of the first cushion as the mattress is rotated and/or tilted in a counter-clockwise direction.

For example, a device to help a person in bed to avoid decubitus ulcers comprises: a garment which is worn by a person who lies in a bed, wherein the garment has selected portions (on the legs and sleeves) which are reinforced so that the fabric does not tear and/or the portion does not bind on a person's body when the portion is pulled; an electromagnetic sensor which detects the locations of the selected portions of the garment; at least one robotic arm which first gently grasps (or otherwise reversibly connects with) the selected portions of the garment and then gently pushes or pulls the selected portions (in an arc through space) from a first (right or left) side of the bed to a second (left or right) side of the bed, thereby moving the person from lying on their first (e.g., right) side to lying on their second (e.g., left) side.

Alternatively, a device which helps to prevent decubitus ulcers comprises: a flexible support structure (such as a net, mesh, sling, hammock, pad, sheet, or blanket) on which a person lies; an undulating loop of flexible material which is under the flexible support structure, wherein the loop comprises an upper portion which moves in a selected lateral direction (e.g., right-to-left) and a lower portion which moves in the opposite lateral direction (e.g., left-to-right); and a plurality of actuators which lift the flexible support structure up off the loop of flexible material, move (and/or rotate) the loop of flexible material laterally, and then lower the flexible support structure back down onto the loop of flexible material.

In another example, a device to help a person in bed to avoid decubitus ulcers comprises: a lower first-side cushion (or pillow) on a first (e.g., right or left) side of the person; an upper first-side cushion (or pillow) which is also on the first side of the person, but above the lower first-side cushion; a lower second-side cushion (or pillow) on a second (e.g., left or right) side of the person; an upper second-side cushion (or pillow) which is also on the second side of the person, but above the lower second-side cushion; wherein the person is turned from lying on their first (e.g., right) side to lying on their second (e.g., left) side by: moving the first and second side lower cushions toward a first portion of the person's torso to hold the first portion of the torso in place; and asymmetrically moving the first and second side upper cushions to push a second portion of the person's torso in a lateral direction. Alternatively, a device which helps a person in bed to avoid decubitus ulcers comprises: a lower first-side cushion on a first (e.g., right or left) side of the person; an upper first-side cushion which is also on the first side of the person, but above the lower first-side cushion; a lower second-side cushion on a second (e.g., left or right) side of the person; an upper second-side cushion which is also on the second side of the person, but above the lower second-side cushion; wherein the person is turned from lying on their first (e.g., right) side to lying on their second (e.g., left) side by inflation and deflation of the cushions, wherein inflation of the lower cushions holds a first portion of the person's torso in place, and wherein asymmetric inflation of the upper cushions pushes a second portion of the person's torso in a lateral direction.

In another embodiment, a method to help a person in bed to avoid decubitus ulcers comprises: (a) detecting (based on image analysis or data from optical, pressure, stretch, or electromagnetic energy sensors) that a person in a bed is lying on their side on a mattress; and (b) if the person is lying on their side, temporarily inflating right and left side cushions and changing the mattress from a flat configuration to an arcuate configuration to help the person move from lying on their first (e.g., right) side to lying on their second (e.g., left) side. Alternatively, a method to help a person in bed to avoid decubitus ulcers comprises: (a) detecting (based on image analysis or data from optical, pressure, stretch, or electromagnetic energy sensors) that a person in a bed is lying on their side on a mattress; and (b) if the person is lying on their side, temporarily rotating and/or tilting the mattress to help the person move from lying on their first (e.g., right) side to lying on their second (e.g., left) side.

In another example, a device to help a person in bed to avoid decubitus ulcers comprises: a support structure (such as a mattress) on which a person lies, wherein the support structure further comprises a plurality of adjustable portions (e.g., cells, columns, bladders, or compartments) whose sizes and/or shapes are able to be individually adjusted, and wherein the support structure further comprises a plurality of electromagnetic energy sensors; and a garment (or dressing) which is worn by the person, wherein the garment (or dressing) further comprises at least one electromagnetic energy emitter, wherein a ring of adjustable portions surrounding, but not directly beneath, the electromagnetic energy emitter at a selected time are identified by the electromagnetic energy sensors, and wherein the sizes and/or shapes of the ring of adjustable portions near (e.g., within 6″ of) the electromagnetic energy emitter at the selected time are increased relative to the sizes and/or shapes of the rest of the adjustable portions. Alternatively, a device to help a person in bed to avoid decubitus ulcers comprises: a support structure on which a person lies, wherein the support structure further comprises a plurality of adjustable portions (e.g., cells, columns, bladders, or compartments) whose sizes are able to be selectively adjusted, and wherein the support structure further comprises a plurality of electromagnetic energy sensors; and a garment (or dressing) which is worn by the person, wherein the garment (or dressing) further comprises an electromagnetic energy emitter, wherein the adjustable portions which are below the electromagnetic energy emitter at a selected time are identified by the electromagnetic energy sensors, and wherein the sizes of the adjustable portions which are near (e.g., within 1″ to 6″ of) the electromagnetic energy emitter at the selected time are decreased relative to the sizes of the rest of the adjustable portions.

In another embodiment, a device to help a person in bed to avoid decubitus ulcers comprises: a support structure on which a person lies, wherein the support structure further comprises a plurality of adjustable portions (e.g., cells, columns, bladders, or compartments) whose sizes are able to be selectively adjusted, and wherein the support structure further comprises a plurality of electromagnetic energy sensors; and a garment (or dressing) which is worn by the person, wherein the garment (or dressing) further comprises an electromagnetic energy emitter, wherein the adjustable portions which are below the electromagnetic energy emitter at a selected time are identified by the electromagnetic energy sensors, and wherein the sizes of the adjustable portions which are near (e.g., within 1″ to 2″ of) the electromagnetic energy emitter at the selected time are decreased relative to the sizes of the rest of the adjustable portions. Alternatively, a device which helps a person in bed avoid decubitus ulcers comprises: a support structure on which a person lies, wherein the support structure further comprises a plurality of adjustable portions (e.g., cells, columns, bladders, or compartments) whose sizes are able to be selectively adjusted, and wherein the support structure further comprises a plurality of electromagnetic energy sensors; and a garment (or dressing) which is worn by the person, wherein the garment (or dressing) further comprises an electromagnetic energy emitter, wherein the adjustable portions which are below the electromagnetic energy emitter at a selected time are identified by the electromagnetic energy sensors, and wherein the sizes of the adjustable portions which are within 6″ of the electromagnetic energy emitter at the selected time are decreased relative to the sizes of the rest of the adjustable portions.

In one example, a device to help a person in bed to avoid decubitus ulcers comprises: a support structure on which a person lies, wherein the support structure further comprises a plurality of inflated portions (e.g., cells, columns, bladders, or compartments) whose inflation levels are able to be selectively adjusted, and wherein the support structure further comprises a plurality of electromagnetic energy sensors; and a garment (or dressing) which is worn by the person, wherein the garment (or dressing) further comprises an electromagnetic energy emitter, wherein the inflated portions which are farther than a selected distance (e.g., 6″) from the electromagnetic energy emitter at a selected time are identified by the electromagnetic energy sensors, and wherein the inflation levels of the inflated portions which are farther than the selected distance from the electromagnetic energy emitter at the selected time are increased relative to the inflation levels of the inflated portions which are closer than the selected distance. Alternatively, a device which helps a person to avoid decubitus ulcers comprises: a support structure on which a person lies, wherein the support structure further comprises a plurality of adjustable portions (e.g., cells, columns, bladders, or compartments) whose sizes are able to be individually adjusted, and wherein the support structure further comprises a plurality of electromagnetic energy sensors; and a garment (or dressing) which is worn by the person, wherein the garment (or dressing) further comprises an electromagnetic energy emitter, wherein the adjustable portions which are below the electromagnetic energy emitter at a selected time are identified by the electromagnetic energy sensors, and wherein the sizes of the adjustable portions which are not below the electromagnetic energy emitter at the selected time are increased relative to the sizes of the adjustable portions which are below the electromagnetic energy emitter.

In another example, a device to help a person in bed to avoid decubitus ulcers comprises: a support structure on which a person lies, wherein the support structure further comprises a plurality of adjustable portions (e.g., cells, columns, bladders, or compartments) whose sizes are able to be selectively adjusted, and wherein the support structure further comprises a plurality of electromagnetic energy sensors; and a garment (or dressing) which is worn by the person, wherein the garment (or dressing) further comprises an electromagnetic energy emitter, wherein the adjustable portions which are below the electromagnetic energy emitter at a selected time are identified by the electromagnetic energy sensors, and wherein the sizes of the adjustable portions which are not below the electromagnetic energy emitter at the selected time are increased relative to the sizes of the adjustable portions which are below the electromagnetic energy emitter.

Alternatively, a device which helps to prevent decubitus ulcers comprises: a support structure on which a person lies, wherein the support structure further comprises a plurality of inflated portions (e.g., cells, compartments, bladders, or columns) whose inflation levels are able to be individually adjusted, and wherein the support structure further comprises a plurality of electromagnetic energy sensors; and a garment (or dressing) which is worn by the person, wherein the garment (or dressing) further comprises an electromagnetic energy emitter, wherein inflated portions which are near (e.g., within 6″ of) the electromagnetic energy emitter at a selected time are identified by the electromagnetic energy sensors, and wherein the inflation levels of the inflated portions near the electromagnetic energy emitter at the selected time are reduced relative to the inflation levels of the rest of the inflated portions.

For example, a device to help a person in bed to avoid decubitus ulcers comprises: a support structure on which a person lies, wherein the support structure further comprises a plurality of inflated portions (e.g., cells, compartments, bladders, or columns) whose inflation levels are able to be individually adjusted, and wherein the support structure further comprises a plurality of electromagnetic energy sensors; and a garment (or dressing) which is worn by the person, wherein the garment (or dressing) further comprises an electromagnetic energy emitter, wherein inflated portions which are near (e.g., within 6″ of) the electromagnetic energy emitter at a selected time are identified by the electromagnetic energy sensors, and wherein the inflation levels of the inflated portions near the electromagnetic energy emitter at the selected time are reduced (by at least 20%) relative to the inflation levels of the rest of the inflated portions.

Alternatively, a device to help a person in bed to avoid decubitus ulcers comprises: a support structure on which a person lies, wherein the support structure further comprises a plurality of adjustable portions which each have a first configuration and a second configuration, wherein the second configuration is shorter than the first configuration, and wherein the support structure further comprises a plurality of electromagnetic energy sensors; and a garment (or dressing) which is worn by the person, wherein the garment (or dressing) further comprises at least one electromagnetic energy emitter, wherein the adjustable portions which are within a selected distance (e.g., within 2″ to 6″) from the electromagnetic energy emitter at a selected time are set to their second configurations but other adjustable portions are set to their first configurations.

In another example, a device to help a person in bed to avoid decubitus ulcers comprises: a support structure on which a person lies, wherein the support structure further comprises a plurality of adjustable portions whose sizes are able to be individually adjusted, and wherein the support structure further comprises a plurality of electromagnetic energy sensors; and a garment (or dressing) which is worn by the person, wherein the garment (or dressing) further comprises at least one electromagnetic energy emitter, wherein the adjustable portions which are within a selected distance (between 1″ and 6″) from the electromagnetic energy emitter at a selected time are identified by the electromagnetic energy sensors, and wherein the sizes of the adjustable portions near (e.g., within 6″ of) the electromagnetic energy emitter at the selected time are reduced relative to the sizes of the rest of the adjustable portions. Alternatively, a device which helps a person in bed to avoid decubitus ulcers comprises: a support structure on which a person lies, wherein the support structure further comprises a plurality of adjustable portions whose sizes and/or shapes are able to be individually adjusted, and wherein the support structure further comprises a plurality of electromagnetic energy sensors; and a garment (or dressing) which is worn by the person, wherein the garment (or dressing) further comprises at least one electromagnetic energy emitter, wherein the adjustable portions which are within a selected distance (e.g., within 2″ to 6″) from the electromagnetic energy emitter at a selected time are identified by the electromagnetic energy sensors, and wherein the sizes and/or shapes of the adjustable portions near (e.g., within 6″ of) the electromagnetic energy emitter at the selected time are adjusted relative to the sizes and/or shapes of the rest of the adjustable portions.

In one example, a device to help a person in bed to avoid decubitus ulcers comprises: a support structure on which a person lies, wherein the support structure further comprises a plurality of adjustable portions whose sizes are able to be individually adjusted, and wherein the support structure further comprises a plurality of electromagnetic energy sensors; and a garment (or dressing) which is worn by the person, wherein the garment (or dressing) further comprises at least one electromagnetic energy emitter, wherein the adjustable portions which are within a selected distance (e.g., with the range of 1″ to 6″) from the electromagnetic energy emitter at a selected time are identified by the electromagnetic energy sensors, and wherein the sizes of the adjustable portions near (e.g., within 6″ of) the electromagnetic energy emitter at the selected time are reduced relative to the sizes of the rest of the adjustable portions. Alternatively, a device which helps to prevent decubitus ulcers comprises: a support structure on which a person lies, wherein the support structure further comprises a plurality of adjustable portions which each have a first configuration and a second configuration, wherein the second configuration is smaller than the first configuration, and wherein the support structure further comprises a plurality of electromagnetic energy sensors; and a garment (or dressing) which is worn by the person, wherein the garment (or dressing) further comprises at least one electromagnetic energy emitter, wherein the adjustable portions which are near (e.g., within 6″ of) the electromagnetic energy emitter at a selected time are set to their second configurations but other adjustable portions are set to their first configurations.

A device to help a person in bed to avoid decubitus ulcers comprises: a support structure on which a person lies, wherein the support structure further comprises a plurality of adjustable portions (e.g., cells, columns, bladders, or compartments) whose sizes and/or shapes are able to be individually adjusted; and a garment (or dressing) which is worn by the person, wherein the sizes and/or shapes of adjustable portions which are below (a selected section of) the garment at a given time are adjusted relative to the sizes and/or shapes of the rest of the adjustable portions. Alternatively, a device which helps a person in bed to avoid decubitus ulcers comprises: a support structure on which a person lies, wherein the support structure further comprises a plurality of adjustable portions (e.g., cells, columns, bladders, or compartments) whose sizes and/or shapes are able to be individually adjusted; and a garment (or dressing) with a plurality of pressure sensors which is worn by the person, wherein the sizes and/or shapes of adjustable portions which are below (a selected section of) the garment at a given time are adjusted relative to the sizes and/or shapes of the rest of the adjustable portions.

In another example, a device to help a person in bed to avoid decubitus ulcers comprises: a flexible support structure (such as a net, mesh, hammock, sling, sheet, blanket, mattress pad, folding mattress, articulating mattress, or shape-changing mattress) with a longitudinal axis, wherein a person lies on the flexible support structure on their right side or left side at a first point in time, wherein the support structure has a first configuration which is substantially flat and under the person's body, wherein the support structure has a second configuration with a right-side-facing concavity and wherein the person's body is at least partially within the concavity, and wherein the support structure has a third configuration with a left-side-facing concavity and wherein the person's body is at least partially within the concavity; and a plurality of actuators which move the support structure so that it transitions among its first, second, and third configurations. Alternatively, a device to help a person in bed to avoid decubitus ulcers comprises: one or more garments which are worn by a person who lies in a bed, wherein the garments further comprise electromagnetic markers on the pant legs and torso; and a plurality of electromagnetic sensors which detect the locations of the markers on the pant legs and torso; and a human-to-computer interface (e.g., voice command interface); and a first support structure with a soft opening into which the person places their torso; and a second support structure with a soft opening into which the person places their legs; and wherein the first and second support structures are moved when the person gives the appropriate command via the human-to-computer interface and the person's legs and torso are properly positioned within the first and second support structures based on data from the plurality of electromagnetic energy sensors; and wherein the first and second support structures are moved in an arcuate manner from a first (right or left) side of the bed to a second (left or right) side of the bed, thereby gently moving the person from lying on their first (e.g., right) side to lying on their second (e.g., left) side.

In one example, a device to help a person in bed to avoid decubitus ulcers comprises: a support structure (such as a mattress) on which a person lies, wherein the support structure further comprises a plurality of height-adjustable portions; and wherein the support structure further comprises a plurality of electromagnetic energy sensors; and a garment (or dressing) which is worn by the person, wherein the garment (or dressing) further comprises at least one electromagnetic energy emitter, wherein the height-adjustable portions which are below the electromagnetic energy emitter at a selected time are identified by the electromagnetic energy sensors, and wherein the heights of the height-adjustable portions which are below the electromagnetic energy emitter at the selected time are set lower than the heights of the rest of the height-adjustable portions. Alternatively, a device which helps to prevent decubitus ulcers comprises: a support structure (such as a mattress) on which a person lies, wherein the support structure further comprises a plurality of height-adjustable portions; and wherein the support structure further comprises a plurality of electromagnetic energy sensors; and a garment (or dressing) which is worn by the person, wherein the garment (or dressing) further comprises at least one electromagnetic energy emitter, wherein the height-adjustable portions which are below the electromagnetic energy emitter at a selected time are identified by the electromagnetic energy sensors, and wherein the heights of the height-adjustable portions which within a selected distance (in the range of 1″ to 6″) from the electromagnetic energy emitter at the selected time are set lower than the heights of the rest of the height-adjustable portions.

In another example, a device to help a person in bed to avoid decubitus ulcers comprises: one or more garments which are worn by a person who lies in a bed, wherein the one or more marked garments have first reinforced and/or padded portions on pant legs and second reinforces and/or padded portions on shirt sleeves; at least one (optical or electromagnetic) sensor which detects the locations of the portions; at least two robotic arms which simultaneously gently engage and move (e.g., push and/or pull) the portions in an arcuate manner from a first (right or left) side of the bed to a second (left or right) side of the bed, thereby gently moving the person from lying on their first (e.g., right) side to lying on their second (e.g., left) side. Alternatively, a device which helps a person in bed avoid decubitus ulcers comprises: one or more marked garments which are worn by a person who lies in a bed, wherein the one or more marked garments have first markers on the pant legs and second markers on the shirt sleeves; at least one (optical or electromagnetic) sensor which detects the locations of the markers; at least two robotic arms which are programmed to gently engage and push the marked portions of the one or more garments in an arcuate manner from a first (right or left) side of the bed to a second (left or right) side of the bed, thereby moving the person from lying on their first (e.g., right) side to lying on their second (e.g., left) side.

For example, a device to help a person in bed to avoid decubitus ulcers comprises: one or more marked garments which are worn by a person who lies in a bed, wherein the one or more marked garments have first markers on the pant legs and second markers on the shirt sleeves; at least one (optical or electromagnetic) sensor which detects the locations of the markers; at least two robotic arms which are programmed to gently engage and pull the marked portions of the one or more garments in an arcuate manner from a first (right or left) side of the bed to a second (left or right) side of the bed, thereby moving the person from lying on their first (e.g., right) side to lying on their second (e.g., left) side. Alternatively, a device which helps a person in bed to avoid decubitus ulcers comprises: a concave mattress on which a person lies; at least one actuator which changes the curvature of concavity of the mattress; at least one inflatable cushion (or pillow or compartment) on a first (right or left) side of the mattress; at least one inflatable cushion (or pillow or compartment) on a second (left or right) side of the mattress; wherein the person is moved from lying on their first (e.g., right) side to lying on their second (e.g., left) side by inflating the cushion on the first side and/or the second side of the mattress and changing the curvature of the concavity of the mattress.

In another embodiment, a device to help a person in bed to avoid decubitus ulcers comprises: an adjustably-concave mattress on which a person lies; at least one actuator which increases or decreases concavity of the mattress; at least one inflatable cushion (or compartment) on a first (right or left) side of the mattress; at least one inflatable cushion (or compartment) on a second (left or right) side of the mattress; wherein the person is moved from lying on their first (e.g., right) side to lying on their second (e.g., left) side by: inflating and deflating the cushions; and increasing and decreasing the concavity of the mattress.

Alternatively, a device to help a person in bed to avoid decubitus ulcers comprises: a laterally-concave mattress on which a person lies; at least one actuator which increases or decreases the curvature of lateral-concavity of the mattress; at least one inflatable cushion (or compartment) on a first (right or left) side of the mattress; at least one inflatable cushion (or compartment) on a second (left or right) side of the mattress; wherein the person is moved from lying on their first (e.g., right) side to lying on their second (e.g., left) side by inflating the cushion on the first side and/or the second side of the mattress and increasing the curvature of the lateral-concavity of the mattress. In another example, a device to help a person in bed to avoid decubitus ulcers comprises: a laterally-tiltable mattress on which a person lies; at least one actuator which laterally tilts the mattress; at least one cushion on a first (right or left) side of the mattress; at least one cushion on a second (left or right) side of the mattress; wherein the person is moved from lying on their first (e.g., right) side to lying on their second (e.g., left) side by moving one or both of the cushions and by laterally tilting the mattress. Alternatively, a device which helps a person to avoid decubitus ulcers comprises: a smart mattress with a first configuration in which its lateral cross-sectional shape is flat and a second configuration in which its lateral cross-sectional shape is a concave conic section; at least one actuator which moves the mattress from its first configuration to its second configuration, or vice versa; inflatable cushions on the right and left sides of the smart mattress; and at least one air pump which inflates the cushions; wherein a person lying on the smart mattress is moved from lying on their first (e.g., right) side to lying on their second (e.g., left) side by inflation of the cushions by the at least one air pump and by movement of the mattress from its first configuration to its second configuration by the at least one actuator.

In one example, a device to help a person in bed to avoid decubitus ulcers comprises: a smart mattress with a first configuration which is substantially (laterally) flat and a second configuration which is (laterally) concave; at least one actuator which moves the mattress from its first configuration to its second configuration, and vice versa; inflatable cushions (or pillows or chambers) on the right side and on the left side of the smart mattress; and at least one fluid pump which expands the cushions by filling them with fluid; wherein a person lying on the smart mattress is moved from lying on their first (e.g., right) side to lying on their second (e.g., left) side by expansion of the cushions and by movement of the mattress from its first configuration to its second configuration by the at least one actuator. Alternatively, a device which helps to prevent decubitus ulcers comprises: a smart mattress with a first configuration which is substantially horizontal and a second configuration which is rotated and/or tilted between 10 and 45 degrees from horizontal around a longitudinal axis; at least one actuator which moves the mattress from its first configuration to its second configuration, and vice versa; inflatable cushions on the right and left sides of the smart mattress; and at least one air pump which inflates the cushions; wherein a person lying on the smart mattress is moved from lying on their first (e.g., right) side to lying on their second (e.g., left) side by inflation of the cushions by the at least one air pump and by movement of the mattress from its first configuration to its second configuration by the at least one actuator.

In another example, a device to help a person in bed to avoid decubitus ulcers comprises: a smart mattress with a first configuration which is substantially flat and a second configuration with a laterally concave shape and cross-sectional variation in height between 6″ and 24″; at least one actuator which moves the mattress from its first configuration to its second configuration, and vice versa; inflatable cushions on the right and left sides of the smart mattress; and at least one air pump which inflates the cushions; wherein a person lying on the smart mattress is moved from lying on their first (e.g., right) side to lying on their second (e.g., left) side by inflation of the cushions by the at least one air pump and by movement of the mattress from its first configuration to its second configuration by the at least one actuator. Alternatively, a device which helps a person in bed avoid decubitus ulcers comprises: a smart mattress with a first configuration which is substantially horizontal and a second configuration which is rotated and/or tilted by an by an acute angle from horizontal around a longitudinal axis; at least one actuator which moves the mattress from its first configuration to its second configuration, or vice versa; inflatable cushions on the right and left sides of the smart mattress; and at least one air pump which inflates the cushions; wherein a person lying on the smart mattress is moved from lying on their first (e.g., right) side to lying on their second (e.g., left) side by inflation of the cushions by the at least one air pump and by movement of the mattress from its first configuration to its second configuration by the at least one actuator.

A device to help a person in bed to avoid decubitus ulcers comprises: a longitudinal bed mattress on which a person lies, wherein the upper surface of the mattress has cross-sectional shape which is selected from the group consisting of—parabola, arc of a circle, arc of an ellipse, conic section, catenary, and concave; at least one actuator which rotates and/or tilts the mattress around its longitudinal axis, wherein rotation and/or tilting of the mattress helps the person to move from lying on their first (e.g., right) side to lying on their second (e.g., left) side; a first (right or left) side cushion which has a more-expanded configuration or a less-expanded configuration; and a second (left or right) side cushion which has a more-expanded configuration or a less-expanded configuration; wherein the first side cushion and the second side cushion are both in their more-expanded configurations during the rotation and/or tilting of the mattress in order to cushion (or dampen) motion of the person's body during rotation and/or tilting. Alternatively, a device which helps to prevent decubitus ulcers comprises: a longitudinal bed mattress on which a person lies, wherein the upper surface of the mattress has cross-sectional shape selected from the group consisting of—parabola, arc of a circle, arc of an ellipse, conic section, catenary, and concave; at least one actuator which rotates and/or tilts the mattress around its longitudinal axis, wherein rotation and/or tilting of the mattress helps the person to move from lying on their first (e.g., right) side to lying on their second (e.g., left) side; a first (right or left) side cushion with a first level of inflation and/or expansion which varies over time; and a second (left or right) side cushion with a second level of inflation and/or expansion which varies over time; wherein the maximum first level is greater than the maximum second level during rotation and/or tilting of the mattress in a clockwise direction; and wherein the maximum second level is greater than the maximum first level during rotation and/or tilting of the mattress in a counter-clockwise direction.

For example, a device to help a person in bed to avoid decubitus ulcers comprises: a longitudinal bed mattress on which a person lies, wherein the upper surface of the mattress has cross-sectional shape which is selected from the group consisting of—parabola, arc of a circle, arc of an ellipse, conic section, catenary, and concave; at least one actuator which rotates and/or tilts the mattress around its longitudinal axis, wherein rotation and/or tilting of the mattress helps the person to move from lying on their first (e.g., right) side to lying on their second (e.g., left) side; a first (right or left) side cushion with a more-expanded configuration at a first time or a less-expanded configuration at a second time; and a second (left or right) side cushion with a more-expanded configuration at the first time or a less-expanded configuration at the second time; wherein the first side cushion and the second side cushion are in their more-expanded configurations during the rotation and/or tilting of the mattress in order to cushion (or dampen) motion of the person's body during rotation and/or tilting. Alternatively, a device to help a person in bed to avoid decubitus ulcers comprises: a longitudinal bed mattress on which a person lies, wherein the upper surface of the mattress has concave shape; at least one actuator which rotates and/or tilts the mattress around its longitudinal axis, wherein rotation and/or tilting of the mattress helps the person to move from lying on their first (e.g., right) side to lying on their second (e.g., left) side; a first inflated cushion within one foot of a first (right or left) side of the mattress; and a second inflated cushion within one foot of a second (left or right) side of the mattress; wherein the first cushion and the second cushion are sequentially inflated and deflated during the rotation and/or tilting of the mattress.

In another example, a device to help a person in bed to avoid decubitus ulcers comprises: a mattress on which a person lies, wherein the mattress is rotated and/or tilted around a longitudinal axis; at least one actuator which rotates and/or tilts the mattress; a first cushion on a first (right or left) side of the mattress; a second cushion on a second (left or right) side of the mattress; wherein the person is moved from lying on their first (e.g., right) side to lying on their second (e.g., left) side by—(a) moving a selected first or second cushion closer to the person's body, (b) tilting the mattress, and then (c) moving the selected first or second cushion away from the person's body. Alternatively, a device which helps a person in bed to avoid decubitus ulcers comprises: a bed mattress on which a person lies, wherein the mattress has an upper surface with a chevron-shaped cross section and a longitudinal (e.g., head-to-toe) axis; at least one actuator, wherein the actuator rotates and/or tilts the bed mattress (in a clockwise or counter-clockwise manner) around the longitudinal axis, wherein the actuator rotates and/or tilts the mattress in a periodic manner to help the person switch back and forth in a periodic manner from lying on their first (e.g., right) side to lying on their second (e.g., left) side; and a first expandable (e.g., inflatable) cushion to the right of the longitudinal axis; and a second expandable (e.g., inflatable) cushion to the left the longitudinal axis; wherein the first and second expandable cushions are in expanded (e.g., inflated) configurations when the mattress is rotated and/or tilted.

In another embodiment, a device to help a person in bed to avoid decubitus ulcers comprises: a bed mattress with a concave upper surface on which a person lies and a longitudinal (e.g., head to toe) axis; at least one actuator, wherein the actuator rotates and/or tilts the bed mattress around the longitudinal axis, and wherein rotation and/or tilting of the mattress helps the person to switch from lying on their first (e.g., right) side to lying on their second (e.g., left) side; a first expandable (e.g., inflatable) cushion (or compartment) to the right of the longitudinal axis; and a second expandable (e.g., inflatable) cushion (or compartment) to the left the longitudinal axis; wherein the first and second expandable cushions are in expanded (e.g., inflated) configurations as the mattress is rotated and/or tilted. Alternatively, a method to help a person in bed to avoid decubitus ulcers comprises: detecting if a person who is lying on a flexible support structure (e.g., a net, mesh, hammock, sling, sheet, blanket, or mattress pad) is lying on their right side or on their left side at a first point in time; automatically activating actuators to move a right edge and a left edge of the flexible support structure closer together so as to at least partially wrap, bend, or enfold the person's torso with the flexible support structure; then automatically activating actuators to move the right edge and the left edge of the flexible support structure in the direction of the side (right or left) on which the person was lying at the first point in time; then automatically activating actuators to tilt and/or rotate the right and left edges of the flexible support structure away from the side (right or left) on which the person was lying at the first point in time; and then automatically activating actuators to move a right edge and a left edge of the flexible support structure farther apart so as to unwrap, unbend, or unfold the flexible support structure from around person's torso.

In another example, a method to help a person in bed to avoid decubitus ulcers comprises: detecting (based on image analysis or data from optical, pressure, stretch, or electromagnetic energy sensors) that a person in a bed is lying on their first (e.g., right) side on a mattress; detecting (based on image analysis or data from optical, pressure, stretch, or electromagnetic energy sensors) that the person is awake; then, if the person is lying on their side and is awake, asking (via a speaker) the person if they want to switch sides; receiving (via speech recognition) a response from the person; and then, if the person responds that they want to switch sides, initiating movement of the mattress to help the person move from lying on their first (e.g., right) side to lying on their second (e.g., left) side. Alternatively, a method to help prevent decubitus ulcers comprises: detecting (based on image analysis or data from optical, pressure, stretch, or electromagnetic energy sensors) that a person in a bed is lying on their first (e.g., right) side on a mattress; if the person is lying on their side, then asking (via a speaker) the person if they want to switch sides; receiving (via speech recognition interface) a response from the person; and if the person responds that they want to switch sides, then initiating movement of the mattress to help the person move from lying on their first (e.g., right) side to lying on their second (e.g., left) side.

In one example, a method to help a person in bed to avoid decubitus ulcers comprises: detecting (based on image analysis or data from optical, pressure, stretch, or electromagnetic energy sensors) that a person in a bed is lying on their first (e.g., right) side on a mattress; if the person is lying on their side, then prompting the person with a light signal to indicate whether they want to switch sides; if the person responds (e.g., via speech recognition interface) that they want to switch sides, then rotating and/or tilting the mattress to help the person move from lying on their first (e.g., right) side to lying on their second (e.g., left) side. Alternatively, a device which helps to prevent decubitus ulcers comprises: a longitudinal support structure (e.g., mattress) on which a person lies; inflatable chambers (e.g., cushions) along the right and left sides of the support structure; wherein the chambers are inflated on either side of the person so as to temporarily hold the person in place, the support structure is rotated around its longitudinal axis, and then the chambers are deflated to release the person. In another embodiment, a device to help a person in bed to avoid decubitus ulcers comprises: a longitudinal support structure (such as a mattress) on which a person lies; inflatable chambers (or cushions or pillows) along the right and left sides of the support structure; wherein first the chambers are inflated, then the support structure is rotated between 160 and 200 degrees around its longitudinal axis, and then the chambers are deflated. Alternatively, a device which helps a person in bed to avoid decubitus ulcers comprises: a mattress on which a person lies on their side; inflatable cushions on the right and left sides of the mattress; and a plurality of actuators; wherein first the cushions are inflated to hold the person on the mattress, then the mattress is tilted and/or rotated around its longitudinal axis, and then the cushions are deflated.

In another example, a method to help prevent decubitus ulcers comprises: detecting if a person who is lying on a support structure with right side and left side inflatable chambers is lying on their side at a first point in time; inflating the right side and left side inflatable chambers; rotating and/or tilting the support structure, around a longitudinal axis, from a first orientation to a second orientation, wherein the second orientation is rotated between 160 and 200 degrees from the first orientation; and then deflating the right side and left side inflatable chambers. Alternatively, a method to help a person in bed to avoid decubitus ulcers comprises: detecting if a person who is lying on a flexible support structure (e.g., a net, mesh, hammock, sling, sheet, blanket, mattress pad, folding mattress, articulating mattress, or shape-changing mattress) is lying on their right side or on their left side at a first point in time; lifting the right and left edges of the flexible support structure which are located to the right and to the left of the person's body; lifting the right edge of the flexible support structure a first distance; lifting the left edge of the flexible support structure a second distance; wherein the first distance is less than the second distance if the person was lying on their right side at the first time; and wherein the first distance is greater than the second distance if the person was lying on their left side at the first time; thereby enfolding and/or wrapping the flexible support structure around a portion of the torso of the person's body; tilting and/or rotating the right and left edges of the flexible support structure to the left if the person was lying on their right side at the first time; or tilting and/or rotating the right and left edges of the flexible support structure to the right if the person was lying on their left side at the first time; moving the flexible support structure to the right if the person was lying on their right side at the first point in time or to the left if the person was lying on their left side at the first point in time; and lowering the right and left edges of the flexible support structure, thereby unfolding and/or unwrapping the flexible support structure from being around the portion of the person's torso, so that the person is now lying on their left side at a second time if the person had been lying on their right side at the first point in time, or so that the person is now lying on their right side at a second time if the person had been lying on their left side at the first point in time.

For example, a method to help prevent decubitus ulcers comprises: detecting if a person who is lying on a flexible support structure (e.g., a net, mesh, hammock, sling, sheet, blanket, mattress pad, folding mattress, articulating mattress, or shape-changing mattress) is lying on their right side or on their left side at a first point in time; lifting the right and left edges of the flexible support structure which are located to the right and to the left of the person's body; lifting the right edge of the flexible support structure a first distance; lifting the left edge of the flexible support structure a second distance; wherein the first distance is less than the second distance if the person was lying on their right side at the first time; and wherein the first distance is greater than the second distance if the person was lying on their left side at the first time; thereby enfolding and/or wrapping the flexible support structure around a portion of the torso of the person's body; tilting and/or rotating the right and left edges of the flexible support structure to the left if the person was lying on their right side at the first time; or tilting and/or rotating the right and left edges of the flexible support structure to the right if the person was lying on their left side at the first time; and lowering the right and left edges of the flexible support structure, thereby unfolding and/or unwrapping the flexible support structure from being around the portion of the person's torso, so that the person is now lying on their left side at a second time if the person had been lying on their right side at the first point in time, or so that the person is now lying on their right side at a second time if the person had been lying on their left side at the first point in time.

Alternatively, a method to help a person in bed to avoid decubitus ulcers comprises: detecting if a person who is lying on a flexible support structure (e.g., a net, mesh, hammock, sling, sheet, blanket, mattress pad, folding mattress, articulating mattress, or shape-changing mattress) is lying on their right side or on their left side at a first point in time; lifting the right and left edges of the flexible support structure which are located to the right and to the left of the person's body; moving the right edge of the flexible support structure a first distance; moving the left edge of the flexible support structure a second distance; wherein the first distance is less than the second distance if the person was lying on their right side at the first time; and wherein the first distance is greater than the second distance if the person was lying on their left side at the first time; thereby enfolding and/or wrapping the flexible support structure around a portion of the torso of the person's body; moving the flexible support structure to the right if the person was lying on their right side at the first point in time or to the left if the person was lying on their left side at the first point in time; and lowering the right and left edges of the flexible support structure, thereby unfolding and/or unwrapping the flexible support structure from being around the portion of the person's torso, so that the person is now lying on their left side at a second time if the person had been lying on their right side at the first point in time, or so that the person is now lying on their right side at a second time if the person had been lying on their left side at the first point in time.

In another example, a method to help a person in bed to avoid decubitus ulcers comprises: detecting if a person who is lying on a flexible support structure (e.g., a net, mesh, hammock, sling, sheet, blanket, mattress pad, folding mattress, articulating mattress, or shape-changing mattress) is lying on their right side or on their left side at a first point in time; lifting the right and left edges of the flexible support structure which are located to the right and to the left of the person's body; rotating the right side of the flexible support structure a first angle; rotating the left side of the flexible support structure a second angle; wherein the first angle is less than the second angle if the person was lying on their right side at the first time; and wherein the first angle is greater than the second angle if the person was lying on their left side at the first time; thereby enfolding and/or wrapping the flexible support structure around a portion of the torso of the person's body; tilting and/or rotating the right and left edges of the flexible support structure to the left if the person was lying on their right side at the first time; or tilting and/or rotating the right and left edges of the flexible support structure to the right if the person was lying on their left side at the first time; moving the flexible support structure to the right if the person was lying on their right side at the first point in time or to the left if the person was lying on their left side at the first point in time; and lowering the right and left edges of the flexible support structure, thereby unfolding and/or unwrapping the flexible support structure from being around the portion of the person's torso, so that the person is now lying on their left side at a second time if the person had been lying on their right side at the first point in time, or so that the person is now lying on their right side at a second time if the person had been lying on their left side at the first point in time.

Alternatively, a method to help a person in bed to avoid decubitus ulcers comprises: detecting if a person who is lying on a flexible support structure (e.g., a net, mesh, hammock, sling, sheet, blanket, mattress pad, folding mattress, articulating mattress, or shape-changing mattress) is lying on their right side or on their left side at a first point in time; lifting the right and left edges of the flexible support structure which are located to the right and to the left of the person's body; rotating the right side of the flexible support structure a first angle; rotating the left side of the flexible support structure a second angle; wherein the first angle is less than the second angle if the person was lying on their right side at the first time; and wherein the first angle is greater than the second angle if the person was lying on their left side at the first time; thereby enfolding and/or wrapping the flexible support structure around a portion of the torso of the person's body; tilting and/or rotating the right and left edges of the flexible support structure to the left if the person was lying on their right side at the first time; or tilting and/or rotating the right and left edges of the flexible support structure to the right if the person was lying on their left side at the first time; and lowering the right and left edges of the flexible support structure, thereby unfolding and/or unwrapping the flexible support structure from being around the portion of the person's torso, so that the person is now lying on their left side at a second time if the person had been lying on their right side at the first point in time, or so that the person is now lying on their right side at a second time if the person had been lying on their left side at the first point in time.

In one example, a method to help prevent decubitus ulcers comprises: detecting if a person who is lying on a flexible support structure is lying on their right side or on their left side at a first point in time; lifting up the right and left edges of the flexible support structure; wherein these edges are located to the right and to the left of the person's body, respectively; wherein during lifting the right edge of the flexible support structure is moved a first arcuate distance and the left edge of the flexible support structure is moved a second arcuate distance; wherein the first arcuate distance is greater than the second arcuate distance if the person was lying on their right side at the first time; wherein the first arcuate distance is less than the second arcuate distance if the person was lying on their left side at the first time; and wherein lifting causes the flexible support structure to be at least partially wrapped or enfolded around a portion of the person's torso; moving the flexible support structure to the right if the person was lying on their right side at the first point in time or moving the flexible support structure to the to the left if the person was lying on their left side at the first point in time; and lowering the previously-identified right and left edges of the flexible support structure; wherein during lowering the right edge of the flexible support structure is moved a third arcuate distance and the left edge of the flexible support structure is moved a fourth arcuate distance; wherein the third arcuate distance is less than the fourth arcuate distance if the person was lying on their right side at the first time and the third arcuate distance is greater than the fourth arcuate distance if the person was lying on their left side at the first time; wherein lowering unwraps or unfolds the flexible support structure from being around a portion of the person's torso; and wherein, after lowering, the person is now lying on their left side if they were originally lying on their right side at the first point in time or the person is now lying on their right side if they were originally lying on their left side at the first point in time.

Alternatively, a method to help a person in bed to avoid decubitus ulcers comprises: detecting if a person who is lying on a flexible support structure is lying on their right side or on their left side at a first point in time; lifting up the right and left edges of the flexible support structure; wherein these edges are located to the right and to the left of the person's body, respectively; wherein during lifting the right edge of the flexible support structure is moved a first arcuate distance and the left edge of the flexible support structure is moved a second arcuate distance; wherein the first arcuate distance is greater than the second arcuate distance if the person was lying on their right side at the first time; wherein the first arcuate distance is less than the second arcuate distance if the person was lying on their left side at the first time; and wherein lifting causes the flexible support structure to be at least partially wrapped or enfolded around a portion of the person's torso; moving the flexible support structure to the right if the person was lying on their right side at the first point in time or moving the flexible support structure to the to the left if the person was lying on their left side at the first point in time; and lowering the previously-identified right and left edges of the flexible support structure; wherein during lowering the right edge of the flexible support structure is moved a third arcuate distance and the left edge of the flexible support structure is moved a fourth arcuate distance; wherein the third arcuate distance is greater than the fourth arcuate distance if the person was lying on their right side at the first time and the third arcuate distance is less than the fourth arcuate distance if the person was lying on their left side at the first time; wherein lowering unwraps or unfolds the flexible support structure from being around a portion of the person's torso; and wherein, after lowering, the person is now lying on their left side if they were originally lying on their right side at the first point in time or the person is now lying on their right side if they were originally lying on their left side at the first point in time.

In one example, a method to help prevent decubitus ulcers comprises: detecting if a person who is lying on a flexible support structure is lying on their right side or on their left side at a first point in time; lifting up the right and left edges of the flexible support structure; wherein these edges are located to the right and to the left of the person's body, respectively; wherein during lifting the right edge of the flexible support structure is raised a first distance and the left edge of the flexible support structure is raised a second distance; wherein the first distance is greater than the second distance if the person was lying on their right side at the first time; wherein the first distance is less than the second distance if the person was lying on their left side at the first time; and wherein lifting causes the flexible support structure to be at least partially wrapped or enfolded around a portion of the person's torso; moving the flexible support structure to the right if the person was lying on their right side at the first point in time or moving the flexible support structure to the to the left if the person was lying on their left side at the first point in time; and lowering the previously-identified right and left edges of the flexible support structure; wherein during lowering the right edge of the flexible support structure is raised a third distance and the left edge of the flexible support structure is raised a fourth distance; wherein the third distance is less than the fourth distance if the person was lying on their right side at the first time and the third distance is greater than the fourth distance if the person was lying on their left side at the first time; wherein lowering unwraps or unfolds the flexible support structure from being around a portion of the person's torso; and wherein, after lowering, the person is now lying on their left side if they were originally lying on their right side at the first point in time or the person is now lying on their right side if they were originally lying on their left side at the first point in time.

Alternatively, a method to help a person in bed to avoid decubitus ulcers comprises: detecting if a person who is lying on a flexible support structure is lying on their right side or on their left side at a first point in time; lifting up the right and left edges of the flexible support structure; wherein these edges are located to the right and to the left of the person's body, respectively; wherein during lifting the right edge of the flexible support structure is raised a first distance and the left edge of the flexible support structure is raised a second distance; wherein the first distance is greater than the second distance if the person was lying on their right side at the first time; wherein the first distance is less than the second distance if the person was lying on their left side at the first time; and wherein lifting causes the flexible support structure to be at least partially wrapped or enfolded around a portion of the person's torso; moving the flexible support structure to the right if the person was lying on their right side at the first point in time or moving the flexible support structure to the to the left if the person was lying on their left side at the first point in time; and lowering the previously-identified right and left edges of the flexible support structure; wherein during lowering the right edge of the flexible support structure is raised a third distance and the left edge of the flexible support structure is raised a fourth distance; wherein the third distance is greater than the fourth distance if the person was lying on their right side at the first time and the third distance is less than the fourth distance if the person was lying on their left side at the first time; wherein lowering unwraps or unfolds the flexible support structure from being around a portion of the person's torso; and wherein, after lowering, the person is now lying on their left side if they were originally lying on their right side at the first point in time or the person is now lying on their right side if they were originally lying on their left side at the first point in time.

In another example, a method to help prevent decubitus ulcers comprises: detecting if a person who is lying on a flexible support structure (e.g., a net, mesh, hammock, sling, sheet, blanket, mattress pad, folding mattress, articulating mattress, or shape-changing mattress) is lying on their right side or on their left side at a first point in time; lifting up the right and left sides of the flexible support structure on either side of the person's body; moving the flexible support structure to the right if the person was lying on their right side at the first point in time or to the left if the person was lying on their left side at the first point in time; rotating and/or tilting the flexible support structure around a longitudinal axis; lowering the right and left sides of the flexible support structure on either side of the person's body, so that the person is then lying on their side opposite to the side on which they were lying at the first point in time. Alternatively, a method to help a person in bed to avoid decubitus ulcers comprises: analyzing images from a camera to detect that a person's body is in a configuration in which the person is ready to be turned from lying on their first (e.g., right or left) side to lying on their second (e.g., left or right) side, wherein in this configuration the person is lying on their side with their arms crossed and/or folder over their torso; receiving a voice command (and/or voice response) from the person which confirms that the person is ready and willing to be turned from lying on their first side to lying on their second side; and sequentially inflating and deflating a cushion (or pillow or compartment) located to the right of the person and a cushion (or pillow or compartment) located to the left of the person, wherein this inflation and deflation tilts and/or rotates the person (around a longitudinal axis) so that the person is turned from lying on their first side to lying on their second side.

In one example, a method to help a person in bed to avoid decubitus ulcers comprises: analyzing images from a plurality of electromagnetic energy sensors to detect that a person who is lying on a mattress has their body in a configuration which is ready to be turned from lying on their first (e.g., right or left) side to lying on their second (e.g., left or right) side, wherein in this configuration the person is lying on their side with their arms crossed and/or folder over their torso; receiving a voice command (and/or voice response) from the person which confirms that the person is ready and willing to be turned from lying on their first side to lying on their second side; and using a plurality of actuators to tilt and/or rotate the mattress in order to turn the person from lying on their first side to lying on their second side. Alternatively, a method to help a person in bed to avoid decubitus ulcers comprises: analyzing images from a plurality of pressure sensors (e.g., on a mattress or in a garment) to detect that a person's body is in a configuration in which the person is ready to be turned from lying on their first (e.g., right or left) side to lying on their second (e.g., left or right) side, wherein in this configuration the person is lying on their side with their arms crossed and/or folder over their torso; receiving a voice command (and/or voice response) from the person which confirms that the person is ready and willing to be turned from lying on their first side to lying on their second side; and sequentially inflating and deflating a cushion (or pillow or compartment) located to the right of the person and a cushion (or pillow or compartment) located to the left of the person, wherein this inflation and deflation tilts and/or rotates the person (around a longitudinal axis) so that the person is turned from lying on their first side to lying on their second side.

In another example, a method to help prevent decubitus ulcers comprises: analyzing images from a plurality of pressure sensors to detect that a person who is lying on a mattress has their body in a configuration which is ready to be turned from lying on their first (e.g., right or left) side to lying on their second (e.g., left or right) side, wherein in this configuration the person is lying on their side with their arms crossed and/or folder over their torso; receiving a voice command (and/or voice response) from the person which confirms that the person is ready and willing to be turned from lying on their first side to lying on their second side; and using a plurality of actuators to tilt and/or rotate the mattress in order to turn the person from lying on their first side to lying on their second side. Alternatively, a method to help a person in bed to avoid decubitus ulcers comprises: analyzing images from one or more electromagnetic energy sensors (e.g., on a mattress or in a garment) to detect that a person's body is in a configuration in which the person is ready to be turned from lying on their first (e.g., right or left) side to lying on their second (e.g., left or right) side, wherein in this configuration the person is lying on their side with their arms crossed and/or folder over their torso; receiving a voice command (and/or voice response) from the person which confirms that the person is ready and willing to be turned from lying on their first side to lying on their second side; and sequentially inflating and deflating a cushion (or pillow or compartment) located to the right of the person and a cushion (or pillow or compartment) located to the left of the person, wherein this inflation and deflation tilts and/or rotates the person (around a longitudinal axis) so that the person is turned from lying on their first side to lying on their second side.

For example, a method to help prevent decubitus ulcers comprises: analyzing images from one or more motion sensors to detect that a person's body is in a configuration in which the person is ready to be turned from lying on their first (e.g., right or left) side to lying on their second (e.g., left or right) side, wherein in this configuration the person is lying on their side with their arms crossed and/or folder over their torso; receiving a voice command (and/or voice response) from the person which confirms that the person is ready and willing to be turned from lying on their first side to lying on their second side; and sequentially inflating and deflating a cushion (or pillow or compartment) located to the right of the person and a cushion (or pillow or compartment) located to the left of the person, wherein this inflation and deflation tilts and/or rotates the person (around a longitudinal axis) so that the person is turned from lying on their first side to lying on their second side. Alternatively, a method to help a person in bed to avoid decubitus ulcers comprises: analyzing images from one or more stretch sensors (e.g., in a garment) to detect that a person's body is in a configuration in which the person is ready to be turned from lying on their first (e.g., right or left) side to lying on their second (e.g., left or right) side, wherein in this configuration the person is lying on their side with their arms crossed and/or folder over their torso; receiving a voice command (and/or voice response) from the person which confirms that the person is ready and willing to be turned from lying on their first side to lying on their second side; and sequentially inflating and deflating a cushion (or pillow or compartment) located to the right of the person and a cushion (or pillow or compartment) located to the left of the person, wherein this inflation and deflation tilts and/or rotates the person (around a longitudinal axis) so that the person is turned from lying on their first side to lying on their second side.

In another embodiment, a device to help a person in bed to avoid decubitus ulcers comprises: a flexible support structure (such as a net, mesh, hammock, sling, sheet, blanket, mattress pad, folding mattress, articulating mattress, or shape-changing mattress) with a longitudinal axis; wherein a person lies on the flexible support structure on their right side or on their left side at a first point in time; and a plurality of electromagnetic, pneumatic, or hydraulic actuators which raise and lower a right edge and a left edge of the flexible support structure; wherein the plurality of actuators periodically move the right edge and the left edge of the flexible support structure in the following sequence—raising the right edge and the left edge of the flexible support structure, thereby at least partially wrapping or enfolding the flexible support structure around at least a portion of the person's torso; moving the flexible support structure to the right if the person was lying on their right side at the first point in time or moving the flexible support structure to the left if the person was lying on their left side at the first point in time; tilting and/or rotating the flexible support structure around its longitudinal axis; and then lowering the right edge and the left edge of the flexible support structure, thereby unwrapping the flexible support structure from being around a portion of the person's torso. Alternatively, a device to help a person in bed to avoid decubitus ulcers comprises: a bed mattress on which a person lies; wherein bed mattress has a shape which is selected from the group consisting of—parabola, arc of a circle, arc of an ellipse, conic section, catenary, and concave; an actuator which rotates and/or tilts the bed mattress around a longitudinal axis; wherein rotation and/or tilting of the bed mattress helps the person to turn from lying on their first (e.g., right) side to lying on their second (e.g., left) side; a right side cushion (or pillow or chamber) on the right side of the bed mattress; and a left side cushion (or pillow or chamber) on the left side of the bed mattress; wherein the right side cushion and/or the left side cushion is changed from a less-inflated configuration or more-inflated configuration; and wherein the right side cushion is in its more-inflated configuration for a longer period of time than the left side cushion when the mattress is rotated and/or tilted in a clockwise direction; and wherein the left side cushion is in its more-inflated configuration for a longer period of time than the right side cushion when the mattress is rotated and/or tilted in a counter-clockwise direction.

In another example, a device to help a person in bed to avoid decubitus ulcers comprises: an article of clothing which is worn by a person lying in a bed; wherein the article of clothing further comprises pressure sensors on selected areas of the article of clothing; and wherein the article of clothing further comprises a plurality of inflatable nets or meshes on different areas (or portions) of the article of clothing, wherein there is air flow through holes in the nets or meshes, and wherein an inflatable net or mesh on a selected area is inflated based on data from one or more pressure sensors on the selected area. Alternatively, a device which helps a person in bed avoid decubitus ulcers comprises: a longitudinal mattress on which a sleeping person lies; wherein the mattress further comprises a plurality of movable longitudinal sections which collectively span a cross-section of the mattress; and a plurality of actuators, wherein the actuators change the angles between the movable longitudinal sections by rotating and/or tilting one or more of the movable longitudinal sections around one or more longitudinal axes, wherein the actuators change the angles between the movable longitudinal sections in a side-to-side sequence, and wherein sequential changes in the angles between the movable longitudinal sections help the person to move from lying on their first (e.g., right) side to lying on their second (e.g., left) side.

A device to help a person in bed to avoid decubitus ulcers comprises: a longitudinal mattress on which a sleeping person lies; wherein the mattress further comprises a plurality of movable longitudinal sections which collectively span a cross-section of the mattress; and a plurality of actuators, wherein the actuators change the angles between the movable longitudinal sections by rotating and/or tilting one or more of the movable longitudinal sections around one or more longitudinal axes, wherein the actuators change the angles between the movable longitudinal sections in a side-to-side wave sequence; wherein sequential changes in the angles between the movable longitudinal sections help the person to move from lying on their first (e.g., right) side to lying on their second (e.g., left) side. Alternatively, a device which helps a person in bed to avoid decubitus ulcers comprises: a longitudinal mattress on which a sleeping person lies; wherein the mattress further comprises a plurality of movable longitudinal sections which collectively span a cross-section of the mattress; and a plurality of actuators, wherein the actuators change the angles between the movable longitudinal sections by rotating and/or tilting one or more of the movable longitudinal sections around one or more longitudinal axes, creating an side-to-side undulating pattern; wherein the undulating side-to-side pattern helps the person to move from lying on their first (e.g., right) side to lying on their second (e.g., left) side.

In another example, a device to help a person in bed to avoid decubitus ulcers comprises: a support structure on which a person lies; wherein the support structure further comprises a plurality of adjustable portions (e.g., cells, columns, bladders, or compartments) whose sizes and/or shapes are able to be individually adjusted; wherein the support structure further comprises a plurality of electromagnetic energy sensors which detect which adjustable portions are below (a selected part of) the person's body at a given time; and wherein the sizes and/or shapes of adjustable portions which are below (a selected part of) the person's body at a given time are adjusted relative to the sizes and/or shapes of the rest of the adjustable portions. Alternatively, a device which helps to prevent decubitus ulcers comprises: a support structure on which a person lies; wherein the support structure further comprises a plurality of adjustable portions (e.g., cells, columns, bladders, or compartments) whose sizes and/or shapes are able to be individually adjusted; wherein the support structure further comprises a plurality of pressure sensors which detect which adjustable portions are below (a selected part of) the person's body at a given time; and wherein the sizes and/or shapes of adjustable portions which are below (a selected part of) the person's body at a given time are adjusted relative to the sizes and/or shapes of the rest of the adjustable portions.

In one example, a device to help a person in bed to avoid decubitus ulcers comprises: a flexible support structure on which a sleeping person lies, wherein the support structure has a longitudinal axis; wherein the support structure has a first configuration in which it is substantially laterally flat and a second configuration in which it is partially laterally folded (along a longitudinal axis) around the person's body; a plurality of actuators which change the support structure from its first configuration to its second configuration, or vice versa; wherein a person is moved from lying on their first (e.g., right) side to lying on their second (e.g., left) side by: (a) activating actuators to change the support structure from its first configuration to its second configuration as the person is lying on their first side, enfolding the person in the support structure; (b) activating actuators to slowly rotate and/or tilt the support structure relative to a longitudinal axis, thereby also slowly rotating and/or tilting the person within the support structure; and (c) activating the actuators to change the support structure from its second configuration to its first configuration, thereby unfolding the support structure and releasing the person lying on their second side. Alternatively, a device to help a person in bed to avoid decubitus ulcers comprises: a flexible support structure on which a sleeping person lies, wherein the support structure has a longitudinal axis; wherein the support structure has a first configuration in which it is substantially laterally flat and a second configuration in which it is partially laterally folded (along a longitudinal axis) around the person's body; a voice command interface; a plurality of actuators which change the support structure from its first configuration to its second configuration, or vice versa; wherein a person is moved from lying on their first (e.g., right) side to lying on their second (e.g., left) side when the person requests such a move via the voice command interface; wherein a person is moved from lying on their first (e.g., right) side to lying on their second (e.g., left) side by: (a) activating actuators to change the support structure from its first configuration to its second configuration as the person is lying on their first side; (b) activating actuators to slowly rotate and/or tilt the support structure relative to a longitudinal axis, thereby slowly rotating and/or tilting the person enfolded within the support structure; and (c) activating the actuators to change the support structure from its second configuration to its first configuration, resulting in the person is lying on their second side.

For example, a device to help a person in bed to avoid decubitus ulcers comprises: a bed mattress on which a person lies; wherein the upper surface of a cross-section of the bed mattress has a shape which is selected from the group consisting of—parabola, arc of a circle, arc of an ellipse, conic section, catenary, and concave; an actuator which rotates and/or tilts the bed mattress around a longitudinal (head-to-toe) axis; wherein rotation and/or tilting of the bed mattress helps the person to turn from lying on their first (e.g., right) side to lying on their second (e.g., left) side; a right side cushion (or pillow or chamber) on the right side of the bed mattress; and a left side cushion (or pillow or chamber) on the left side of the bed mattress; wherein the inflation levels of the right side cushion and/or the left side cushion are automatically changed over time; wherein the right side cushion is more inflated than the left side cushion when the mattress is rotated and/or tilted in a first direction; and wherein the left side cushion is more inflated than the right side cushion when the mattress is rotated and/or tilted in a second direction. Alternatively, a device which helps a person to avoid decubitus ulcers comprises: a bed mattress on which a person lies; wherein the upper surface of a cross-section of the bed mattress has a shape which is selected from the group consisting of—parabola, arc of a circle, arc of an ellipse, conic section, catenary, and concave; an actuator which rotates and/or tilts the bed mattress around a longitudinal (head-to-toe) axis; wherein rotation and/or tilting of the bed mattress helps the person to turn from lying on their first (e.g., right) side to lying on their second (e.g., left) side; a right side cushion on the right side of the bed mattress; and a left side cushion on the left side of the bed mattress; wherein the inflation levels of the right side cushion and/or the left side cushion are automatically changed over time; wherein the right side cushion is more inflated than the left side cushion when the mattress is rotated and/or tilted in a counter-clockwise manner; and wherein the left side cushion is more inflated than the right side cushion when the mattress is rotated and/or tilted in a clockwise manner.

In another example, a device to help a person in bed to avoid decubitus ulcers comprises: a bed mattress on which a person lies; wherein the upper surface of a cross-section of the bed mattress has a shape which is selected from the group consisting of—parabola, arc of a circle, arc of an ellipse, conic section, catenary, and concave; an actuator which rotates and/or tilts the bed mattress around a longitudinal (head-to-toe) axis; wherein rotation and/or tilting of the bed mattress helps the person to turn from lying on their first (e.g., right) side to lying on their second (e.g., left) side; a right-side cushion (or pillow) on the right side of the bed mattress; and a left-side cushion (or pillow) on the left side of the bed mattress; wherein the right-side cushion and/or the left side cushion is changed from a less-inflated configuration to a more-inflated configuration; and wherein the right-side cushion is in its more-inflated configuration when the mattress is rotated and/or tilted to the right; and wherein the left-side cushion is in its more-inflated configuration when the mattress is rotated and/or tilted to the left. Alternatively, a device which helps to prevent decubitus ulcers comprises: a support structure (such as a mattress) on which a person lies, wherein the support structure further comprises a plurality of height-adjustable solenoids whose heights are able to be individually adjusted; a camera which records images which are analyzed to determine the location of a selected part of the person's body on the support structure at a selected time; wherein the heights of the solenoids which are below the selected part of the person's body at the selected time are set lower than the heights of the rest of the solenoids.

In another embodiment, a device to help a person in bed to avoid decubitus ulcers comprises: a support structure (such as a mattress) on which a person lies, wherein the support structure further comprises a plurality of inflated portions (e.g., cells, compartments, bladders, or columns) whose inflation levels are able to be individually adjusted; a camera which records images which are analyzed to identify the areas where the person's body rests on the support structure at a selected time; wherein the inflated portions which are below the identified areas at the selected time are inflated less than the rest of the inflated portions. Alternatively, a device which helps a person in bed avoid decubitus ulcers comprises: a flexible support structure (e.g., net, mesh, hammock, sling, sheet, or blanket) on which a person lies; a first arch which curves over the width of the support structure, wherein the first arch is less than two feet away from the head of the support structure, wherein two sides or edges of the support structure are connected to the first arch; a second arch which curves over the width of the support structure, wherein the second arch is less than two feet away from the foot of the support structure, wherein two other sides or edges of the support structure are connected to the second arch, and wherein the support structure is suspended between the first arch and the second arch; and a plurality of actuators which move the connections between the support structure and the arches, thereby changing the slope and/or shape of the support structure and helping the person to turn from lying on their first (e.g., right) side to lying on their second (e.g., left) side.

In another example, a device to help a person in bed to avoid decubitus ulcers comprises: a longitudinal flexible support structure on which a person lies, wherein the support structure further comprises a head portion which is closer to the person's head and a foot portion which is closer to the person's foot; a first arcuate beam which arcs over the width of the support structure, wherein corners (or edges or sides) of the head portion of the support structure are connected to the first arcuate beam at a plurality of connections; a second arcuate beam which arcs over the width of the support structure, wherein corners (or edges or sides) of the foot portion of the support structure are connected to the second arcuate beam at a plurality of connections; and a plurality of actuators which move the connections on the first arcuate beam and the connections on the second arcuate beam; wherein the plurality of actuators move the connections in the following sequence—firstly, the actuators move the connections on the first arcuate beam closer together and the connections on the second arcuate beam closer together, thereby gently folding the support structure around the person's body as the person lies on their first (e.g., right or left) side; secondly, the actuators jointly move the connections on the first arcuate beam along the first arcuate beam and jointly move the connections on the second arcuate beam along the second arcuate beam, thereby rotating and/or tilting the upper portion of the person's body toward their second (e.g., left or right) side; and thirdly, the actuators move the connections on the first arcuate beam farther apart and move the connections on the second arcuate beam farther apart, thereby gently unfolding the support structure from the person's body and leaving the person lying on their second side.

Alternatively, a device to help a person in bed to avoid decubitus ulcers comprises: a longitudinal flexible support structure on which a person lies, wherein the support structure further comprises a head portion which is closer to the person's head and a foot portion which is closer to the person's foot; a first arcuate beam which curves over the width of the support structure, wherein corners (or edges) of the head portion of the support structure are connected to the first beam at a plurality of connections; a second arcuate beam which curves over the width of the support structure, wherein corners (or edges) of the foot portion of the support structure are connected to the second arcuate beam at a plurality of connections; wherein the support structure is suspended between the first arcuate beam and the second arcuate beam; and a plurality of actuators which move the connections on the first arcuate beam and the connections on the second arcuate beam; wherein the plurality of actuators move the connections in the following sequence—firstly, the actuators move the connections on the first arcuate beam closer together and the connections on the second arcuate beam closer together, thereby gently folding the support structure around the person's body as the person is lying on their first side; secondly, the actuators jointly move the connections on the first arcuate beam along the first arcuate beam and jointly move the connections on the second arcuate beam along the second arcuate beam, thereby rotating and/or tilting the person's body; and thirdly, the actuators move the connections on the first arcuate beam farther apart and move the connections on the second arcuate beam farther apart, thereby gently unfolding the support structure from the person's body and leaving the person lying on their second side.

In one example, a device to help a person in bed to avoid decubitus ulcers comprises: a concave flexible support structure (e.g., net, mesh, hammock, sling, sheet, or blanket) on which a person lies; a first arcuate beam which spans (in an arc) over and across the width of the support structure, wherein two corners or edges of the support structure are connected to the first arcuate beam; a second arcuate beam which spans (in an arc) over and across the width of the support structure, wherein the first arcuate beam is closer to the head of the support structure than the second arcuate beam, wherein two other corners or edges of the support structure are connected to the second arcuate beam, and wherein the support structure is suspended between the first arcuate beam and the second arcuate beam; and a plurality of actuators which move the connections between the support structure and the arcuate beams, thereby changing the slope and/or shape of the support structure suspended between the first and second arcuate beams, thereby helping the person to turn from lying on their first (e.g., right) side to lying on their second (e.g., left) side. Alternatively, a device which helps to prevent decubitus ulcers comprises: a longitudinal flexible support structure on which a person lies, wherein the support structure further comprises a head portion which is closer to the person's head and a foot portion which is closer to the person's foot; a first arcuate rib which curves over the width of the support structure, wherein two corners (or sides) of the head portion of the support structure are connected to the first rib at two connections; a second arcuate rib which curves over the width of the support structure, wherein two corners (or sides) of the foot portion of the support structure are connected to the second arcuate rib at two connections; and a plurality of actuators which move the connections on the first arcuate rib and the connections on the second arcuate rib; wherein the plurality of actuators move the connections in the following sequence—firstly, the actuators move the connections on the first arcuate rib closer together and the connections on the second arcuate rib closer together, thereby gently enfolding the support structure around the person's body as the person lies on their first (e.g., right) side; secondly, the actuators jointly move the connections on the first arcuate rib along the first arcuate rib and jointly move the connections on the second arcuate rib along the second arcuate rib, thereby rotating and/or tilting the person's body; and thirdly, the actuators move the connections on the first arcuate rib farther apart and move the connections on the second arcuate rib farther apart, thereby gently unfolding the support structure from the person's body and leaving the person lying on their second (e.g., left) side.

A device to help a person in bed to avoid decubitus ulcers comprises: a bed mattress on which a person lies; a first inflatable compartment (or cushion) with an inflation level which varies over time on a first (right or left) side of the mattress; a second inflatable compartment (or cushion) with an inflation level which varies over time on a second (left or right) side of the mattress; wherein the first and second inflatable compartments are both inflated during a first time period, but the first compartment is inflated more than the second compartment; wherein the first and second inflatable compartments are both deflated during a second time period, but the first compartment is deflated more than the second compartment; and wherein the person is moved from lying on their first (e.g., right) side to lying on their second (e.g., left) side during the first and second time periods by sequential inflation and deflation of the first and second inflatable compartments.

Alternatively, a device which helps a person in bed to avoid decubitus ulcers comprises: an article of clothing which is worn by a person lying in a bed; a first set of one or more pressure sensors integrated into a first portion of the article of clothing; a second set of one or more pressure sensors integrated into a second portion of the article of clothing; a first porous but inflatable net or mesh integrated into the first portion of the article of clothing; a second porous but inflatable net or mesh integrated into the second portion of the article of clothing; wherein the first net or mesh is inflated based on pressure level and/or duration measured by the first set of one or more pressure sensors; and wherein the second net or mesh is inflated based on pressure level and/or duration measured by the second set of one or more pressure sensors.

In another example, a device to help a person in bed to avoid decubitus ulcers comprises: an article of clothing which is worn by a person lying in a bed; a first set of one or more pressure sensors integrated into a first portion of the article of clothing; a second set of one or more pressure sensors integrated into a second portion of the article of clothing; a first concentric array of inflatable micro-bladders integrated into the first portion of the article of clothing; a second concentric array of inflatable micro-bladders integrated into the second portion of the article of clothing; wherein the first net or mesh is inflated based on pressure level and/or duration measured by the first set of one or more pressure sensors; and wherein the second net or mesh is inflated based on pressure level and/or duration measured by the second set of one or more pressure sensors. Alternatively, a device which helps a person in bed to avoid decubitus ulcers comprises: an article of clothing which is worn by a person lying in a bed; a first set of one or more pressure sensors integrated into a first portion of the article of clothing; a second set of one or more pressure sensors integrated into a second portion of the article of clothing; a first radial array of inflatable micro-bladders integrated into the first portion of the article of clothing; a second radial array of inflatable micro-bladders integrated into the second portion of the article of clothing; wherein the first net or mesh is inflated based on pressure level and/or duration measured by the first set of one or more pressure sensors; and wherein the second net or mesh is inflated based on pressure level and/or duration measured by the second set of one or more pressure sensors.

For example, a device to help a person in bed to avoid decubitus ulcers comprises: an article of clothing which is worn by a person lying in a bed; a first set of one or more pressure sensors integrated into a first portion of the article of clothing; a second set of one or more pressure sensors integrated into a second portion of the article of clothing; a first porous grid of inflatable micro-chambers integrated into the first portion of the article of clothing; a second porous grid of inflatable micro-chambers integrated into the second portion of the article of clothing; wherein the first net or mesh is inflated based on pressure level and/or duration measured by the first set of one or more pressure sensors; and wherein the second net or mesh is inflated based on pressure level and/or duration measured by the second set of one or more pressure sensors. Alternatively, a device to help a person in bed to avoid decubitus ulcers comprises: an article of clothing which is worn by a person lying in a bed; a first set of one or more pressure sensors on a first portion (or section) of the article of clothing; a second set of one or more pressure sensors on a second portion (or section) of the article of clothing; a first porous array of inflatable micro-bladders on the first portion or section of the article of clothing; a second porous array of inflatable micro-bladders on the second portion or section of the article of clothing; wherein the first net or mesh is inflated based on pressure level and/or duration measured by the first set of one or more pressure sensors; and wherein the second net or mesh is inflated based on pressure level and/or duration measured by the second set of one or more pressure sensors.

In another example, a device to help a person in bed to avoid decubitus ulcers comprises: an article of clothing which is worn by a person lying in a bed; a first set of one or more pressure sensors on a first portion or section of the article of clothing; a second set of one or more pressure sensors on a second portion or section of the article of clothing; a first porous but inflatable net or mesh on the first portion or section of the article of clothing; a second porous but inflatable net or mesh on the second portion or section of the article of clothing; wherein the first net or mesh is inflated based on pressure level and/or duration measured by the first set of one or more pressure sensors; and wherein the second net or mesh is inflated based on pressure level and/or duration measured by the second set of one or more pressure sensors. Alternatively, a device which helps a person in bed avoid decubitus ulcers comprises: an article of clothing which is worn by a person lying in a bed; a first set of one or more pressure sensors on a first portion or section of the article of clothing; a second set of one or more pressure sensors on a second portion or section of the article of clothing; a first nested array of inflatable micro-bladders on the first portion or section of the article of clothing; a second nested array of inflatable micro-bladders on the second portion or section of the article of clothing; wherein the first net or mesh is inflated based on pressure level and/or duration measured by the first set of one or more pressure sensors; and wherein the second net or mesh is inflated based on pressure level and/or duration measured by the second set of one or more pressure sensors.

In another embodiment, a device to help a person in bed to avoid decubitus ulcers comprises: an article of clothing which is worn by a person lying in a bed; a first set of one or more pressure sensors on a first portion or section of the article of clothing; a second set of one or more pressure sensors on a second portion or section of the article of clothing; a first porous grid of inflatable micro-bladders on the first portion or section of the article of clothing; a second porous grid of inflatable micro-bladders on the second portion or section of the article of clothing; wherein the first net or mesh is inflated based on pressure level and/or duration measured by the first set of one or more pressure sensors; and wherein the second net or mesh is inflated based on pressure level and/or duration measured by the second set of one or more pressure sensors. Alternatively, a device which helps to prevent decubitus ulcers comprises: an article of clothing which is worn by a person lying in a bed; a first set of one or more pressure sensors on a first portion or section of the article of clothing; a second set of one or more pressure sensors on a second portion or section of the article of clothing; a first porous grid of inflatable micro-bubbles on the first portion or section of the article of clothing; a second porous grid of inflatable micro-bubbles on the second portion or section of the article of clothing; wherein the first net or mesh is inflated based on pressure level and/or duration measured by the first set of one or more pressure sensors; and wherein the second net or mesh is inflated based on pressure level and/or duration measured by the second set of one or more pressure sensors.

In one example, a device to help a person in bed to avoid decubitus ulcers comprises: an article of clothing which is worn by a person lying in a bed; a first set of one or more pressure sensors which is attached to a first area of the article of clothing; a second set of one or more pressure sensors which is attached to a second area of the article of clothing; a first porous but inflatable net or mesh which is attached to the first area of the article of clothing; a second porous but inflatable net or mesh which is attached to the second area of the article of clothing; wherein the first net or mesh is inflated based on prolonged high pressure levels measured by the first set of one or more pressure sensors; and wherein the second net or mesh is inflated based on prolonged pressure levels measured by the second set of one or more pressure sensors.

Alternatively, a device which helps a person in bed to avoid decubitus ulcers comprises: an article of clothing which is worn by a person lying in a bed; a first set of one or more pressure sensors which is woven into a first area of the article of clothing; a second set of one or more pressure sensors which is woven into a second area of the article of clothing; a first porous but inflatable net or mesh which is woven into the first area of the article of clothing; a second porous but inflatable net or mesh which is woven into the second area of the article of clothing; wherein the first net or mesh is inflated based on data from the first set of one or more pressure sensors; and wherein the second net or mesh is inflated based on data from the second set of one or more pressure sensors.

In another example, a device to help a person in bed to avoid decubitus ulcers comprises: a flexible and breathable (e.g., porous to gas and liquid) upper support surface (e.g., sheet, pad, blanket, net, or mesh) on which a sleeping person lies; a flexible and breathable (e.g., porous to gas and liquid) middle support surface (e.g., sheet, pad, blanket, net, or mesh) below the upper support surface, wherein the middle support surface is automatically moved along a first (e.g., longitudinal or lateral) axis by one or more actuators, wherein the middle support surface has a first surface portion with a first elasticity level and a second surface portion with a second elasticity level, wherein the second elasticity level is greater than the first elasticity level, and wherein the second surface portion is smaller than (and nested within) the first surface portion; and a flexible and breathable (e.g., porous to gas and liquid) lower support surface (e.g., sheet, pad, blanket, net, or mesh) below the middle support surface, wherein the lower support surface is automatically moved along a second axis by one or more actuators, wherein the second axis is perpendicular to the first axis, wherein the middle support surface has a third surface portion with a third elasticity level and a fourth surface portion with a fourth elasticity level, wherein the fourth elasticity level is greater than the third elasticity level, wherein the fourth surface portion is smaller than (and nested within) the third surface portion, and wherein middle support surface and the lower support surface are moved so as to overlap the second surface portion and the fourth surface portion, thereby creating a localized surface portion with greater elasticity below a selected part of the sleeping person's body that has a pressure ulcer and/or is particularly vulnerable to developing a pressure ulcer.

Alternatively, a device to help a person in bed to avoid decubitus ulcers comprises: a flexible and breathable (e.g., porous to gas and liquid) upper support surface (e.g., sheet, pad, blanket, net, or mesh) on which a sleeping person lies; a flexible and breathable (e.g., porous to gas and liquid) middle support surface (e.g., sheet, pad, blanket, net, or mesh) below the upper support surface, wherein the middle support surface is automatically moved along a first (e.g., longitudinal or lateral) axis by one or more actuators, wherein the middle support surface has a first surface portion with a first durometer level and a second surface portion with a second durometer level, wherein the second durometer level is lower than the first durometer level, and wherein the second surface portion is smaller than (and nested within) the first surface portion; and a flexible and breathable (e.g., porous to gas and liquid) lower support surface (e.g., sheet, pad, blanket, net, or mesh) below the middle support surface, wherein the lower support surface is automatically moved along a second axis by one or more actuators, wherein the second axis is perpendicular to the first axis, wherein the middle support surface has a third surface portion with a third durometer level and a fourth surface portion with a fourth durometer level, wherein the fourth durometer level is lower than the third durometer level, wherein the fourth surface portion is smaller than (and nested within) the third surface portion, and wherein middle support surface and the lower support surface are moved so as to overlap the second surface portion and the fourth surface portion, thereby creating a localized surface portion with lower durometer below a selected part of the sleeping person's body that has a pressure ulcer and/or is particularly vulnerable to developing a pressure ulcer.

In one example, a device to help a person in bed to avoid decubitus ulcers comprises: a flexible and breathable (e.g., porous to gas and liquid) upper support surface (e.g., sheet, pad, blanket, net, or mesh) on which a sleeping person lies; a flexible and breathable (e.g., porous to gas and liquid) middle support surface (e.g., sheet, pad, blanket, net, or mesh) below the upper support surface, wherein the middle support surface is automatically moved along a first (e.g., longitudinal or lateral) axis by one or more actuators, wherein the middle support surface has a first surface portion with a first stretchability level and a second surface portion with a second stretchability level, wherein the second stretchability level is greater than the first stretchability level, and wherein the second surface portion is smaller than (and nested within) the first surface portion; and a flexible and breathable (e.g., porous to gas and liquid) lower support surface (e.g., sheet, pad, blanket, net, or mesh) below the middle support surface, wherein the lower support surface is automatically moved along a second axis by one or more actuators, wherein the second axis is perpendicular to the first axis, wherein the middle support surface has a third surface portion with a third stretchability level and a fourth surface portion with a fourth stretchability level, wherein the fourth stretchability level is greater than the third stretchability level, wherein the fourth surface portion is smaller than (and nested within) the third surface portion, and wherein middle support surface and the lower support surface are moved so as to overlap the second surface portion and the fourth surface portion, thereby creating a localized surface portion with greater stretchability below a selected part of the sleeping person's body that has a pressure ulcer and/or is particularly vulnerable to developing a pressure ulcer.

Alternatively, a device which helps to prevent decubitus ulcers comprises: a flexible and breathable (e.g., porous to gas and liquid) upper support surface (e.g., sheet, pad, blanket, net, or mesh) on which a sleeping person lies; a flexible and breathable (e.g., porous to gas and liquid) middle support surface (e.g., sheet, pad, blanket, net, or mesh) below the upper support surface, wherein the middle support surface is automatically moved along a first (e.g., longitudinal or lateral) axis by one or more actuators, wherein the middle support surface has a first surface portion with a first flexibility level and a second surface portion with a second flexibility level, wherein the second flexibility level is greater than the first flexibility level, and wherein the second surface portion is smaller than (and nested within) the first surface portion; and a flexible and breathable (e.g., porous to gas and liquid) lower support surface (e.g., sheet, pad, blanket, net, or mesh) below the middle support surface, wherein the lower support surface is automatically moved along a second axis by one or more actuators, wherein the second axis is perpendicular to the first axis, wherein the middle support surface has a third surface portion with a third flexibility level and a fourth surface portion with a fourth flexibility level, wherein the fourth flexibility level is greater than the third flexibility level, wherein the fourth surface portion is smaller than (and nested within) the third surface portion, and wherein middle support surface and the lower support surface are moved so as to overlap the second surface portion and the fourth surface portion, thereby creating a localized surface portion with greater stretchability below a selected part of the sleeping person's body that has a pressure ulcer and/or is particularly vulnerable to developing a pressure ulcer.

In another example, a device to help a person in bed to avoid decubitus ulcers comprises: a flexible and breathable (e.g., porous to gas and liquid) upper support surface (e.g., sheet, pad, blanket, net, or mesh) on which a sleeping person lies; a flexible and breathable (e.g., porous to gas and liquid) middle support surface (e.g., sheet, pad, blanket, net, or mesh) below the upper support surface, wherein the middle support surface is automatically moved along a first (e.g., longitudinal or lateral) axis by one or more actuators, wherein the middle support surface has a first opening (or hole); and a flexible and breathable (e.g., porous to gas and liquid) lower support surface (e.g., sheet, pad, blanket, net, or mesh) below the middle support surface, wherein the lower support surface is automatically moved along a second axis by one or more actuators, wherein the second axis is perpendicular to the first axis, wherein the middle support surface has a second opening (or hole), and wherein middle support surface and the lower support surface are moved so as to overlap the first opening (or hole) and the second opening (or hole), thereby creating a localized opening (or hole) below a selected part of the sleeping person's body that has a pressure ulcer and/or is particularly vulnerable to developing a pressure ulcer.

Alternatively, a device which helps a person to avoid decubitus ulcers comprises: a flexible and breathable (e.g., porous to gas and liquid) upper support surface (e.g., sheet, pad, blanket, net, or mesh) on which a sleeping person lies; a flexible and breathable (e.g., porous to gas and liquid) middle support surface (e.g., sheet, pad, blanket, net, or mesh) below the upper support surface, wherein the middle support surface is suspended between first and second rollers; wherein the middle support surface is automatically moved between the first and second rollers by one or more actuators, wherein the middle support surface has a first surface portion with a first elasticity level and a second surface portion with a second elasticity level, wherein the second elasticity level is greater than the first elasticity level, and wherein the second surface portion is smaller than (and nested within) the first surface portion; and a flexible and breathable (e.g., porous to gas and liquid) lower support surface (e.g., sheet, pad, blanket, net, or mesh) below the middle support surface, wherein the lower support surface is suspended between third and fourth rollers; wherein the lower support surface is automatically moved between the third and fourth rollers, wherein the middle support surface has a third surface portion with a third elasticity level and a fourth surface portion with a fourth elasticity level, wherein the fourth elasticity level is greater than the third elasticity level, wherein the fourth surface portion is smaller than (and nested within) the third surface portion, and wherein middle support surface and the lower support surface are moved so as to overlap the second surface portion and the fourth surface portion, thereby creating a localized surface portion with greater elasticity below a selected part of the sleeping person's body that has a pressure ulcer and/or is particularly vulnerable to developing a pressure ulcer.

For example, a device to help a person in bed to avoid decubitus ulcers comprises: a flexible and breathable upper support surface on which a sleeping person lies; a flexible and breathable middle support surface below the upper support surface, wherein the middle support surface is automatically moved along a first axis by one or more actuators, wherein the middle support surface has a first surface portion with a first elasticity level and a second surface portion with a second elasticity level, wherein the second elasticity level is greater than the first elasticity level, and wherein the second surface portion is smaller than the first surface portion; and a flexible and breathable lower support surface below the middle support surface, wherein the lower support surface is automatically moved along a second axis by one or more actuators, wherein the second axis is perpendicular to the first axis, wherein the middle support surface has a third surface portion with a third elasticity level and a fourth surface portion with a fourth elasticity level, wherein the fourth elasticity level is greater than the third elasticity level, wherein the fourth surface portion is smaller than the third surface portion, and wherein middle support surface and the lower support surface are moved so as to overlap the second surface portion and the fourth surface portion, thereby creating a localized surface portion with greater elasticity below a selected part of the sleeping person's body that has a pressure ulcer and/or is particularly vulnerable to developing a pressure ulcer.

Alternatively, a device which helps to prevent decubitus ulcers comprises: a flexible upper support surface on which a sleeping person lies; a flexible middle support surface below the upper support surface, wherein the middle support surface is automatically moved by one or more actuators, wherein the middle support surface has a first surface portion with a first elasticity level and a second surface portion with a second elasticity level, wherein the second elasticity level is greater than the first elasticity level, and wherein the second surface portion is smaller than the first surface portion; and a flexible lower support surface below the middle support surface, wherein the lower support surface is automatically moved by one or more actuators, wherein the middle support surface has a third surface portion with a third elasticity level and a fourth surface portion with a fourth elasticity level, wherein the fourth elasticity level is greater than the third elasticity level, wherein the fourth surface portion is smaller than the third surface portion, and wherein middle support surface and the lower support surface are moved so as to overlap the second surface portion and the fourth surface portion, thereby creating a localized surface portion with greater elasticity below a selected part of the sleeping person's body that has a pressure ulcer and/or is particularly vulnerable to developing a pressure ulcer.

A device to help a person in bed to avoid decubitus ulcers comprises: a flexible support structure (such as a net, mesh, sling, hammock, pad, sheet, or blanket) on which a person lies; a laterally-moving loop of padding which is under the flexible support structure, wherein the loop comprises an upper portion which moves in a selected lateral direction (e.g., right-to-left or left-to-right) and a lower portion which moves in the opposite lateral direction (e.g., left-to-right or right-to-left); a plurality of actuators which lift the flexible support structure up off the loop of padding, move (and/or rotate) the loop of padding laterally, and then lower the flexible support structure back down onto the loop of padding; and a drying and/or cleaning mechanism which dries and/or cleans the loop of padding as it passes through the lower portion of the loop. Alternatively, a device to help a person in bed to avoid decubitus ulcers comprises: a flexible support structure (such as a net, mesh, sling, hammock, pad, sheet, or blanket) on which a person lies; a laterally-moving loop of padding which is under the flexible support structure, wherein the loop comprises an upper portion which moves in a selected lateral direction (e.g., right-to-left or left-to-right) and a lower portion which moves in the opposite lateral direction (e.g., left-to-right or right-to-left); a plurality of actuators which lift the flexible support structure up off the loop of padding, move (and/or rotate) the loop of padding laterally, and then lower the flexible support structure back down onto the loop of padding; and a fluffing mechanism which fluffs and/or expands the loop of padding as it passes through the lower portion of the loop.

In another example, a device to help a person in bed to avoid decubitus ulcers comprises: a flexible support structure (such as a net, mesh, sling, hammock, pad, sheet, or blanket) on which a person lies; a laterally-moving sinusoidal-surface loop of flexible material which is under the flexible support structure, wherein the loop comprises an upper portion which moves in a selected lateral direction (e.g., right-to-left or left-to-right) and a lower portion which moves in the opposite lateral direction (e.g., left-to-right or right-to-left); and a plurality of actuators which lift the flexible support structure up off the loop of flexible material, move (and/or rotate) the loop of flexible material laterally, and then lower the flexible support structure back down onto the loop of flexible material. Alternatively, a device which helps a person in bed avoid decubitus ulcers comprises: a flexible net, mesh, sling, hammock, pad, sheet, or blanket on which a person lies; a laterally-scrolling loop of padding which is under the upper support structure; and a plurality of actuators; and using at least one actuator to lift the flexible net, mesh, sling, hammock, pad, sheet, or blanket up off the lower support structure; (b) using at least one actuator to scroll the loop of padding laterally, thereby changing which portion of the loop of padding is directly underneath a selected location on the person's body; and then (c) using at least one actuator to lower the flexible net, mesh, sling, hammock, pad, sheet, or blanket back down onto the lower support structure.

In one example, a device to help a person in bed to avoid decubitus ulcers comprises: a flexible support structure (such as a net, mesh, sling, hammock, pad, sheet, or blanket) on which a person lies; a longitudinally-moving loop of padding which is under the flexible support structure, wherein the loop comprises an upper portion which moves in a selected longitudinal direction (e.g., head-to-toe) and a lower portion which moves in the opposite longitudinal direction (e.g., toe-to-head); a plurality of actuators which lift the flexible support structure up off the loop of padding, move (and/or rotate) the loop of padding longitudinally, and then lower the flexible support structure back down onto the loop of padding; and a drying and/or cleaning mechanism which dries and/or cleans the loop of padding as it passes through the lower portion of the loop. Alternatively, a device which helps a person in bed to avoid decubitus ulcers comprises: a flexible support structure (such as a net, mesh, sling, hammock, pad, sheet, or blanket) on which a person lies; a longitudinally-moving loop of padding which is under the flexible support structure, wherein the loop comprises an upper portion which moves in a selected longitudinal direction (e.g., head-to-toe or toe-to-head) and a lower portion which moves in the opposite longitudinal direction (e.g., toe-to-head or head-to-toe); a plurality of actuators which lift the flexible support structure up off the loop of padding, move (and/or rotate) the loop of padding longitudinally, and then lower the flexible support structure back down onto the loop of padding; and a fluffing mechanism which fluffs and/or expands the loop of padding as it passes through the lower portion of the loop.

In another example, a device to help a person in bed to avoid decubitus ulcers comprises: a flexible support structure (such as a net, mesh, sling, hammock, pad, sheet, or blanket) on which a person lies; a longitudinally-moving sinusoidal-surface loop of flexible material which is under the flexible support structure, wherein the loop comprises an upper portion which moves in a selected longitudinal direction (e.g., head-to-toe or toe-to-head) and a lower portion which moves in the opposite longitudinal direction (e.g., toe-to-head or head-to-toe); and a plurality of actuators which lift the flexible support structure up off the loop of flexible material, move (and/or rotate) the loop of flexible material longitudinally, and then lower the flexible support structure back down onto the loop of flexible material. Alternatively, a device which helps a person in bed to avoid decubitus ulcers comprises: a flexible support structure (such as a net, mesh, sling, hammock, pad, sheet, or blanket) on which a person lies; a longitudinally-moving undulating loop which is under the flexible support structure, wherein the loop comprises an upper portion which moves in a selected longitudinal direction (e.g., head-to-toe) and a lower portion which moves in the opposite longitudinal direction (e.g., toe-to-head); and a plurality of actuators which sequentially lift the flexible support structure up off the loop, move (and/or rotate) the loop longitudinally, and then lower the flexible support structure back down onto the loop.

In another embodiment, a device to help a person in bed to avoid decubitus ulcers comprises: a flexible support surface (such as a flexible net, mesh, sling, hammock, pad, sheet, or blanket) on which a person lies; a longitudinally-scrolling loop of padding (such as a loop of compressible foam or a loop of compressible textile padding) which is under the upper support structure; two rollers, one roller closer to the head of the support surface and one roller closer to the foot of the support surface, wherein the longitudinally-scrolling loop of padding loops around the two rollers and scrolls longitudinally between the two rollers; and a plurality of actuators; and using at least one actuator to lift the flexible support surface up off the loop of padding; (b) using at least one actuator to scroll the loop of padding longitudinally, thereby changing which portion of the loop of padding is directly underneath a selected location on the person's body; and then (c) using at least one actuator to lower the flexible support surface back down onto the loop of padding.

Alternatively, a device to help a person in bed to avoid decubitus ulcers comprises: a flexible support structure (such as a net, mesh, sling, hammock, pad, sheet, or blanket) on which a person lies; a loop of padding which is under the flexible support structure; a plurality of actuators which lift the flexible support structure up off the loop of padding, move (and/or rotate) the loop of padding (laterally or longitudinally), and then lower the flexible support structure back down onto the loop of padding; and a reconditioning mechanism, wherein the reconditioning mechanism reconditions a portion of the loop of padding at a location where the person's body is not pressing against the loop of padding, and wherein the reconditioning mechanism performs one of more functions selected group the group consisting of: drying or dehumidifying the padding (e.g., using thermal energy); sanitizing or disinfecting the padding (e.g., using light energy or microwave energy); cleaning the padding (e.g., using soap and water; and fluffing or expanding the padding (e.g., using positive or negative air pressure)

For example, a device to help a person in bed to avoid decubitus ulcers comprises: a flexible net, mesh, sling, hammock, pad, sheet, or blanket on which a person lies; a loop of padding which is under the upper support structure; and a plurality of actuators; and (a) using at least one actuator to lift the flexible net, mesh, sling, hammock, pad, sheet, or blanket up off the lower support structure; (b) using at least one actuator to scroll the loop of padding laterally, thereby changing which portion of the loop of padding is directly underneath a selected location on the person's body; and then (c) using at least one actuator to lower the flexible net, mesh, sling, hammock, pad, sheet, or blanket back down onto the lower support structure.

Alternatively, a device which helps to prevent decubitus ulcers comprises: a mattress on which a person lies; a lower first-side cushion on a first (e.g., right or left) side of the person; an upper first-side cushion which is also on the first side of the person, but above the lower first-side cushion; a lower second-side cushion on a second (e.g., left or right) side of the person; an upper second-side cushion which is also on the second side of the person, but above the lower second-side cushion; wherein the person is turned from lying on their first (e.g., right) side to lying on their second (e.g., left) side by asymmetrically inflating and deflating the cushions.

In another example, a device to help a person in bed to avoid decubitus ulcers comprises: a mattress on which a person lies; a lower first-side cushion on a first (e.g., right or left) side of the person; an upper first-side cushion which is also on the first side of the person, but above the lower first-side cushion; a lower second-side cushion on a second (e.g., left or right) side of the person; an upper second-side cushion which is also on the second side of the person, but above the lower second-side cushion; wherein the person is turned from lying on their first (e.g., right) side to lying on their second (e.g., left) side by inflating and deflating the cushions, wherein the level of inflation (and deflation) of cushions on the first vs. second sides is asymmetric with respect to a vertical plane midway between them, and wherein the level of inflation (and deflation) of lower vs. upper cushions is asymmetric with respect to a horizontal plane midway between them. Alternatively, a device which helps a person in bed avoid decubitus ulcers comprises: a mattress on which a person lies; a lower first-side cushion on a first (e.g., right or left) side of the person; an upper first-side cushion which is also on the first side of the person, but above the lower first-side cushion; a lower second-side cushion on a second (e.g., left or right) side of the person; an upper second-side cushion which is also on the second side of the person, but above the lower second-side cushion; wherein the person is turned from lying on their first (e.g., right) side to lying on their second (e.g., left) side by inflating and deflating the cushions, wherein the timing of inflation (and deflation) of cushions on the first vs. second sides is asymmetric with respect to a vertical plane between them, and wherein the timing of inflation (and deflation) of lower vs. upper cushions is asymmetric with respect to a horizontal plane between them.

In one example, a device to help a person in bed to avoid decubitus ulcers comprises: a mattress on which a person lies; a lower first-side cushion on a first (e.g., right or left) side of the person; an upper first-side cushion which is also on the first side of the person, but above the lower first-side cushion; a lower second-side cushion on a second (e.g., left or right) side of the person; an upper second-side cushion which is also on the second side of the person, but above the lower second-side cushion; wherein the person is turned from lying on their first (e.g., right) side to lying on their second (e.g., left) side by inflating and deflating the cushions, and wherein inflation of the lower cushions holds a first portion of the person's torso in place and inflation of the upper cushions pushes a second portion of the person's torso in a lateral direction, thereby tilting and/or rotating the person's torso. Alternatively, a device which helps to prevent decubitus ulcers comprises: an upper support structure (such as a flexible net, mesh, sling, hammock, pad, sheet, or blanket) on which a person lies; a lower support structure (such as a loop of soft padding) which is under the upper support structure; and a plurality of actuators; and (a) using at least one actuator to lift the upper support structure up off the lower support structure; (b) using at least one actuator to scroll the lower support structure (laterally or longitudinally), thereby changing which portion of the lower support structure is directly underneath a selected location on the person's body; and then (c) using at least one actuator to lower the upper support structure back down onto the lower support structure.

In another example, a device to help a person in bed to avoid decubitus ulcers comprises: an upper support surface on which a person lies; a lower support surface below the upper support surface; and a plurality of cushions around the person's torso; wherein the person is turned from lying on one side to the other side by the following sequence—the cushions are inflated, the upper support surface is tilted and/or rotated between 90 and 180 degrees around its longitudinal axis in a first (clockwise or counter-clockwise) direction, and the cushions are deflated. Alternatively, a device to help a person in bed to avoid decubitus ulcers comprises: an upper support surface on which a person lies; a lower support surface below the upper support surface; and inflatable cushions around the person; wherein first the cushions are inflated around the person, then the upper support surface is tilted and/or rotated at least 135 degrees, and then the cushions are deflated.

A device to help a person in bed to avoid decubitus ulcers comprises: an upper support surface on which a person lies; a lower support surface below the upper support surface; and inflatable cushions to the right and left of the; wherein first the cushions are inflated on both sides of the person, then the upper support surface is tilted and/or rotated, and then the cushions are deflated. Alternatively, a device which helps a person in bed to avoid decubitus ulcers comprises: a longitudinal flexible body support surface (such as a net, mesh, pad, sheet, or blanket) on which a person lies; a mattress under the support surface, wherein the mattress further comprises right-side inflatable compartment and a left-side inflatable compartment; and a plurality of actuators; wherein the person is moved from lying on their first (e.g., right) side to lying on their second (e.g., left) side in the following steps (a) lifting the right and left sides of the support surface using the actuators, thereby wrapping the support surface at least partially around the person's torso and lifting the person who was lying on their first (e.g., right) side at least partially up off the mattress; (b) inflating the second side compartment so that the second-side inflatable compartment pushes against the support surface and tilts, pivots, and/or rotates the person's body around a longitudinal axis; and then (c) lowering the right and left sides of the support surface using the actuators, thereby unwrapping the support surface from around the person's torso and lowering the person down onto the mattress lying on their second (e.g., left) side.

In another embodiment, a device to help a person in bed to avoid decubitus ulcers comprises: an upper support surface on which a sleeping person lies; a middle support surface below the upper support surface, wherein the middle support surface is automatically moved by one or more actuators, wherein the middle support surface has a first surface portion with a first elasticity level and a second surface portion with a second elasticity level, wherein the second elasticity level is greater than the first elasticity level, and wherein the second surface portion is smaller than the first surface portion; and a lower support surface below the middle support surface, wherein the lower support surface is automatically moved by one or more actuators, wherein the middle support surface has a third surface portion with a third elasticity level and a fourth surface portion with a fourth elasticity level, wherein the fourth elasticity level is greater than the third elasticity level, wherein the fourth surface portion is smaller than the third surface portion, and wherein middle support surface and the lower support surface are moved so as to overlap the second surface portion and the fourth surface portion, thereby creating a localized surface portion with greater elasticity below a selected part of the sleeping person's body that has a pressure ulcer and/or is particularly vulnerable to developing a pressure ulcer. Alternatively, a device which helps to prevent decubitus ulcers comprises: an upper support surface on which a sleeping person lies; a middle support surface below the upper support surface, wherein the middle support surface has a first surface portion with a first elasticity level and a second surface portion with a second elasticity level, wherein the second elasticity level is greater than the first elasticity level, and wherein the second surface portion is smaller than the first surface portion; and a lower support surface below the middle support surface, wherein the middle support surface has a third surface portion with a third elasticity level and a fourth surface portion with a fourth elasticity level, wherein the fourth elasticity level is greater than the third elasticity level, wherein the fourth surface portion is smaller than the third surface portion, and wherein middle support surface and the lower support surface are moved so as to align the second surface portion and the fourth surface portion, thereby creating a localized surface portion with greater elasticity below a selected part of the sleeping person's body that has a pressure ulcer and/or is particularly vulnerable to developing a pressure ulcer.

In another example, a device to help a person in bed to avoid decubitus ulcers comprises: an upper support surface on which a sleeping person lies; a middle support surface below the upper support surface, wherein the middle support surface has a first surface portion with a first elasticity level and a second surface portion with a second elasticity level, wherein the second elasticity level is greater than the first elasticity level, and wherein the second surface portion is smaller than the first surface portion; and a lower support surface below the middle support surface, wherein the middle support surface has a third surface portion with a third elasticity level and a fourth surface portion with a fourth elasticity level, wherein the fourth elasticity level is greater than the third elasticity level, wherein the fourth surface portion is smaller than the third surface portion, and wherein the middle support surface and the lower support surface are manually moved to align the second surface portion and the fourth surface portion to create a localized area with greater elasticity below a selected part of the sleeping person's body that has a pressure ulcer and/or is particularly vulnerable to developing a pressure ulcer. Alternatively, a device which helps a person in bed to avoid decubitus ulcers comprises: an upper support surface on which a sleeping person lies; a middle support surface below the upper support surface, wherein the middle support surface has a first surface portion with a first elasticity level and a second surface portion with a second elasticity level, wherein the second elasticity level is greater than the first elasticity level, and wherein the second surface portion is smaller than the first surface portion; and a lower support surface below the middle support surface, wherein the middle support surface has a third surface portion with a third elasticity level and a fourth surface portion with a fourth elasticity level, wherein the fourth elasticity level is greater than the third elasticity level, wherein the fourth surface portion is smaller than the third surface portion, and wherein the middle support surface and the lower support surface are automatically moved to overlap the second surface portion and the fourth surface portion to create a localized area with greater elasticity below a selected part of the sleeping person's body that has a pressure ulcer and/or is particularly vulnerable to developing a pressure ulcer.

For example, a device to help a person in bed to avoid decubitus ulcers comprises: a flexible support surface (such as a flexible net, mesh, sling, hammock, pad, sheet, or blanket) on which a person lies; a moving layer of padding (such as a layer of compressible foam or textile padding) which is under the upper support structure; and a plurality of actuators; and using at least one actuator to lift the flexible support surface up off the loop of padding; (b) using at least one actuator to shift the layer of padding longitudinally, thereby changing which portion of the layer of padding is directly underneath a selected location on the person's body; and then (c) using at least one actuator to lower the flexible support surface back down onto the layer of padding. Alternatively, a device to help a person in bed to avoid decubitus ulcers comprises: a support structure on which a person lies; a plurality of actuators which change the cross-sectional shape of the support structure from flat to concave, or vice versa; a garment worn by the person; and one or more sensors on the garment selected from the group consisting of motion sensor, pressure sensor, and moisture sensor; wherein the plurality of actuators are triggered to change the cross-sectional shape of the support structure from flat to concave, or vice versa, based on data from the one or more sensors.

In another example, a device to help a person in bed to avoid decubitus ulcers comprises: a support structure on which a person lies; a plurality of actuators which change the cross-sectional shape of the support structure from flat to concave, or vice versa; wherein the plurality of actuators are activated periodically (e.g., wherein the time period is between 1 and 8 hours) to change the cross-sectional shape of the support structure from flat to concave, then tilt and/or rotate the support structure, and then change the cross-sectional shape of the support structure back to flat. Alternatively, a device which helps a person in bed avoid decubitus ulcers comprises: a support structure (such as a mattress) on which a person lies, wherein the support structure further comprises a concentric array of compressible rings; a plurality of actuators which move the concentric array of compressible rings; a plurality of actuators which moves the concentric array of compressible rings; a garment (or dressing) worn by the person, wherein the garment (or dressing) further comprises at least one electromagnetic energy emitter; and a plurality of electromagnetic energy sensors which are used to determine the location of the at least one electromagnetic energy emitter; wherein the concentric array of compressible rings is moved so that its center is under the at least one electromagnetic energy emitter.

In one example, a device to help a person in bed to avoid decubitus ulcers comprises: a support structure (such as a mattress) on which a person lies, wherein the support structure further comprises a concentric array of foam rings; a plurality of actuators which move the concentric array of foam rings; a plurality of actuators which move the concentric array of foam rings; a garment (or dressing) worn by the person, wherein the garment (or dressing) further comprises an electromagnetic energy emitter; and a plurality of electromagnetic energy sensors which are used to determine the location of the at least one electromagnetic energy emitter; wherein the concentric array of foam rings is moved so that its center is under the electromagnetic energy emitter. Alternatively, a device which helps a person in bed to avoid decubitus ulcers comprises: a support structure (such as a mattress) on which a person lies, wherein the support structure further comprises a concentric array of foam rings; a plurality of actuators which move the concentric array of foam rings; and a camera which records infrared images which are analyzed to determine the location of a selected part of the person's body at a selected time; wherein the concentric array of foam rings is moved so that its center is under the selected part of the person's body.

In another embodiment, a device to help a person in bed to avoid decubitus ulcers comprises: a support structure (such as a mattress) on which a person lies, wherein the support structure further comprises a concentric array of inflated rings; a plurality of actuators which move the concentric array of inflated rings; and a camera which records images which are analyzed to determine the location of a selected part of the person's body at a selected time; wherein the concentric array of inflated rings is moved so that its center is under the selected part of the person's body. Alternatively, a device which helps to prevent decubitus ulcers comprises: a longitudinal flexible support structure on which a person lies; a plurality of arcuate beams which span laterally over the support structure, wherein the support structure is connected to the arcuate beams at a plurality of movable connections, and wherein the support structure is suspended between the arcuate beams; and a plurality of actuators which move the connections; wherein moving the connections changes the slope and/or shape of the support structure which, in turn, helps the person to move from lying on their first (e.g., right) side to lying on their second (e.g., left) side.

In another example, a device to help a person in bed to avoid decubitus ulcers comprises: a longitudinal flexible support structure (such as a reinforced sheet, pad, blanket, net, mesh, or sling) on which a person lies; a plurality of beams (or ribs) which laterally span the support structure above the support structure, wherein the support structure is connected to the beams at a plurality of connections which are moved along tracks in the beams (or ribs); and a plurality of actuators which move the connections; wherein moving the connections changes the slope and/or shape of the support structure which, in turn, helps the person to move from lying on their first (e.g., right) side to lying on their second (e.g., left) side. Alternatively, a device to help a person in bed to avoid decubitus ulcers comprises: a longitudinal flexible support structure on which a person lies; a plurality of beams which span laterally over the support structure, wherein the support structure is connected to the beams at a plurality of movable connections; and a plurality of actuators which move the connections closer together or farther apart in an alternating manner; wherein moving the connections closer together or farther apart in an alternating manner changes the slope and/or shape of the support structure in an alternating manner which, in turn, helps the person to move from lying on their first (e.g., right) side to lying on their second (e.g., left) side by gently lifting the person from lying on their first side and gently lowering them onto their second side.

A device to help a person in bed to avoid decubitus ulcers comprises: a longitudinal flexible support structure on which a person lies; a plurality of beams which span laterally over the support structure, wherein right and left sides of the support structure are connected to the beams at a plurality of movable connections; and a plurality of actuators which move the connections closer together and farther apart; wherein moving the connections closer together and farther apart changes the slope and/or shape of the support structure in a sequential manner which, in turn, helps the person to move from lying on their first (e.g., right) side to lying on their second (e.g., left) side. Alternatively, a device which helps a person to avoid decubitus ulcers comprises: a longitudinal flexible support structure on which a person lies; a plurality of beams which span laterally over the support structure, wherein corners of the support structure are connected to the beams at a plurality of movable connections; and a plurality of actuators which move the connections of laterally-aligned corners of the support structure closer together and farther apart; wherein moving these connections closer together partially folds the support structure around the person's body; wherein moving these connections farther apart unfolds the support structure around the person's body; and wherein folding and unfolding the support structure in a sequential manner helps the person to move from lying on their first (e.g., right) side to lying on their second (e.g., left) side.

In another example, a device to help a person in bed to avoid decubitus ulcers comprises: a longitudinal flexible support structure on which a person lies; a plurality of beams which span laterally over the support structure, wherein corners of the support structure are connected to the beams at a plurality of movable connections; and a plurality of actuators which move the connections of laterally-aligned corners of the support structure; wherein moving these connections changes the slope and/or shape of the support structure which, in turn, helps the person to move from lying on their first (e.g., right) side to lying on their second (e.g., left) side. Alternatively, a device which helps to prevent decubitus ulcers comprises: a longitudinal flexible support structure on which a person lies; a plurality of beams which span laterally over the support structure, wherein corners (and/or sides) of the support structure are connected to the beams at a plurality of movable connections; and a plurality of actuators which move the connections; wherein the plurality of actuators move the connections in the following three-step sequential manner; firstly, the actuators gently fold the support structure around the person's body as they lie on their first side by moving laterally-aligned corners (and/or sides) of the support structure closer to each other; secondly, the actuators rotate and/or tilt the person's body within the folder support structure by moving both laterally-aligned corners (and/or sides) of the support structure; and then thirdly, the actuators gently unfold the support structure from the person's body, leaving the person lying on their second side.

For example, a device to help a person in bed to avoid decubitus ulcers comprises: a longitudinal flexible support structure on which a person lies; a plurality of beams which span laterally over the support structure, wherein the support structure is connected to the beams at a plurality of movable connections, and wherein the support structure is suspended between the beams; and a plurality of actuators which move the connections; wherein moving the connections changes the slope and/or shape of the support structure which, in turn, helps the person to move from lying on their first (e.g., right) side to lying on their second (e.g., left) side. Alternatively, a device which helps a person in bed avoid decubitus ulcers comprises: a longitudinal flexible support structure on which a person lies; a plurality of beams which span laterally over the support structure, wherein the support structure is connected to the beams at a plurality of movable connections; and a plurality of actuators which move the connections; wherein moving the connections enfolds the support structure around the person's body and tilts the person's body from a first configuration lying on their first (e.g., right) side to a second configuration lying on their second (e.g., left) side.

In one example, a device to help a person in bed to avoid decubitus ulcers comprises: a longitudinal flexible support structure on which a person lies; a plurality of beams which span laterally over the support structure, wherein corners of the support structure are connected to the beams at a plurality of movable connections; and a plurality of actuators which raise and lower the connections; wherein raising or lowering the connections changes the slope and/or shape of the support structure which, in turn, helps the person to move from lying on their first (e.g., right) side to lying on their second (e.g., left) side. Alternatively, a device to help a person in bed to avoid decubitus ulcers comprises: a support structure on which a person lies, wherein the support structure further comprises a plurality of adjustable portions (e.g., cells, columns, bladders, or compartments) whose sizes and/or shapes are able to be individually adjusted; a plurality of electromagnetic energy sensors; and a garment (or dressing) which is worn by the person, wherein the garment (or dressing) further comprises an electromagnetic energy emitter, wherein the adjustable portions which are within a selected distance (e.g., between ½″ and 6″) from the electromagnetic energy emitter at a selected time are identified by the electromagnetic energy sensors, and wherein the sizes and/or shapes of the identified adjustable portions at the selected time are adjusted relative to the sizes and/or shapes of the other adjustable portions.

In another example, a device to help a person in bed to avoid decubitus ulcers comprises: a support structure on which a person lies, wherein the support structure further comprises a plurality of adjustable portions (e.g., cells, columns, bladders, or compartments) whose sizes and/or shapes are able to be individually adjusted; a plurality of electromagnetic energy sensors; and a garment (or dressing) which is worn by the person, wherein the garment (or dressing) further comprises at least one electromagnetic energy emitter, wherein the adjustable portions which are below the electromagnetic energy emitter at a selected time are identified by the electromagnetic energy sensors, and wherein the sizes and/or shapes of the adjustable portions near (e.g., within 6″ of) the electromagnetic energy emitter at the selected time are adjusted relative to the sizes and/or shapes of the rest of the adjustable portions. Alternatively, a device which helps to prevent decubitus ulcers comprises: one or more garments which are worn by a person who lies in a bed, wherein the garments further comprise electromagnetic markers on pant legs and torso; a plurality of electromagnetic sensors which detect the locations of the markers; a human-to-computer interface (e.g., voice command interface) which is controlled by the person; a first (robotic) soft support structure (such as a moving sling, pad, or pillow) onto which the person places their knees; a second (robotic) soft support structure (such as a moving sling, pad, or pillow) onto which the person places their torso; wherein the first and second soft support structures engage the person's knees and torso if the person gives the appropriate command (via the human-to-computer interface) and the plurality of sensors indicate that the person's knees and torso are properly positioned relative to the first and second soft support structure; and wherein the first and second soft support structures are moved, in an arcuate manner, from a first (right or left) side of the bed to a second (left or right) side of the bed, thereby gently moving the person from lying on their first (e.g., right) side to lying on their second (e.g., left) side at their command.

In one example, a device to help a person in bed to avoid decubitus ulcers comprises: one or more garments which are worn by a person who lies in a bed, wherein the garments further comprise electromagnetic markers on pant legs and torso; a plurality of electromagnetic sensors which detect the locations of the markers; a human-to-computer interface (e.g., voice command interface) which is controlled by the person; a first soft C-shaped structure into which the person places their knees; a second soft C-shaped structure into which the person places their torso; wherein the support structures move (a) if the person gives the appropriate command and (b) if the sensors indicate that the person's knees and torso are properly positioned in the support structures; and wherein the support structures are moved, spanning an arc in 3D space, from a first (right or left) side of the bed to a second (left or right) side of the bed, thereby gently moving the person from lying on their first (e.g., right) side to lying on their second (e.g., left) side at their command. Alternatively, a device which helps a person in bed to avoid decubitus ulcers comprises: one or more garments which are worn by a person who lies in a bed, wherein the garments further comprise electromagnetic markers on pant legs and torso; a plurality of electromagnetic sensors which detect the locations of the markers; a human-to-computer interface (e.g., voice command interface) which is controlled by the person; a first set of robotic arms which gently engages the person's knees; a second set of robotic arms which gently engage the person's torso; wherein the robotic arms move the person's knees and torso, in an arcuate manner, from a first (right or left) side of the bed to a second (right or left) side of the bed: (a) if the person gives the appropriate command; and (b) if the sensors indicate that the person's knees and torso are properly positioned.

In another example, a device to help a person in bed to avoid decubitus ulcers comprises: one or more garments which are worn by a person who lies in a bed, wherein the garments further comprise electromagnetic markers on pant legs and shirt sleeves; a plurality of electromagnetic sensors which detect the locations of the markers; a human-to-computer interface (e.g., voice command interface) which is controlled by the person; a first (robotic) soft support structure (such as a moving sling, pad, or pillow) onto which the person places their knees; a second (robotic) soft support structure (such as a moving sling, pad, or pillow) onto which the person places their elbows; wherein the first and second soft support structures engage the person's knees and elbows if the person gives the appropriate command (via the human-to-computer interface) and the plurality of sensors indicate that the person's knees and elbows are properly positioned relative to the first and second soft support structure; and wherein the first and second soft support structures are moved, in an arcuate manner, from a first (right or left) side of the bed to a second (left or right) side of the bed, thereby gently moving the person from lying on their first (e.g., right) side to lying on their second (e.g., left) side at their command. Alternatively, a device which helps a person to avoid decubitus ulcers comprises: one or more garments which are worn by a person who lies in a bed, wherein the garments further comprise electromagnetic markers on pant legs and shirt sleeves; a plurality of electromagnetic sensors which detect the locations of the markers; a human-to-computer interface (e.g., voice command interface) which is controlled by the person; a first sling structure onto which the person places their knees; a second sling structure onto which the person places their elbows; wherein the sling structures move (a) if the person gives the appropriate command and (b) if the sensors indicate that the person's knees and elbows are properly positioned in the support structures; and wherein the support structures are moved in arc in 3D space from a first (right or left) side of the bed to a second (left or right) side of the bed, thereby gently moving the person from lying on their first (e.g., right) side to lying on their second (e.g., left) side at their command.

In one example, a device to help a person in bed to avoid decubitus ulcers comprises: one or more garments which are worn by a person who lies in a bed, wherein the garments further comprise electromagnetic markers on pant legs and shirt sleeves; a plurality of electromagnetic sensors which detect the locations of the markers; a human-to-computer interface (e.g., voice command interface) which is controlled by the person; a first set of robotic arms which gently engages the person's knees; a second set of robotic arms which gently engage the person's elbows; wherein the robotic arms move the person's knees and elbows in a sequence of at least five gradual and limited moves, along an arcuate path in 3D space, from a first (right or left) side of the bed to a second (right or left) side of the bed: (a) if the person gives the appropriate command to continue for each of the five sequential gradual and limited moves; and (b) if the sensors indicate that the person's knees and elbows are properly positioned for each of the five sequential gradual and limited moves. Alternatively, a device to help a person in bed to avoid decubitus ulcers comprises: a longitudinal flexible support structure on which a person lies; a plurality of lateral beams above the support structure which span the width of the support structure, wherein right and left side corners (or sides or edges) of the support structure are connected to right and left sides, respectively, of the lateral beams; a longitudinal beam which spans longitudinally under a central portion of the support structure and is connected to the longitudinal beam; and a plurality of actuators which move the connections between the support structure and the lateral beams in a sequential manner, which changes the slope and/or shape of the support structure in a sequential manner which, in turn, helps the person to move from lying on their first (e.g., right) side to lying on their second (e.g., left) side; wherein this sequential manner further comprises the following steps: (a) first, actuators fold the support structure partially around the person's body while the person lies on their first side, by moving right side and left side connections closer to each other; (b) second, actuators rotate and/or tilt the support structure, with the person's body enfolded inside it, by jointly moving right side and left side connections to the right or left; and (c) third, actuators unfold the support structure to release the person's body into a position lying on their second side, by moving right and left side connections apart from each other.

For example, a device to help a person in bed to avoid decubitus ulcers comprises: a plurality of longitudinal fabric strips; a plurality of lateral fabric strips; wherein the longitudinal fabric strips and the lateral fabric strips together create an orthogonal mesh or grid which supports a sleeping person's body; and a plurality of actuators which move (selected) longitudinal fabric strips apart from each other and move (selected) lateral fabric strips apart from each other in order to create an opening (or hole) in the mesh or grid at a selected location; wherein the selected location is located under a portion of the sleeping person's body which has a pressure ulcer or is particularly vulnerable to getting a pressure ulcer. Alternatively, a device which helps a person in bed to avoid decubitus ulcers comprises: a plurality of longitudinal rods; a plurality of lateral rods; wherein the longitudinal rods and the lateral rods together create an orthogonal mesh or grid which supports a sleeping person's body; and a plurality of actuators which move (selected) longitudinal rods apart from each other and move (selected) lateral rods apart from each other in order to create an opening (or hole) in the mesh or grid at a selected location; wherein the selected location is located under a portion of the sleeping person's body which has a pressure ulcer or is particularly vulnerable to getting a pressure ulcer.

In another example, a device to help a person in bed to avoid decubitus ulcers comprises: a plurality of longitudinal strips; a plurality of lateral strips; wherein the longitudinal strips and the lateral strips are woven together create an orthogonal mesh or grid which supports a sleeping person's body; and a plurality of actuators which move (selected) longitudinal strips apart and move (selected) lateral strips apart in order to create an opening (or hole) in the mesh or grid at a selected location; wherein the selected location is located under a portion of the sleeping person's body which has a pressure ulcer or is particularly vulnerable to getting a pressure ulcer. Alternatively, a device which helps to prevent decubitus ulcers comprises: a plurality of porous longitudinal straps; a plurality of porous lateral straps; wherein the longitudinal straps and the lateral straps together create an orthogonal porous mesh or grid which supports a sleeping person's body; and a plurality of actuators which move (selected) longitudinal straps in a lateral manner and move (selected) lateral straps in a longitudinal manner in order to create an opening (or hole) in the mesh or grid at a selected location; wherein the selected location is located under a portion of the sleeping person's body which has a pressure ulcer or is particularly vulnerable to getting a pressure ulcer.

A device to help a person in bed to avoid decubitus ulcers comprises: a plurality of porous longitudinal strips; a plurality of porous lateral strips; wherein the longitudinal strips and the lateral strips together create an orthogonal porous mesh or grid which supports a sleeping person's body; and a plurality of actuators which move (selected) longitudinal strips to overlap each other and move (selected) lateral strips to overlap each other in order to create an opening (or hole) in the mesh or grid at a selected location; wherein the selected location is located under a portion of the sleeping person's body which has a pressure ulcer or is particularly vulnerable to getting a pressure ulcer. Alternatively, a device which helps a person in bed avoid decubitus ulcers comprises: a plurality of porous longitudinal strips; a plurality of porous lateral strips; wherein the longitudinal strips and the lateral strips together create an orthogonal porous mesh or grid which supports a sleeping person's body; and a plurality of actuators which move (selected) longitudinal strips away from each other and move (selected) lateral strips away from each other in order to create an opening (or hole) in the mesh or grid at a selected location; wherein the selected location is located under a portion of the sleeping person's body which has a pressure ulcer or is particularly vulnerable to getting a pressure ulcer.

In another example, a device to help a person in bed to avoid decubitus ulcers comprises: a longitudinal flexible support structure (such as a reinforced sheet, blanket, pad, mesh, net, or sling) on which a person lies; a right side longitudinal beam to the right of the support structure; a left side longitudinal beam to the left of the support structure; and a central longitudinal beam under a central portion of the support structure; wherein the support structure is attached to the right side, left side, and central longitudinal beams; and a plurality of actuators which move the beams in a lateral manner, thereby changing the slope and/or shape of the support structure and helping the person to move from lying on their first (e.g., right) side to lying on their second (e.g., left) side. Alternatively, a device to help a person in bed to avoid decubitus ulcers comprises: a longitudinal flexible support structure on which a person lies; a right side longitudinal beam to the right of the support structure; a left side longitudinal beam to the left of the support structure; and a central longitudinal beam under a central portion of the support structure; wherein the support structure is attached to the right side, left side, and central longitudinal beams; and a plurality of actuators which move the beams closer together or farther apart in sequential manner, thereby changing the slope and/or shape of the support structure in order to help the person to move from lying on their first (e.g., right) side to lying on their second (e.g., left) side.

In another embodiment, a device to help a person in bed to avoid decubitus ulcers comprises: a longitudinal flexible support structure on which a person lies; a right-side cushion (or pillow) to the right of the person; a left-side cushion (or pillow) to the left of the person; wherein the right-side and left-side cushions (or pillows) are first asymmetrically moved toward the person, then tilted and/or rotated around their longitudinal axes, and then asymmetrically moved away from the person. Alternatively, a device which helps to prevent decubitus ulcers comprises: a longitudinal flexible support structure on which a person lies; a right-side inflatable cushion (or pillow); a left-side inflatable cushion (or pillow); wherein the right-side and left-side cushions are asymmetrically inflated during a first period of time; wherein the right-side and left-side cushions are deflated during a second period of time. In another example, a device to help a person in bed to avoid decubitus ulcers comprises: a longitudinal flexible support structure on which a person lies; a right-side inflatable cushion; a left-side inflatable cushion, wherein the right-side and left-side cushions are inflated during a first period of time, wherein the right-side and left-side cushions are deflated during a second period of time, wherein a first cushion is inflated more than a second cushion during the first period of time, and wherein the first cushion is deflated more than the second cushion during the second period of time.

Alternatively, a device which helps a person in bed to avoid decubitus ulcers comprises: a longitudinal flexible support structure on which a person lies; a right-side inflatable cushion; a left-side inflatable cushion, wherein the right-side and left-side cushions are inflated during a first period of time, wherein the right-side and left-side cushions are deflated during a second period of time, wherein a first cushion is inflated longer than a second cushion during the first period of time, and wherein the second cushion is inflated longer than the first cushion during the second period of time.

In another example, a device to help a person in bed to avoid decubitus ulcers comprises: a longitudinal flexible support structure on which a person lies; a right-side inflatable lateral-wedge-shaped chamber on the right side of the support structure; a left-side inflatable lateral-wedge-shaped chamber on the left side of the support structure; wherein the right-side and left-side chambers are inflated during a first period of time; wherein the right-side and left-side chambers are deflated during a second period of time; wherein a first chamber on a first selected side is inflated sooner than a second chamber on a second side during the first period of time; and wherein the first chamber is deflated sooner than the second chamber during the second period of time. Alternatively, a device which helps to prevent decubitus ulcers comprises: a longitudinal flexible support structure on which a person lies; a right-side inflatable longitudinal air compartment on the right side of the support structure; a left-side inflatable longitudinal air compartment on the left side of the support structure; wherein the right-side and left-side air compartments are inflated during a first period of time; wherein the right-side and left-side air compartments are deflated during a second period of time; wherein a first air compartment on a first (right or left) side is inflated more than a second air compartment on a second (left or right) side during the first period of time; and wherein the first air compartment is deflated more than the second air compartment during the second period of time.

For example, a device to help a person in bed to avoid decubitus ulcers comprises: a longitudinal flexible support structure on which a person lies; a right-side inflatable longitudinal air compartment on the right side of the support structure; a left-side inflatable longitudinal air compartment on the left side of the support structure; wherein the right-side and left-side air compartments are inflated during a first period of time; wherein the right-side and left-side air compartments are deflated during a second period of time; wherein a first air compartment on a first selected side is inflated sooner than a second air compartment on a second side during the first period of time; and wherein the first air compartment is deflated sooner than the second air compartment during the second period of time. Alternatively, a device to help a person in bed to avoid decubitus ulcers comprises: a longitudinal flexible support structure on which a person lies; a right-side inflatable longitudinal cushion (or chamber) on the right side of the support structure; a left-side inflatable longitudinal cushion (or chamber) on the left side of the support structure; wherein the right-side and left-side cushions are inflated during a first period of time; wherein the right-side and left-side cushions are deflated during a second period of time; wherein a first cushion on a first selected side is inflated more rapidly than a second cushion on a second side during the first period of time; and wherein the first cushion is deflated more rapidly than the second cushion during the second period of time.

In another example, a device to help a person in bed to avoid decubitus ulcers comprises: a longitudinal flexible support structure on which a person lies; a right-side inflatable longitudinal cushion on the right side of the support structure; a left-side inflatable longitudinal cushion on the left side of the support structure; wherein the right-side and left-side cushions are inflated during a first period of time; wherein the right-side and left-side cushions are deflated during a second period of time; wherein a first cushion on a first selected side is inflated earlier than a second cushion on a second side during the first period of time; and wherein the first cushion is deflated earlier than the second cushion during the second period of time. Alternatively, a device which helps a person in bed to avoid decubitus ulcers comprises: a longitudinal flexible body support surface (such as a net, mesh, pad, sheet, or blanket) on which a person lies; a right-side inflatable member (such as a compartment, bladder, cushion, or wedge) and a left-side inflatable member (such as a compartment, bladder, cushion, or wedge) under the support surface; a mattress under the support surface; and a plurality of actuators; wherein the person is moved from lying on their first (e.g., right) side to lying on their second (e.g., left) side as follows (a) lifting the right and left edges (or sides) of the support surface using the actuators, thereby wrapping the support surface at least partially around the person's torso and lifting the person who was lying on their first (e.g., right) side at least partially up off the mattress so that the lateral axis of their torso becomes substantially vertical; (b) inflating the right-side and/or left-side inflatable members such that one or both of the inflatable members push against the side of the support surface, thereby tilting, pivoting, and/or rotating the person's body around a longitudinal axis; and then (c) lowering the right and left edges (or sides) of the support surface using the actuators, thereby unwrapping the support surface from being around the person's torso and lowering the person down onto the mattress lying on their second (e.g., left) side.

In another embodiment, a device to help a person in bed to avoid decubitus ulcers comprises: a longitudinal flexible body support surface (such as a net, mesh, pad, sheet, or blanket) on which a person lies; a right-side inflatable member (such as a compartment, bladder, cushion, or wedge) and a left-side inflatable member (such as a compartment, bladder, cushion, or wedge) under the support surface; a mattress under the support surface; and a plurality of actuators; wherein the person is moved from lying on their first (e.g., right) side to lying on their second (e.g., left) side in the following steps (a) lifting the right and left sides of the support surface using the actuators, thereby wrapping the support surface at least partially around the person's torso and lifting the person who was lying on their first (e.g., right) side at least partially up off the mattress; (b) inflating the second side inflatable member so that the second-side inflatable member pushes against the support surface and tilts, pivots, and/or rotates the person's body around a longitudinal axis; and then (c) lowering the right and left sides of the support surface using the actuators, thereby unwrapping the support surface from around the person's torso and lowering the person down onto the mattress lying on their second (e.g., left) side. Alternatively, a device which helps a person in bed avoid decubitus ulcers comprises: a longitudinal flexible body support surface (such as a net, mesh, pad, sheet, or blanket) on which a person lies; a right-side inflatable member (such as a compartment, bladder, cushion, or wedge) and a left-side inflatable member (such as a compartment, bladder, cushion, or wedge) under the support surface; a mattress under the support surface; and a plurality of actuators; wherein the person is moved from lying on their first (e.g., right) side to lying on their second (e.g., left) side in the following steps (a) lifting the right and left sides of the support surface using the actuators, thereby wrapping the support surface at least partially around the person's torso and lifting the person who was lying on their first (e.g., right) side at least partially up off the mattress; (b) inflating the second side inflatable member so that the second-side inflatable member pushes against the support surface and tilts, pivots, and/or rotates the person's body around a longitudinal axis; (c) lowering the right and left sides of the support surface using the actuators, thereby unwrapping the support surface from around the person's torso and lowering the person down onto the mattress lying on their second (e.g., left) side; and then (d) deflating the second-side inflatable member.

A device to help a person in bed to avoid decubitus ulcers comprises: a longitudinal flexible body support surface (such as a net, mesh, pad, sheet, or blanket) on which a person lies; a right-side inflatable wedge and a left-side inflatable wedge under the support surface; and a plurality of actuators; wherein the person is moved from lying on their first (e.g., right) side to lying on their second (e.g., left) side in the following steps (a) lifting the right and left sides of the support surface using the actuators, thereby wrapping the support surface at least partially around the person's torso and lifting the person who was lying on their first (e.g., right) side at least partially up off the mattress; (b) inflating the second side (opposite the first side) inflatable wedge so that the second-side inflatable compartment pushes against the support surface and tilts, pivots, and/or rotates the person's body around a longitudinal axis; (c) lowering the right and left sides of the support surface using the actuators, thereby unwrapping the support surface from around the person's torso and lowering the person down onto the mattress lying on their second (e.g., left) side; and then (d) deflating the second side inflatable wedge. Alternatively, a device which helps a person to avoid decubitus ulcers comprises: a longitudinal flexible body support surface (such as a net, mesh, pad, sheet, or blanket) on which a person lies; a right-side inflatable wedge and a left-side inflatable wedge under the support surface; and a plurality of actuators; wherein the person is moved from lying on their first (e.g., right) side to lying on their second (e.g., left) side in the following steps (a) lifting the right and left sides of the support surface using the actuators, thereby wrapping the support surface at least partially around the person's torso and lifting the person who was lying on their first (e.g., right) side at least partially up off the mattress; (b) inflating the second side (opposite the first side) inflatable wedge so that the second-side inflatable compartment pushes against the support surface and tilts, pivots, and/or rotates the person's body around a longitudinal axis; and then (c) lowering the right and left sides of the support surface using the actuators, thereby unwrapping the support surface from around the person's torso and lowering the person down onto the mattress lying on their second (e.g., left) side.

In another example, a device to help a person in bed to avoid decubitus ulcers comprises: a longitudinal flexible support structure on which a person lies; a right-side inflatable wedge-shaped cushion, wherein the narrower side of the cushion faces toward the person's body; a left-side inflatable wedge-shaped cushion; wherein the narrower side of the cushion faces toward the person's body, wherein the right-side and left-side cushions are inflated during a first period of time, wherein the right-side and left-side cushions are deflated during a second period of time, wherein a first cushion is inflated more than a second cushion during the first period of time, and wherein the first cushion is deflated more than the second cushion during the second period of time. Alternatively, a device to help a person in bed to avoid decubitus ulcers comprises: a longitudinal flexible support structure on which a person lies; a right-side inflatable wedge-shaped cushion, wherein the narrower side of the cushion faces toward the person's body; a left-side inflatable wedge-shaped cushion; wherein the narrower side of the cushion faces toward the person's body, wherein the right-side and left-side cushions are inflated during a first period of time, wherein the right-side and left-side cushions are deflated during a second period of time, wherein a first cushion is inflated longer than a second cushion during the first period of time, and wherein the second cushion is inflated longer than the first cushion during the second period of time.

In one example, a device to help a person in bed to avoid decubitus ulcers comprises: a reinforced sheet (or blanket or pad) on which a person lies; a right-side longitudinal beam (or arm) to which the right side of the sheet is attached; a left-side longitudinal beam (or arm) to which the left side of the sheet is attached; a central longitudinal beam (or arm) to which a central longitudinal portion of the sheet is attached; and a plurality of actuators which raise and lower the right-side and left-side longitudinal beams, in a sequential manner, thereby changing the shape of the sheet and helping the person to move from lying on their first (e.g., right) side to lying on their second (e.g., left) side. Alternatively, a device which helps to prevent decubitus ulcers comprises: a reinforced sheet (or blanket or pad) on which a person lies; a right-side longitudinal beam (or arm) to which the right side of the sheet is attached; a left-side longitudinal beam (or arm) to which the left side of the sheet is attached; a central longitudinal beam (or arm) to which a central longitudinal portion of the sheet is attached; and a plurality of actuators which raise and lower the longitudinal beams, in a sequential manner, thereby changing the shape of the sheet and helping the person to move from lying on their first (e.g., right) side to lying on their second (e.g., left) side.

In another example, a device to help a person in bed to avoid decubitus ulcers comprises: a reinforced sheet (or blanket or pad) on which a person lies; a right-side longitudinal beam (or arm) to which the right side of the sheet is attached; a left-side longitudinal beam (or arm) to which the left side of the sheet is attached; a central longitudinal beam (or arm) to which a central longitudinal portion of the sheet is attached; and a plurality of actuators which move the right-side and left-side longitudinal beams (or arms) closer together or farther apart, thereby enfolding around a portion of the persons torso, moving the person from lying on their first (e.g., right) side to lying on their second (e.g., left) side, and unfolding from around the portion of the person's torso. Alternatively, a device which helps a person in bed to avoid decubitus ulcers comprises: a first arcuate beam (or rib) which arcs over the width of a bed on which a person lies; a second arcuate beam (or rib) which arcs over the width of the bed, wherein the first beam is closer to the head of the bed than the second arcuate beam; a concave flexible support structure which is connected to the first beam and to the second beam; wherein the support structure is suspended between the first beam and the second beam; and a plurality of actuators which move the connections between the support structure and the first beam and the second beam, thereby changing the slope and/or shape of the support structure which, in turn, helps the person to turn from lying on their first (e.g., right) side to lying on their second (e.g., left) side.

For example, a device to help a person in bed to avoid decubitus ulcers comprises: a first body support surface with a first configuration in which it is below a person's (lower) torso and a second configuration in which it is above a person's (lower) torso, wherein the first body support surface is in its first configuration during a first period of time and in its second configuration during a second period of time; a second body support surface with a third configuration in which it is below the person's (lower) torso and a fourth configuration in which it is above the person's (lower) torso, wherein the second body support surface is in its fourth configuration during the first period of time and in its third configuration during the second period of time; and a plurality of actuators, wherein the actuators decrease the distance between the first and second body support surfaces, then rotate the first body support surface from its first configuration to its second configuration and rotate the second body support surface from its fourth configuration to its third configuration, and then increase the distance between the first and second body support surfaces.

Alternatively, a device which helps to prevent decubitus ulcers comprises: a first inflated support surface with a first configuration in which it is below a person's (lower) torso and a second configuration in which it is above a person's (lower) torso, wherein the first support surface is in its first configuration during a first period of time and in its second configuration during a second period of time; a second inflated support surface with a third configuration in which it is below the person's (lower) torso and a fourth configuration in which it is above the person's (lower) torso, wherein the second support surface is in its fourth configuration during the first period of time and in its third configuration during the second period of time; and a plurality of actuators; wherein a person is turned from lying on their first (e.g., right or left) side to lying on their second (e.g., left or right side) in the following manner—the first and/or second support surfaces are inflated; the actuators rotate the first body support surface from its first configuration to its second configuration and rotate the second body support surface from its fourth configuration to its third configuration, and the first and/or second support surfaces are deflated.

In another embodiment, a device to help a person in bed to avoid decubitus ulcers comprises: a first pivoting (and/or rotating) conic-section-shaped rib which spans from a first pivot joint at the foot of a bed to a second pivot joint at the head of the bed, wherein the first pivoting conic-section-shaped rib has a concave shape which opens toward the bed mattress, wherein the first pivoting conic-section-shaped rib has a first configuration in which it spans (from the foot of the bed to the head of the bed) around a portion of the perimeter of the bed mattress and the plane of its concavity is substantially horizontal, wherein the first pivoting conic-section-shaped rib has a second configuration in which it spans (from the foot of the bed to the head of the bed) over the bed mattress and the plane of its concavity is substantially vertical, and wherein the first pivoting conic-section-shaped rib is manually (or automatically using at least one actuator) pivoted (and/or rotated) from its first configuration to its second configuration, or vice versa; a second pivoting (and/or rotating) conic-section-shaped rib which spans from the first pivot joint at the foot of a bed to the second pivot joint at the head of the bed, wherein the second pivoting conic-section-shaped rib has a concave shape which opens toward the bed mattress, wherein the second pivoting conic-section-shaped rib has a third configuration in which it spans (from the foot of the bed to the head of the bed) around a portion of the perimeter of the bed mattress and the plane of its concavity is substantially horizontal, wherein the second pivoting conic-section-shaped rib has a fourth configuration in which it spans (from the foot of the bed to the head of the bed) over the bed mattress and the plane of its concavity intersects a horizontal plane at an angle greater than 45 degrees, and wherein the second pivoting conic-section-shaped rib is manually (or automatically using at least one actuator) pivoted (and/or rotated) from its third configuration to its fourth configuration, or vice versa; and a flexible support structure (e.g., reinforced sheet, blanket, pad, net, mesh, strap, or sling) on which a person lies, wherein a first (e.g., right or left) side of the support structure is attached to the first pivoting conic-section-shaped rib and a second (e.g., left or right) side of the support structure is attached to the second pivoting conic-section-shaped rib, and wherein changing the first pivoting conic-section-shaped rib from its first configuration to its second configuration (or vice versa) and changing the second pivoting conic-section-shaped rib from its third configuration to its fourth configuration (or vice versa) assists in turning (or automatically turns) the person from lying on their first (e.g., right or left) side to lying on their second (e.g., left or right) side.

Alternatively, a device to help a person in bed to avoid decubitus ulcers comprises: a first pivoting (and/or rotating) rib which curves from a pivot joint at the foot of a bed to a pivot joint at the head of the bed, wherein the first pivoting rib has a first configuration in which it curves around a first (e.g., right or left) side of the bed mattress, wherein the first pivoting rib has a second configuration in which it curves over the bed mattress, and wherein the first pivoting rib is manually (or automatically using at least one actuator) pivoted (and/or rotated) from its first configuration to its second configuration, or vice versa; a second pivoting (and/or rotating) rib which curves from a pivot joint at the foot of a bed to a pivot joint at the head of the bed, wherein the second pivoting rib has a third configuration in which it curves around a second (e.g., left or right) side of the bed mattress, wherein the second pivoting rib has a fourth configuration in which it curves over the bed mattress, and wherein the second pivoting rib is manually (or automatically using at least one actuator) pivoted (and/or rotated) from its third configuration to its fourth configuration, or vice versa; and a flexible support structure (e.g., reinforced sheet, blanket, pad, net, mesh, strap, or sling) on which a person lies, wherein a first (e.g., right or left) side of the support structure is attached to the first pivoting rib and a second (e.g., left or right) side of the support structure is attached to the second pivoting rib, and wherein changing the first pivoting rib from its first configuration to its second configuration (or vice versa) and changing the second pivoting rib from its third configuration to its fourth configuration (or vice versa) assists in turning (or automatically turns) the person from lying on their first (e.g., right or left) side to lying on their second (e.g., left or right) side.

In another example, a device to help a person in bed to avoid decubitus ulcers comprises: a first pivoting (and/or rotating) rib which spans from a (laterally-central) pivot joint at the foot of a bed to a (laterally-central) pivot joint at the head of the bed, wherein the first pivoting rib has a concave shape which opens toward the bed mattress, wherein the first pivoting rib has a first configuration in which it spans (from the foot of the bed to the head of the bed) around a portion of the perimeter of the bed mattress and the plane of its concavity is substantially horizontal, wherein the first pivoting rib has a second configuration in which it spans (from the foot of the bed to the head of the bed) over the bed mattress and the plane of its concavity is substantially vertical, and wherein the first pivoting rib is manually (or automatically using at least one actuator) pivoted (and/or rotated) from its first configuration to its second configuration, or vice versa; a second pivoting (and/or rotating) rib which spans from a (laterally-central) pivot joint at the foot of a bed to a (laterally-central) pivot joint at the head of the bed, wherein the second pivoting rib has a concave shape which opens toward the bed mattress, wherein the second pivoting rib has a third configuration in which it spans (from the foot of the bed to the head of the bed) around a portion of the perimeter of the bed mattress and the plane of its concavity is substantially horizontal, wherein the second pivoting rib has a fourth configuration in which it spans (from the foot of the bed to the head of the bed) over the bed mattress and the plane of its concavity intersects a horizontal plane at an angle greater than 45 degrees, and wherein the second pivoting rib is manually (or automatically using at least one actuator) pivoted (and/or rotated) from its third configuration to its fourth configuration, or vice versa; and a flexible support structure (e.g., reinforced sheet, blanket, pad, net, mesh, strap, or sling) on which a person lies, wherein a first (e.g., right or left) side of the support structure is attached to the first pivoting rib and a second (e.g., left or right) side of the support structure is attached to the second pivoting rib, and wherein changing the first pivoting rib from its first configuration to its second configuration (or vice versa) and changing the second pivoting rib from its third configuration to its fourth configuration (or vice versa) assists in turning (or automatically turns) the person from lying on their first (e.g., right or left) side to lying on their second (e.g., left or right) side.

Alternatively, a device which helps a person in bed to avoid decubitus ulcers comprises: a first pivoting (and/or rotating) rib which spans from a pivot joint at the foot of a bed to a pivot joint at the head of the bed, wherein the first pivoting rib has a concavity which opens toward the bed mattress, wherein the first pivoting rib has a first configuration in which it spans around a first (e.g., right or left) side of the bed mattress and the plane of its concavity is substantially horizontal, wherein the first pivoting rib has a second configuration in which it spans over the bed mattress and the plane of its concavity is substantially vertical, and wherein the first pivoting rib is manually (or automatically using at least one actuator) pivoted (and/or rotated) from its first configuration to its second configuration, or vice versa; a second pivoting (and/or rotating) rib which spans from a pivot joint at the foot of a bed to a second pivot joint at the head of the bed, wherein the second pivoting rib has a concavity which opens toward the bed mattress, wherein the second pivoting rib has a third configuration in which it spans around a second (e.g., left or right) side of the bed mattress and the plane of its concavity is substantially horizontal, wherein the second pivoting rib has a fourth configuration in which it spans over the bed mattress and the plane of its concavity intersects a horizontal plane at an angle greater than 45 degrees, and wherein the second pivoting rib is manually (or automatically using at least one actuator) pivoted (and/or rotated) from its third configuration to its fourth configuration, or vice versa; and a flexible support structure (e.g., reinforced sheet, blanket, pad, net, mesh, strap, or sling) on which a person lies, wherein a first (e.g., right or left) side of the support structure is attached to the first pivoting rib and a second (e.g., left or right) side of the support structure is attached to the second pivoting rib, and wherein changing the first pivoting rib from its first configuration to its second configuration (or vice versa) and changing the second pivoting rib from its third configuration to its fourth configuration (or vice versa) assists in turning (or automatically turns) the person from lying on their first (e.g., right or left) side to lying on their second (e.g., left or right) side.

In one example, a device to help a person in bed to avoid decubitus ulcers comprises: a first pivoting (and/or rotating) rib which spans from a pivot joint at the foot of a bed to a pivot joint at the head of the bed, wherein the first pivoting rib has a concavity which opens toward the bed mattress, wherein the first pivoting rib has a first configuration in which it spans around a first (e.g., right or left) side of the bed mattress, wherein the first pivoting rib has a second configuration in which it spans over the bed mattress, and wherein the first pivoting rib is manually (or automatically using at least one actuator) pivoted (and/or rotated) from its first configuration to its second configuration, or vice versa; a second pivoting (and/or rotating) rib which spans from a pivot joint at the foot of a bed to a second pivot joint at the head of the bed, wherein the second pivoting rib has a concavity which opens toward the bed mattress, wherein the second pivoting rib has a third configuration in which it spans around a second (e.g., left or right) side of the bed mattress, wherein the second pivoting rib has a fourth configuration in which it spans over the bed mattress, and wherein the second pivoting rib is manually (or automatically using at least one actuator) pivoted (and/or rotated) from its third configuration to its fourth configuration, or vice versa; and a flexible support structure (e.g., reinforced sheet, blanket, pad, net, mesh, strap, or sling) on which a person lies, wherein a first (e.g., right or left) side of the support structure is attached to the first pivoting rib and a second (e.g., left or right) side of the support structure is attached to the second pivoting rib, and wherein changing the first pivoting rib from its first configuration to its second configuration (or vice versa) and changing the second pivoting rib from its third configuration to its fourth configuration (or vice versa) assists in turning (or automatically turns) the person from lying on their first (e.g., right or left) side to lying on their second (e.g., left or right) side.

Alternatively, a device which helps to prevent decubitus ulcers comprises: a first pivoting (and/or rotating) rib which spans from a pivot joint on a first (e.g., right or left) side of the foot of a bed to a pivot joint on the first side of the head of the bed, wherein the first pivoting rib has a concavity which opens toward the bed mattress, wherein the first pivoting rib has a first configuration in which it spans around a first (e.g., right or left) side of the bed mattress, wherein the first pivoting rib has a second configuration in which it spans over the bed mattress, and wherein the first pivoting rib is manually (or automatically using at least one actuator) pivoted (and/or rotated) from its first configuration to its second configuration, or vice versa; a second pivoting (and/or rotating) rib which spans from a pivot joint on a second (e.g., left or right) side of the foot of a bed to a pivot joint on the second side of the head of the bed, wherein the second pivoting rib has a concavity which opens toward the bed mattress, wherein the second pivoting rib has a third configuration in which it spans around a second (e.g., left or right) side of the bed mattress, wherein the second pivoting rib has a fourth configuration in which it spans over the bed mattress, and wherein the second pivoting rib is manually (or automatically using at least one actuator) pivoted (and/or rotated) from its third configuration to its fourth configuration, or vice versa; and a flexible support structure (e.g., reinforced sheet, blanket, pad, net, mesh, strap, or sling) on which a person lies, wherein a first (e.g., right or left) side of the support structure is attached to the first pivoting rib and a second (e.g., left or right) side of the support structure is attached to the second pivoting rib, and wherein changing the first pivoting rib from its first configuration to its second configuration (or vice versa) and changing the second pivoting rib from its third configuration to its fourth configuration (or vice versa) assists in turning (or automatically turns) the person from lying on their first (e.g., right or left) side to lying on their second (e.g., left or right) side.

In another example, a device to help a person in bed to avoid decubitus ulcers comprises: a first pivoting (and/or rotating) rib which spans from a rotating joint at the foot of a bed to a rotating joint at the head of the bed, wherein the first pivoting rib has a concavity which opens toward a bed mattress, wherein the first pivoting rib has a first configuration in which it spans around a first (e.g., right or left) side of the bed mattress, wherein the first pivoting rib has a second configuration in which it spans over the bed mattress, and wherein the first pivoting rib is manually (or automatically using at least one actuator) pivoted (and/or rotated) from its first configuration to its second configuration, or vice versa; a second pivoting (and/or rotating) rib which spans from a rotating joint at the foot of a bed to a rotating joint at the head of the bed, wherein the second pivoting rib has a concavity which opens toward the bed mattress, wherein the second pivoting rib has a third configuration in which it spans around a second (e.g., left or right) side of the bed mattress, wherein the second pivoting rib has a fourth configuration in which it spans over the bed mattress, and wherein the second pivoting rib is manually (or automatically using at least one actuator) pivoted (and/or rotated) from its third configuration to its fourth configuration, or vice versa, and wherein the second pivoting rib is symmetric (relative to the central longitudinal axis of the bed) to the first pivoting rib when the first pivoting rib is in its first configuration and the second pivoting rib is in its third configuration; and a flexible support structure (e.g., reinforced sheet, blanket, pad, net, mesh, strap, or sling) on which a person lies, wherein a first (e.g., right or left) side of the support structure is attached to the first pivoting rib and a second (e.g., left or right) side of the support structure is attached to the second pivoting rib, and wherein changing the first pivoting rib from its first configuration to its second configuration (or vice versa) and changing the second pivoting rib from its third configuration to its fourth configuration (or vice versa) assists in turning (or automatically turns) the person from lying on their first (e.g., right or left) side to lying on their second (e.g., left or right) side.

Alternatively, a device which helps a person in bed avoid decubitus ulcers comprises: a first pivoting (and/or rotating) sinusoidal rib which spans from a first pivot joint at the foot of a bed to a second pivot joint at the head of the bed, wherein the first pivoting sinusoidal rib has a concave shape which opens toward the bed mattress, wherein the first pivoting sinusoidal rib has a first configuration in which it spans (from the foot of the bed to the head of the bed) around a portion of the perimeter of the bed mattress and the plane of its concavity is substantially horizontal, wherein the first pivoting sinusoidal rib has a second configuration in which it spans (from the foot of the bed to the head of the bed) over the bed mattress and the plane of its concavity is substantially vertical, and wherein the first pivoting sinusoidal rib is manually (or automatically using at least one actuator) pivoted (and/or rotated) from its first configuration to its second configuration, or vice versa; a second pivoting (and/or rotating) sinusoidal rib which spans from the first pivot joint at the foot of a bed to the second pivot joint at the head of the bed, wherein the second pivoting sinusoidal rib has a concave shape which opens toward the bed mattress, wherein the second pivoting sinusoidal rib has a third configuration in which it spans (from the foot of the bed to the head of the bed) around a portion of the perimeter of the bed mattress and the plane of its concavity is substantially horizontal, wherein the second pivoting sinusoidal rib has a fourth configuration in which it spans (from the foot of the bed to the head of the bed) over the bed mattress and the plane of its concavity intersects a horizontal plane at an angle greater than 45 degrees, and wherein the second pivoting sinusoidal rib is manually (or automatically using at least one actuator) pivoted (and/or rotated) from its third configuration to its fourth configuration, or vice versa; and a flexible support structure (e.g., reinforced sheet, blanket, pad, net, mesh, strap, or sling) on which a person lies, wherein a first (e.g., right or left) side of the support structure is attached to the first pivoting sinusoidal rib and a second (e.g., left or right) side of the support structure is attached to the second pivoting sinusoidal rib, and wherein changing the first pivoting sinusoidal rib from its first configuration to its second configuration (or vice versa) and changing the second pivoting sinusoidal rib from its third configuration to its fourth configuration (or vice versa) assists in turning (or automatically turns) the person from lying on their first (e.g., right or left) side to lying on their second (e.g., left or right) side. A device to help a person in bed to avoid decubitus ulcers comprises: a first plurality of parallel flexible strips; a second plurality of parallel flexible strips; a third plurality of parallel flexible strips; wherein the first, second, and third pluralities of parallel flexible strips are woven together to create a hexagonal mesh or grid which supports a sleeping person's body; and a plurality of actuators which move selected strips apart from each other in order to create a hexagonal-shaped opening in the mesh or grid at a selected location; wherein the selected location is located under a portion of the sleeping person's body which has a pressure ulcer or is particularly vulnerable to getting a pressure ulcer. Alternatively, a device to help a person in bed to avoid decubitus ulcers comprises: a first plurality of parallel flexible strips; a second plurality of parallel flexible strips; wherein the first and second pluralities of parallel flexible strips are woven together to create an orthogonal mesh or grid which supports a sleeping person's body; and a plurality of actuators which move selected strips apart from each other in order to create a quadrilateral-shaped opening in the mesh or grid at a selected location; wherein the selected location is located under a portion of the sleeping person's body which has a pressure ulcer or is particularly vulnerable to getting a pressure ulcer.

For example, a device to help a person in bed to avoid decubitus ulcers comprises: a first roller (or tube) at the head a bed (or bed mattress); a second roller (or tube) at the foot of the bed; one or more actuators; and a plurality of moving loops, wherein an upper portion of each loop spans the length of the bed between the rollers in a first direction; wherein a lower portion of each moving loop spans the length of the bed between the rollers in a second direction; and wherein each loop is rotated around the rollers by the one or more actuators. Alternatively, a device which helps a person in bed to avoid decubitus ulcers comprises: a first roller (or tube) at the head a bed (orbed mattress); a second roller (or tube) at the foot of the bed; one or more actuators; and a plurality of moving undulating loops, wherein each loop has longitudinal undulation in thickness, wherein an upper portion of each loop spans the length of the bed between the rollers in a first direction; wherein a lower portion of each moving loop spans the length of the bed between the rollers in a second direction; and wherein each loop is rotated around the rollers by the one or more actuators.

In another example, a device to help a person in bed to avoid decubitus ulcers comprises: a first roller (or tube) at the head a bed (or bed mattress); a second roller (or tube) at the foot of the bed; one or more actuators; and a plurality of moving loops, wherein an upper portion of each loop spans the length of the bed between the rollers in a first direction; wherein a lower portion of each moving loop spans the length of the bed between the rollers in a second direction; wherein each loop is rotated around the rollers by the one or more actuators; and wherein different loops are moved and/or rotated in different directions. Alternatively, a device which helps a person to avoid decubitus ulcers comprises: a first roller (or tube) at the head a bed (orbed mattress); a second roller (or tube) at the foot of the bed; one or more actuators; and a plurality of moving undulating loops, wherein each loop has longitudinal undulation in thickness, wherein an upper portion of each loop spans the length of the bed between the rollers in a first direction; wherein a lower portion of each moving loop spans the length of the bed between the rollers in a second direction; wherein each loop is rotated around the rollers by the one or more actuators; and wherein different loops are moved and/or rotated in different directions.

In one example, a device to help a person in bed to avoid decubitus ulcers comprises: a first roller (or tube) at the head a bed (orbed mattress); a second roller (or tube) at the foot of the bed; one or more actuators; and a plurality of moving loops, wherein an upper portion of each loop spans the length of the bed between the rollers in a first direction; wherein a lower portion of each moving loop spans the length of the bed between the rollers in a second direction; wherein each loop is rotated around the rollers by the one or more actuators; and wherein adjacent loops are moved and/or rotated in opposite longitudinal directions.

Alternatively, a device which helps to prevent decubitus ulcers comprises: a first roller (or tube) at the head a bed (or bed mattress); a second roller (or tube) at the foot of the bed; one or more actuators; and a plurality of moving undulating loops, wherein each loop has longitudinal undulation in thickness, wherein an upper portion of each loop spans the length of the bed between the rollers in a first direction; wherein a lower portion of each moving loop spans the length of the bed between the rollers in a second direction; wherein each loop is rotated around the rollers by the one or more actuators; and wherein adjacent loops are moved and/or rotated in opposite longitudinal directions.

In another example, a device to help a person in bed to avoid decubitus ulcers comprises: a first roller (or tube) on a first (e.g., right) side of a bed (or bed mattress); a second roller (or tube) on a second (e.g., left) side of the bed; one or more actuators; and a plurality of moving loops, wherein an upper portion of each loop spans the width of the bed between the rollers in a first direction; wherein a lower portion of each moving loop spans the width of the bed between the rollers in a second direction; and wherein each loop is rotated around the rollers by the one or more actuators. Alternatively, a device to help a person in bed to avoid decubitus ulcers comprises: a first roller (or tube) on a first (e.g., right) side of a bed (or bed mattress); a second roller (or tube) on a second (e.g., left) side of the bed; one or more actuators; and a plurality of moving undulating loops, wherein each loop has lateral undulation in thickness, wherein an upper portion of each loop spans the width of the bed between the rollers in a first direction; wherein a lower portion of each moving loop spans the width of the bed between the rollers in a second direction; and wherein each loop is rotated around the rollers by the one or more actuators.

In one example, a device to help a person in bed to avoid decubitus ulcers comprises: a first roller (or tube) on a first (e.g., right) side of a bed (or bed mattress); a second roller (or tube) on a second (e.g., left) side of the bed; one or more actuators; and a plurality of moving loops, wherein an upper portion of each loop spans the width of the bed between the rollers in a first direction; wherein a lower portion of each moving loop spans the width of the bed between the rollers in a second direction; wherein each loop is rotated around the rollers by the one or more actuators; and wherein different loops are moved and/or rotated in different directions. Alternatively, a device which helps a person in bed avoid decubitus ulcers comprises: a first roller (or tube) on a first (e.g., right) side of a bed (or bed mattress); a second roller (or tube) on a second (e.g., left) side of the bed; one or more actuators; and a plurality of moving undulating loops, wherein each loop has lateral undulation in thickness, wherein an upper portion of each loop spans the width of the bed between the rollers in a first direction; wherein a lower portion of each moving loop spans the width of the bed between the rollers in a second direction; wherein each loop is rotated around the rollers by the one or more actuators; and wherein different loops are moved and/or rotated in different directions.

The invention claimed is:

1. A resting support apparatus, comprising:
a flexible body support structure; and
a plurality of actuators operable to transform the flexible body support structure from a first configuration to a second configuration, and/or from the second configuration to the first configuration
wherein, in the first configuration, the flexible body support structure is substantially flat and, in the second configuration, the flexible body support structure is folded along a longitudinal axis and/or wrapped at least partially around an individual;
wherein, while the flexible body support structure is in the second configuration, the plurality of actuators rotate, tilt, or pivot the flexible body support structure toward a left side or a right side;
wherein, after rotating, tilting, or pivoting the flexible body support, the plurality of actuators transform the flexible body support structure from the second configuration to the first configuration; and
wherein the flexible body support structure includes a sheet, a blanket, a pad, a net, a mesh, and/or a hammock.

2. The resting support apparatus of claim 1, wherein the flexible body support structure is formed from cotton, polyester, and/or nylon.

3. The resting support apparatus of claim 1, wherein the flexible body support structure includes a plurality of connectors, and wherein the plurality of connectors are operable to slide along one or more lateral arches extending upwardly from the flexible body support structure.

4. The resting support apparatus of claim 3, wherein, in the second configuration, the plurality of connectors are attached to locations on the one or more lateral arches closer together than locations where the plurality of connectors are attached to the one or more lateral arches in the first configuration.

5. The resting support apparatus of claim 1, wherein the plurality of actuators include at least one electromagnetic actuator, at least one electromagnetic motor, at least one hydraulic actuator, and/or at least one pneumatic actuator.

6. The resting support apparatus of claim 1, wherein the flexible body support structure includes at least one pressure sensor and wherein the plurality of actuators automatically transform the flexible body support structure from the first configuration to the second configuration, and rotate, tilt, or pivot the flexible body support structure based on data generated by the at least one pressure sensor.

7. The resting support apparatus of claim 1, wherein the flexible body support structure includes at least one moisture and/or humidity sensor and wherein the plurality of actuators automatically transform the flexible body support structure from the first configuration to the second configuration, and rotate, tilt, or pivot the flexible body support structure based on data generated by the at least one moisture and/or humidity sensor.

8. The resting support apparatus of claim 1, wherein the flexible body support structure is operable to receive at least one verbal command from the individual and wherein the plurality of actuators automatically transform the flexible body support structure from the first configuration to the second configuration, and rotate, tilt, or pivot the flexible body support structure based on the at least one verbal command.

9. A resting support apparatus, comprising:
a flexible body support structure; and
a plurality of actuators operable to transform the flexible body support structure from a first configuration to a second configuration, and/or from the second configuration to the first configuration;
wherein, in the first configuration, the flexible body support structure is substantially flat and, in the second configuration, the flexible body support structure is folded along a longitudinal axis and/or wrapped at least partially around an individual;
wherein, while the flexible body support structure is in the second configuration, the plurality of actuators rotate, tilt, or pivot the flexible body support structure toward a left side or a right side;
wherein the flexible body support structure includes a plurality of connectors, and wherein the plurality of connectors are operable to slide along one or more lateral arches extending upwardly from the flexible body support structure; and
wherein, after rotating, tilting, or pivoting the flexible body support, the plurality of actuators transform the flexible body support structure from the second configuration to the first configuration.

10. The resting support apparatus of claim 9, wherein the flexible body support structure includes a sheet, a blanket, a pad, a net, a mesh, and/or a hammock.

11. The resting support apparatus of claim 9, wherein the flexible body support structure is formed from cotton, polyester, and/or nylon.

12. The resting support apparatus of claim 9, wherein, in the second configuration, the plurality of connectors are attached to locations on the one or more lateral arches closer together than locations where the plurality of connectors are attached to the one or more lateral arches in the first configuration.

13. The resting support apparatus of claim 9, wherein the plurality of actuators include at least one electromagnetic actuator, at least one electromagnetic motor, at least one hydraulic actuator, and/or at least one pneumatic actuator.

14. The resting support apparatus of claim 9, wherein the flexible body support structure includes at least one pressure sensor and wherein the plurality of actuators automatically transform the flexible body support structure from the first configuration to the second configuration, and rotate, tilt, or pivot the flexible body support structure based on data generated by the at least one pressure sensor.

15. The resting support apparatus of claim 9, wherein the flexible body support structure includes at least one moisture and/or humidity sensor and wherein the plurality of actuators automatically transform the flexible body support structure from the first configuration to the second configuration, and rotate, tilt, or pivot the flexible body support structure based on data generated by the at least one moisture and/or humidity sensor.

16. The resting support apparatus of claim 9, wherein the flexible body support structure is operable to receive at least one verbal command from the individual and wherein the plurality of actuators automatically transform the flexible body support structure from the first configuration to the second configuration, and rotate, tilt, or pivot the flexible body support structure based on the at least one verbal command.

17. A resting support apparatus, comprising:
a flexible body support structure;
a plurality of actuators operable to transform the flexible body support structure from a first configuration to a second configuration, and/or from the second configuration to the first configuration;
a first inflatable member positioned on a first side of the flexible body support structure; and
a second inflatable member positioned on a second side of the flexible body support structure;
wherein, in the first configuration, the flexible body support structure is substantially flat and, in the second configuration, the flexible body support structure is folded along a longitudinal axis and/or wrapped at least partially around an individual;
wherein, while the flexible body support structure is in the second configuration, the first inflatable member and/or the second inflatable members inflates, causing the flexible body support structure to rotate, tilt, or pivot the flexible body support structure toward a left side or a right side; and
wherein, after rotating, tilting, or pivoting the flexible body support, the plurality of actuators transform the flexible body support structure from the second configuration to the first configuration.

18. The resting support apparatus of claim 17, wherein the first inflatable member and/or the second inflatable member are selected from the group consisting of an inflatable cushion, pillow, wedge, compartment, mattress section, bladder, and balloon.

19. The resting support apparatus of claim 17, wherein the flexible body support structure includes at least one pressure sensor and wherein the plurality of actuators automatically transform the flexible body support structure from the first configuration to the second configuration, and rotate, tilt, or pivot the flexible body support structure based on data generated by the at least one pressure sensor.

20. The resting support apparatus of claim 17, wherein the flexible body support structure includes at least one moisture and/or humidity sensor and wherein the plurality of actuators automatically transform the flexible body support structure from the first configuration to the second configuration, and rotate, tilt, or pivot the flexible body support structure based on data generated by the at least one moisture and/or humidity sensor.
